(19) United States
(12) Patent Application Publication
(10) Pub. No.: US 2021/0221446 A1
(43) Pub. Date: Jul. 22, 2021

(54) ARTICULATED VEHICLES WITH PAYLOAD-POSITIONING SYSTEMS

(71) Applicant: Indigo Technologies, Inc., Woburn, MA (US)

(72) Inventors: Grant W. Kristofek, Wayland, MA (US); Ian W. HUNTER, Lincoln, MA (US); Andrew S. Bennett, Somerville, MA (US); Adam Wahab, Cambridge, MA (US); Alexander BANDAZIAN, Somerville, MA (US)

(21) Appl. No.: 17/051,613

(22) PCT Filed: Apr. 30, 2019
(86) PCT No.: PCT/US19/29793

§ 371 Date: Oct. 29, 2020

Related U.S. Application Data
(60) Provisional application No. 62/664,656, filed on Apr. 30, 2018.
(60) Provisional application No. 62/679,458, filed on Jun. 1, 2018.

(51) Int. Cl. B62D 31/00; B62D 21/14

(52) U.S. Cl. CPC B62D 31/003; B62D 21/20; B62D 21/14

(57) ABSTRACT

A conventional vehicle typically behaves like a single rigid body with fixed characteristics defined during the design phase of the vehicle. The rigid nature of the conventional vehicle limits their ability to interact and adapt to different environments. To overcome these limitations, an articulated vehicle may be used where one or more sections of the vehicle are reconfigurable, thus changing various aspects of the vehicle including the shape, the size, and the footprint. In one example, the articulated vehicle includes a front section and a tail section joined together by an articulated joint. The articulated joint rotates the tail section about an axis relative to the front section, thus modifying the height and the wheelbase. The vehicle also includes a morphing section to maintain continuity in the form of the vehicle and a payload positioning joint to maintain a desired orientation of a payload as the vehicle is being articulated.

### CROSS-REFERENCE TO RELATED PATENT APPLICATION

This application claims priority, under 35 U.S.C. § 119(e), to U.S. Application No. 62/664,656, filed on Apr. 30, 2018, entitled “ARTICULATED VEHICLE,” and to U.S. Application No. 62/679,458, filed on Jun. 1, 2018, entitled “VEHICLE SEAT WITH POSITIONING MECHANISM,” which are all incorporated herein by reference in their entirety.

### BACKGROUND

A conventional vehicle (e.g., a motor vehicle, an electric vehicle) typically includes a chassis that supports at least one propulsion mechanism (e.g., an internal combustion engine, an electric motor) to propel at least one wheel rotatably coupled to the chassis. The chassis may also support a body that defines an interior space into which a payload (e.g., a driver, a passenger, cargo) may be disposed. Although certain components of the vehicle may move relative to the chassis (e.g., the wheel(s) via a suspension system, active aerodynamic elements on the body in some high performance vehicles), the vehicle remains predominantly a single rigid body during operation. As a result, the characteristics of the vehicle, such as the overall vehicle size, the visibility of the driver, the drag coefficient, or the center of mass, are determined primarily during the design phase of the vehicle and are thus not readily reconfigurable after production without expensive and/or time consuming modification.

### SUMMARY

Embodiments described herein are thus directed to an articulated vehicle (also referred to hereafter as the “vehicle”) with an articulated joint that modifies the shape and size of the vehicle along one or more axes of articulation. The articulated joint enables the vehicle to be reconfigured after production, thus providing greater flexibility and adaptability for various applications. For example, a low profile configuration may be used to reduce aerodynamic drag when driving the vehicle. In another example, a high profile configuration may be used to reduce the footprint of the vehicle when parking. Also described herein is a morphing section, which may be used to maintain continuity in the form and structure of vehicle when the vehicle is articulated between various configurations. Additionally, a payload positioning joint may be deployed in the vehicle interior to maintain a preferred orientation of a payload (e.g., a driver, a passenger, cargo) while the articulated joint changes the shape of the vehicle.

On example of an articulated vehicle includes a front section with a front body, a tail section with a rear body, and an articulated joint. The articulated joint has a first end coupled to the front section and a second end coupled to the tail section. The articulated joint includes a guide structure, a drive actuator, and a brake. The guide structure is coupled to the first end and the second end and defines a curved path. The second end is movable with respect to the first end along the curved path. The drive actuator is coupled to the guide structure and is configured to move the second end along the curved path. And the brake is coupled to the guide structure and hold the second end to a fixed position along the curved path in response to being activated.

In another example, an articulated vehicle includes a front section; and a tail section, wherein the front section includes: a front vehicle body; a front wheel assembly attached to the front vehicle body; and a track system at the rear of the front vehicle body, said track system defining a curved path; and wherein the tail section includes: a rear vehicle body; a rear wheel assembly; a carriage system that rides on the track system and to which the rear vehicle body and the rear wheel assembly is attached; and a motorized drive system for moving the carriage system back and forth over the curved path defined by the track system, wherein the curved path is vertically oriented and is convex as viewed from the tail section towards the front section. Movement of the carriage over the curved path changes the wheelbase and/or the height of the vehicle.

Other embodiments include one or more of the following features. The tail section further includes a steering assembly connected to the carriage and to which the rear wheel is connected, wherein the steering assembly is for steering the vehicle. The curved path defines an arc of a circle with a center located within the front section of the vehicle. The arc of the curved path extends over an angle between 90° and 120° of the circle. The track system is mounted on a back side of the front vehicle body. The curved path is along the back side of front vehicle body. The track system includes a first rail and a second rail, and the carriage system includes bearings that interface and ride on the first and second rails. The bearings are plain bearings. The bearings are configured to hold the carriage system on the first and second rails. The motorized drive system includes a motorized belt drive. The motorized drive system includes a belt, a toothed gear that is engaged with the belt, and a motor driving the toothed gear. The belt is attached to the front vehicle section and the motor and gear are mounted on the carriage system. The motorized drive system further includes a rail attached to the front section, and the rail has a recessed center region that holds the belt. The vehicle further includes a braking assembly for maintaining holding the carriage system at a selectable location along the track system. The brake includes a brake shoe and an actuator for pushing the brake shoe against an object that is attached to the front section. The object attached to the front section is the rail.

An example vehicle may include: a front section and a tail section, wherein the front section includes: a front wheel assembly; and a track system defining a curved path; wherein the tail section includes: a rear wheel assembly; a carriage system that rides on the track system and to which the rear wheel assembly is attached; and a motorized drive system for moving the carriage system back and forth over the curved path defined by the track system, wherein the curved path is vertically oriented and is convex as viewed from the tail section towards the front section.

Embodiments may have one or more of the following advantages.

One advantage of the design described herein is that it allows one to place the virtual hinge point in the space occupied by the passenger without also causing mechanical structure to intrude into and obstruct that space. This allows for a more efficient use of space than some alternative approaches.

Among other advantages, the articulated vehicle is transformable from a lowered position for driving at higher speeds to a raised position, for example, for low speed driving, possibly in smaller spaces, and for parking in small parking spaces. The H-point (i.e., hip-point) of the vehicle is advantageously transformable from approximately 150 mm off the ground as in the case of a sports car and a meter or more as in the case of a sport utility vehicle. As a result, the vehicle has the advantage of a low center of gravity when in its lowered position and a raised point of view for the operator when the vehicle is in its raised position.

Other inventive aspects include a seat positioning system for a vehicle, the seat positioning system including: a track system including a contoured rail with a rear curved section and a forward runout section in front of the rear curved section, wherein the forward runout section is much straighter than the rear curved section; a seat assembly; and a set of one or more bearing assemblies supporting the seat assembly on the contoured rail so that the seat assembly can move back-and-forth along the contoured rail, wherein the seat assembly is supported on the contoured rail in a forward-facing direction.

Other embodiments include one or more of the following features. The curved section of the contoured rail has a constant radius of curvature and the runout section of the contoured rail is straight. The contoured rail lies in a vertical plane with the curved section of the contoured rail being concave in an upward direction. The track system includes a second contoured rail with a rear curved section and a forward runout section in front of the rear curved section, wherein the forward runout section of the second contoured rail is much straighter than the rear curved section of the second contoured rail. The seat positioning system further includes a second set of one or more bearing assemblies supporting the seat assembly on the second contoured rail so that the seat assembly can move back-and-forth along the second contoured rail, wherein the seat assembly is supported on the second contoured rail in a forward-facing direction. The seat positioning system also includes a drive system that is connected to the seat assembly and is configured to move the seat assembly back and forth along the contoured rail to a location determined by an amount of tilt that is applied to the contoured rail in the vertical plane.

Yet another inventive vehicle includes: a front vehicle section that has a forward tilt that is variable; and a seat positioning system within the front vehicle section. The seat positioning system includes: a track system having a contoured rail with a rear curved section and a forward runout section in front of the rear curved section, wherein the forward runout section is much straighter than the rear curved section; a seat assembly; and a set of one or more bearing assemblies supporting the seat assembly on the contoured rail so that the seat assembly can move back-and-forth along the contoured rail, wherein the seat assembly is supported on the contoured rail in a forward-facing direction.

Other embodiments include one or more of the following features. The curved section of the contoured rail has a constant radius of curvature and the runout section of the contoured rail is straight. The contoured rail lies in a vertical plane with the curved section of the contoured rail being concave in an upward direction. The track system further includes a drive system that is connected to the seat assembly and is configured to move the seat assembly along the contoured rail to a location determined by an amount of tilt that is applied to the front vehicle section.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a side, cross-sectional view of an exemplary articulated vehicle.

FIG. 1B shows a side view of the articulated vehicle of FIG. 1A.

FIG. 1C shows a top view of the articulated vehicle of FIG. 1B.

FIG. 1D shows a side view of the articulated vehicle of FIG. 1B in a low profile configuration where the outer shell of the tail section is removed.

FIG. 1E shows a side view of the articulated vehicle of FIG. 1B in a high profile configuration where the outer shell of the tail section is removed.

FIG. 2 shows a side view of the articulated vehicle of FIG. 1B showing various degrees of freedom.

FIG. 3A shows a perspective view of an exemplary articulated joint in an articulated vehicle.

FIG. 3B shows a side view of the articulated joint of FIG. 3A.

FIG. 3C shows a top, side perspective view of the articulated joint of FIG. 3A.

FIG. 3D shows a bottom, side perspective view of the articulated joint of FIG. 3A.

FIG. 3E shows a top, side perspective view of the carriage and the track system in the guide structure of FIG. 3A.

FIG. 3F shows a top, side perspective view of the track system of FIG. 3E.

FIG. 3G shows a cross-sectional view of a bearing in a rail in the track system of FIG. 3F.

FIG. 4A shows an exemplary guide structure based on a carriage and a track system with a desired remote center of motion (RCM).

FIG. 4B shows another exemplary track system with two rotational degrees of freedom (DOF).

FIG. 4C shows another exemplary guide structure based on a yoke.

FIG. 4D shows an exemplary set of needle roller bearings used in the carriage and the track system.

FIG. 4E shows the set of needle roller bearing from FIG. 4D used in a dovetail configuration.

FIG. 4F shows an exemplary set of constrained ball bearings used in the carriage and the track system.

FIG. 4G shows an exemplary rail with an arbitrary profile to guide the carriage.

FIG. 5A shows an exemplary guide structure based on a symmetric four-bar linkage used in an articulating vehicle in a high profile configuration.

FIG. 5B shows the guide structure of FIG. 5A in an intermediate profile configuration.

FIG. 5C shows the guide structure of FIG. 5A in a low profile configuration.

FIG. 6A shows an exemplary guide structure based on another four-bar linkage used in an articulating vehicle in a high profile configuration.

FIG. 6B shows the guide structure of FIG. 5A in an intermediate profile configuration.

FIG. 6C shows the guide structure of FIG. 5A in a low profile configuration.

FIG. 7A shows a top, front, side perspective view of a drive actuator in the articulated joint of FIG. 3A.

FIG. 7B shows a top, rear, side perspective view of the drive actuator of FIG. 7A.

FIG. 7C shows a cross-sectional view of a rail in the drive actuator of FIG. 7A.

FIG. 7D shows a top, rear, perspective cut-away view of an actuator assembly in the drive actuator of FIG. 7A.

FIG. 7E shows a top, front, perspective view of the actuator assembly of FIG. 7D.

FIG. 7F shows a bottom, rear, perspective view of the actuator assembly of FIG. 7D.

FIG. 7G shows a side view of the actuator assembly of FIG. 7D.

FIG. 8A shows a side view of an exemplary articulating vehicle where the drive actuator is based on the rotation of the rear wheel.

FIG. 8B shows a side view of an exemplary articulating vehicle where the drive actuator is based on the rotation of the front wheel.

FIG. 8C shows a side view of an exemplary articulating vehicle where the drive actuator is based on the rotation of both the front and the rear wheels.

FIG. 9A shows an exemplary drive actuator based on a cable drive.

FIG. 9B shows an exemplary drive actuator based on a linear actuator.

FIG. 9C shows an exemplary drive actuator based on a rotary actuator.

FIG. 10A shows a perspective view of an exemplary brake in the actuator assembly of FIG. 7D.

FIG. 10B shows a cross-sectional front view of the brake of FIG. 10A in an open position.

FIG. 10C shows a cross-sectional front view of the brake of FIG. 10A in a closed position.

FIG. 10D shows a front view of the brake of FIG. 10A.

FIG. 10E shows a top view of the brake of FIG. 10A.

FIG. 10F shows a front view of the brake of FIG. 10A without the housing.

FIG. 10G shows a top view of the brake of FIG. 10F.

FIG. 10H shows a left-side view of the brake of FIG. 10F.

FIG. 10I shows a front, perspective view of the brake of FIG. 10F.

FIG. 11A shows a top, perspective view of another exemplary brake.

FIG. 11B shows a side view of the brake of FIG. 11A.

FIG. 11C shows a cross-sectional, side view of the brake of FIG. 11A.

FIG. 12A shows a top, perspective view of an exemplary rear-wheel steering system with forked suspension in the articulating vehicle.

FIG. 12B shows a top, perspective view of the rear-wheel steering system of FIG. 12A.

FIG. 12C shows a cross-sectional side view of the rear-wheel steering system of FIG. 12A.

FIG. 13A shows a side-view of an exemplary vehicle with (bottom) and without (top) a caster angle adjuster.

FIG. 13B shows an exemplary caster angle adjuster based on a rack/pinion system.

FIG. 13C shows an exemplary caster angle adjuster based on a linear actuator.

FIG. 13D shows an exemplary caster angle adjuster based on a spur/pinion system.

FIG. 14A shows a top view of an exemplary monocoque.

FIG. 14B shows a front view of the monocoque of FIG. 14A.

FIG. 14C shows a right-side view of the monocoque of FIG. 14A.

FIG. 14D shows a top, front perspective view of the monocoque of FIG. 14A.

FIG. 15A shows a side view of an exemplary articulating vehicle in a low profile configuration with a flexible morphing section.

FIG. 15B shows a side view of the articulating vehicle of FIG. 15A in a high profile configuration with the flexible morphing section.

FIG. 15C shows various exemplary patterns for the flexible morphing section of FIG. 15A.

FIG. 16 shows yet another exemplary folding morphing section.

FIG. 17A shows a side view of an articulating vehicle in with an exemplary segmented morphing section.

FIG. 17B shows a perspective of the segmented morphing section of FIG. 17A.

FIG. 17C shows a side view of the segmented morphing section of FIG. 17A in a fully extended and a fully contracted state.

FIG. 17D shows a perspective view of another exemplary segmented morphing section.

FIG. 17E shows various components of the segmented morphing section of FIG. 17D.

FIG. 18A shows an exemplary folding morphing section with an origami design.

FIG. 18B shows another exemplary folding morphing section.

FIG. 18C shows a side view of the folding morphing section of FIG. 18B in a fully extended and a fully contracted state.

FIG. 19A shows a perspective view of an exemplary composite morphing section.

FIG. 19B shows a perspective view of another exemplary composite morphing section.

FIG. 20A shows an exemplary rear outer shell assembly with an exemplary sealing member and an exemplary morphing section.

FIG. 20B shows another exemplary rear outer shell assembly with an exemplary morphing section with an integrated sealing member.

FIG. 20C shows an exemplary morphing section with a sealing member for coupling to an outer rear shell.

FIG. 20D shows a cross-sectional view of an exemplary sealing member according to a first design.

FIG. 20E shows a cross-sectional view of another exemplary sealing member according to a second design.

FIG. 20F shows a cross-sectional view of another exemplary sealing member according to a third design.

FIG. 20G shows a cross-sectional view of another exemplary sealing member according to a fourth design.

FIG. 21A shows an exemplary articulating vehicle with a rotation axis along a X axis of the articulating vehicle.

FIG. 21B shows an exemplary articulating vehicle with a rotation axis along a Y axis of the articulating vehicle.

FIG. 21C shows an exemplary articulating vehicle with a rotation axis along a Z axis of the articulating vehicle.

FIG. 21D shows a side view of an exemplary articulating vehicle with a rotation axis along an arbitrary axis (i.e., not along the X, Y, or Z axes of the articulating vehicle) of the articulating vehicle.

FIG. 21E shows a top view of the articulating vehicle of FIG. 21D.

FIG. 21F shows a front view of the articulating vehicle of FIG. 21D.

FIG. 21G shows a rear view of the articulating vehicle of FIG. 21D.

FIG. 22A shows a side view of an exemplary articulating vehicle with a passenger seat.

FIG. 22B shows a cross-sectional side view of a monocoque in the articulating vehicle of FIG. 22A with an exemplary payload positioning joint.

FIG. 22C shows a side view of an exemplary rail in the payload positioning joint of FIG. 22B.

FIG. 22D shows a front view of an exemplary seat frame on the rails of FIG. 22C in the payload positioning joint of FIG. 22B.

FIG. 22E shows a top view of the monocoque of FIG. 22B.

FIG. 22F shows a cross-sectional perspective view of the monocoque of FIG. 22E.

FIG. 23A shows a cross-sectional side view of the payload positioning joint of FIG. 22B when the articulated vehicle is in the low profile configuration of FIG. 1D.

FIG. 23B shows a cross-sectional side view of the payload positioning joint of FIG. 22B when the articulated vehicle is in an intermediate profile configuration.

FIG. 23C shows a cross-sectional side view of the payload positioning joint of FIG. 22B when the articulated vehicle is in the high profile configuration of FIG. 1E.

FIG. 24A shows a side view of another exemplary payload positioning joint with a drive actuator.

FIG. 24B shows a side view of the payload positioning joint of FIG. 24A where the seat is at another position.

FIG. 25A shows a perspective of an exemplary bearing assembly in the payload positioning joint of FIG. 22B.

FIG. 25B shows a rear view of the bearing assembly of FIG. 25A.

FIG. 25C shows a perspective view of another exemplary bearing assembly.

FIG. 25D shows a cross-sectional view of an exemplary roller element assembly in the bearing assembly of FIG. 25C.

FIG. 25E shows a cross-sectional view of another exemplary roller element assembly.

FIG. 25F shows a cross-sectional view of yet another exemplary roller element assembly.

FIG. 26A shows a top view of exemplary articulated vehicles to support a single passenger or multiple passengers.

FIG. 26B shows a rear view of the exemplary articulated vehicles of FIG. 26A.

FIG. 26C shows a side view of the exemplary articulated vehicles of FIG. 26A.

FIG. 26D shows a front, perspective view of the exemplary articulated vehicles of FIG. 26A.

FIG. 27 shows a side view of an exemplary monocoque configured for cargo transport.

FIG. 28A shows an exemplary articulated vehicle in a low profile configuration to reduce aerodynamic drag.

FIG. 28B shows a top view of the articulated vehicle of FIG. 28A.

FIG. 29A shows the articulated vehicle of FIG. 28A in an intermediate profile configuration to increase visibility/accessibility.

FIG. 29B shows the articulated vehicle of FIG. 29A where the passenger is able to grab mail from a mailbox.

FIG. 29C shows the articulated vehicle of FIG. 29A where the passenger is able to grab food from a drive through restaurant.

FIG. 30 shows the articulated vehicle of FIG. 28A in a high profile configuration for parking.

FIG. 31A shows an exemplary articulated vehicle with a wireless power transfer system at various configurations for wireless power transfer with a stationary wireless power transfer system.

FIG. 31B shows an exemplary articulated vehicle with a wireless power transfer system configured to exchange power with another articulated vehicle.

FIG. 31C shows an exemplary articulated vehicle with a wireless power transfer system configured to align to an elevated wireless power transfer on another vehicle.

FIG. 32A shows an exemplary articulated vehicle approaching a docking station for charging in a low profile configuration.

FIG. 32B shows the exemplary articulated vehicle of FIG. 32A at another configuration to couple to the docking station.

FIG. 33 shows an exemplary articulated vehicle with a photovoltaic cell where the configuration of the vehicle changes throughout the day to increase the absorption of sunlight.

FIGS. 34A-34E show an exemplary articulated vehicle configured to traverse a set of stairs through a combination of the articulated joint and actuation of the wheels with respect to the body of the articulated vehicle.

FIG. 35A shows another exemplary articulated vehicle a flatbed coupled to the tail section.

FIG. 35B shows the articulated vehicle of FIG. 35A in a high profile configuration to unload a payload stored in the flatbed.

FIG. 35C shows the articulated vehicle of FIG. 35A in a high profile configuration to transfer a payload from an elevated position and to the ground using the flatbed.

### DETAILED DESCRIPTION

The present disclosure is directed to an articulated vehicle, an articulated joint for articulating the vehicle, a morphing section to maintain a continuous structure and/or form of the vehicle while the vehicle articulates, a payload positioning joint to maintain a preferred orientation of a payload while the vehicle articulates, and various methods of using the articulated vehicle. It should be appreciated that various concepts introduced above and discussed in greater detail below may be implemented in numerous ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are useful for an understanding of the present implementations are described, and detailed descriptions of other portions of such known components are omitted so as not to obscure the present implementations.

For example, the articulated vehicle described herein may be various types of vehicles including, but not limited to a land vehicle, a water vehicle, two and four-wheel vehicles, and an airborne vehicle. In the case of a land vehicle, the articulated vehicle may have any number of wheels including, but not limited to a single wheel (e.g., a monocycle), two wheels (e.g., one wheel in the front and one wheel in the back such as in a motorcycle), three wheels (e.g., two wheels in the front and one wheel in the back, one wheel in the front and two wheels in the back), four wheels (e.g., two wheels in the front and two wheels in the back), and multiple wheels (e.g., wheels on a truck or a train, wheels supporting a continuous track such as on a tank or a construction vehicle).

At least one of the wheels may be powered by a propulsion mechanism (e.g., an engine or an electric motor). One or more articulated joints may be integrated onto the articulated vehicle designed or retrofit onto an existing vehicle (e.g., articulating or non-articulating). One or more morphing sections may be deployed on a vehicle. The form and structure of the morphing section may depend on the desired extent to which the continuity of the structure and/or form of the vehicle is maintained. One or more payload positioning joints may also be disposed within the vehicle (e.g., each passenger or cargo platform has a corresponding payload positioning joint).

### 1. AN EXEMPLARY ARTICULATED VEHICLE

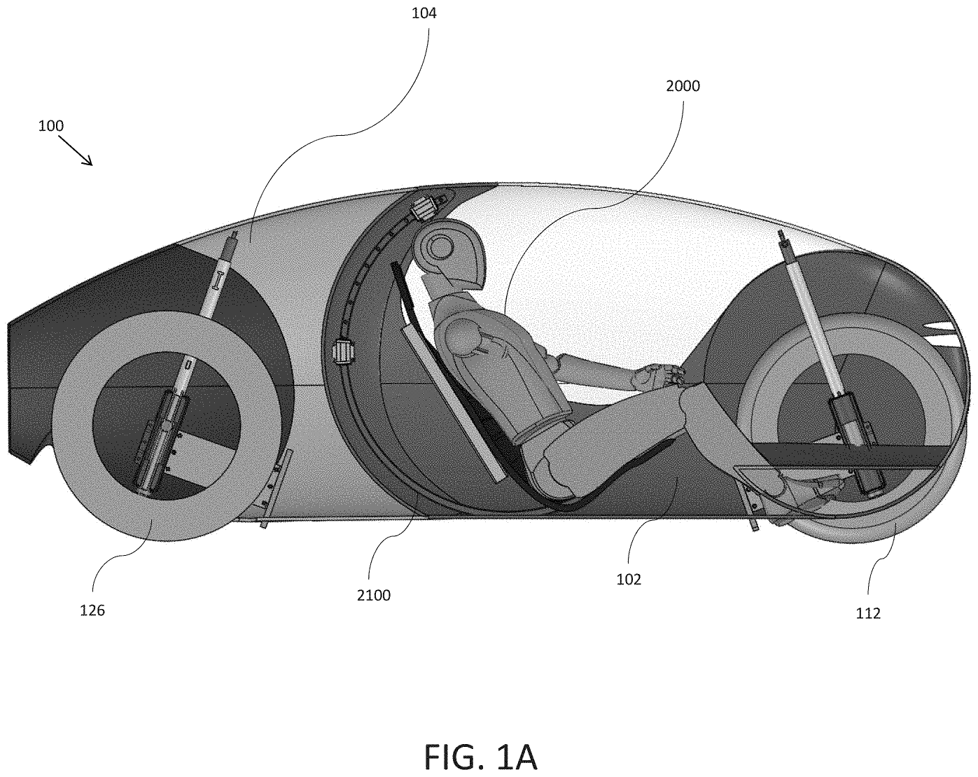

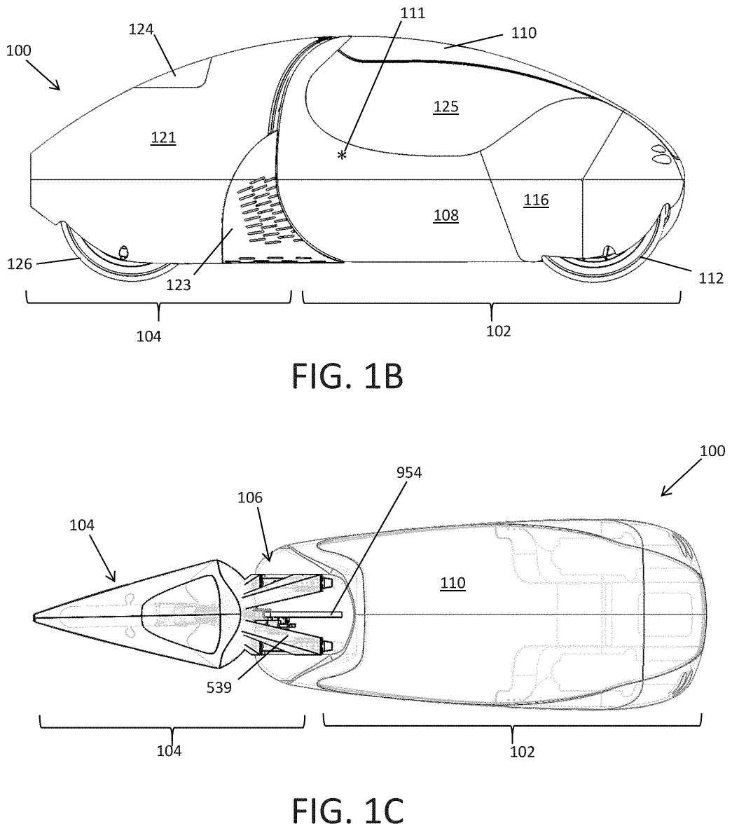

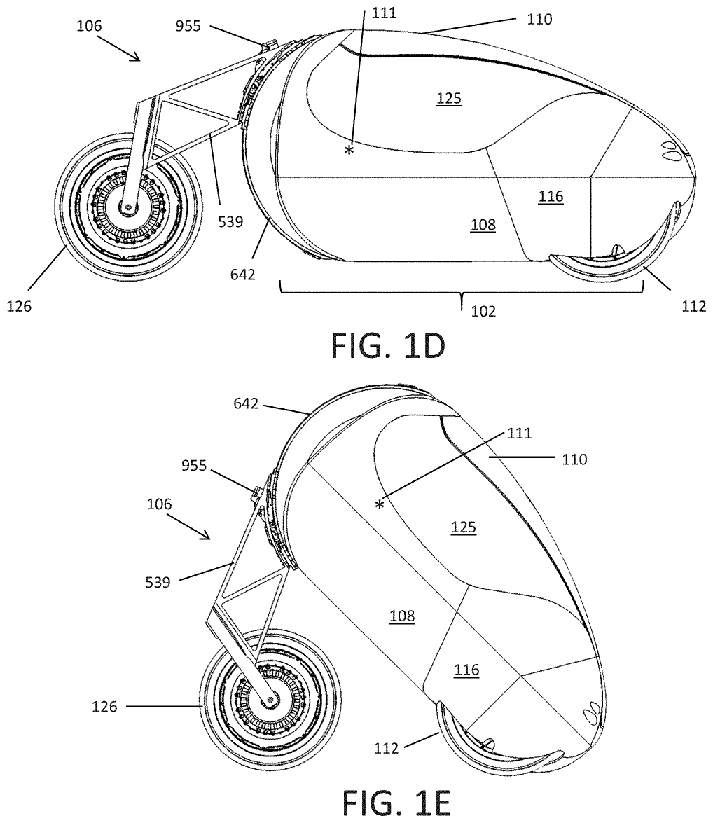

As an illustrative example, FIGS. 1A-1E show an articulated vehicle 100 that incorporates an articulated joint 106 (also called an articulation mechanism), a morphing section 123, and a payload positioning joint 2100 (also called a payload positioning mechanism) to support a payload 2000 (e.g., a driver, a passenger, cargo). In this example, the vehicle 100 is a three-wheeled electric vehicle with rear wheel steering. The articulated joint 106 enables the vehicle 100 to articulate or bend about an intermediate position along the length of the vehicle 100, thus reconfiguring the vehicle 100.

The range of articulation of the vehicle 100 may be defined by two characteristic configurations: (1) a low profile configuration where the wheelbase is extended and the driver is near the ground as shown in FIGS. 1A, 1B, 1D and (2) a high profile configuration where the driver is placed at an elevated position above the ground as shown in FIG. 1E. The vehicle 100 may be articulated to any configuration between the low profile and the high profile configurations. In some cases, the articulated joint 106 may limit the vehicle 100 to a discrete number of configurations. This may be desirable in instances where a simpler and/or a low power design for the articulated joint 106 is preferred.

The vehicle 100 may be subdivided into a front vehicle section 102 and a tail section 104, which are coupled together by the articulated joint 106. The front section 102 may include a body 108, which may be various types of vehicle support structures including, but not limited to a unibody, a monocoque frame/shell, a space frame, and a body-on-frame construction (e.g., a body mounted onto a chassis). In FIGS. 1A-1E, the body 108 is shown as a monocoque frame. The body 108 may include detachable side panels (or wheel fairings) 116, fixed side windows 125, a transparent canopy 110 coupled to the vehicle 100, and two front wheels 112 arranged in a parallel configuration and mounted on the underlying body 108. The tail section 104 may include a rear outer shell 121, a rear windshield 124, and a steerable wheel 126. A morphing section 123 may be coupled between the front section 102 and the tail section 104 to maintain a smooth, continuous exterior surface underneath the vehicle 100 at various configurations. In FIGS. 1D and 1E, the rear outer shell 121 and the rear windshield 124 are removed so that underlying components related to at least the articulated joint 106 can be seen.

The canopy 110 may be coupled to the body 108 via a hinged arrangement to allow the canopy 110 to be opened and closed. In cases where the payload 2000 is a driver, the canopy 110 may be hinged towards the top of the vehicle 100 when in the high profile configuration of FIG. 1E so that the driver may enter/exit the vehicle 100 by stepping into/out of the vehicle 100 between the two front wheels 112.

The front wheels 112 may be powered by electric hub motors. The rear wheel 126 may also be powered by an electric hub motor. Some exemplary electric motors may be found in U.S. Pat. No. 8,742,633, issued on Jun. 14, 2014 and entitled “Rotary Drive with Two Degrees of Movement” and U.S. Pat. Pub. 2018/0072125, entitled “Guided Multi-Bar Linkage Electric Drive System”, both of which are incorporated herein by reference in their entirety.

The rear surface of the front vehicle section 102 may be nested within the rear outer shell 121 and shaped such that the gap between the rear outer shell 121 of the tail section 104 and the rear surface of the front vehicle section 102 remains small as the tail section 104 moves relative to the front section 102 via the articulated joint 106. As shown, the articulated joint 106 may reconfigure the vehicle 100 by rotating the tail section 104 relative to the front section 102 about a rotation axis 111. In FIGS. 1B, 1C, and 1E, the axis of rotation 111 is perpendicular to a plane, which bisects the vehicle 100. The plane may be defined to contain (1) a longitudinal axis of the vehicle 100 (e.g., an axis that intersects the frontmost portion of the body 108 and the rearmost portion of the rear outer shell 121) and (2) a vertical axis normal to a horizontal surface onto which the vehicle 100 rests such.

The articulated joint 106 may include a guide structure 107 (also called a guide mechanism) that determines the articulated motion profile of the articulated joint 106. In the exemplary vehicle 100 shown in FIGS. 1A-1E, the guide structure 107 may include a track system coupled to the front section 102 and a carriage 538 coupled to the tail section 104. Alternatively, the track system 536 may be coupled to tail section 104 and the carriage 538 coupled to the front section 102. The carriage 538 may move along a path defined by the track system 536, thus causing the vehicle 100 to change configuration. The articulated joint 106 may also include a drive actuator 540 (also called a drive mechanism) that moves the carriage 538 along the track system 536 to the desired configuration. The drive actuator 540 may be electrically controllable. The articulated joint 106 may also include a brake 1168 to hold the carriage 538 at a particular position along the track system 536, thus allowing the vehicle 100 to maintain a desired configuration.

The body 108 may also contain therein a payload positioning joint 2100. The payload positioning joint 2100 may orient the payload 2000 to a preferred orientation as a function of the vehicle 100 configuration. As the articulated joint 106 changes the configuration of the vehicle 100, the payload positioning joint 2100 may simultaneously reconfigure the orientation of the payload 2000 with respect to the vehicle 100 (the front section 102 in particular). For example, the payload positioning joint 2100 may be used to maintain a preferred driver orientation with respect to the ground such that the driver does not have to reposition their head as the vehicle 100 transitions from the low profile configuration to the high profile configuration. In another example, the payload positioning joint 2100 may be used to maintain a preferred orientation of a package to reduce the likelihood of damage to objects contained within the package as the vehicle 100 articulates.

The vehicle 100 shown in FIGS. 1A-1E is one exemplary implementation of the articulated joint 106, the morphing section 123, and the payload positioning joint 2100. Various designs for the articulated joint 106, the morphing section 123, and the payload positioning joint 2100, are respectively discussed with reference to the vehicle 100. However, it should be appreciated that the articulated joint 106, the morphing section 123, and the payload positioning joint 2100 may be implemented in other vehicle architectures either separately or in combination. In the following description: Section 2 describes various degrees of freedom (DOF) that may be available in a vehicle 100. Section 3 describes exemplary articulated joints 106 and the components therein. Section 4 describes structural and exterior design of the articulated vehicle 100. Section 5 describes exemplary payload positioning joints 2100. Section 6 describes exemplary applications utilizing the articulated joint 106.

### 2. EXEMPLARY DEGREES OF FREEDOM IN AN ARTICULATED VEHICLE

The articulated vehicle 100 in FIGS. 1A-1E was shown to have a single articulation DOF (i.e., the rotation axis 111) where the tail section 104 rotates relative to the front section 102 in order to change the configuration of the vehicle 100. This topology may be preferable for a single commuter or passenger traveling in both urban environments and the highway, especially when considering intermediate and endpoint interactions with the surrounding environment (e.g., compact/nested parking, small space maneuverability, low speed visibility, high speed aerodynamic form). The various mechanisms that provide support for said topology and use cases may be applied more generally to a broader range of vehicles, fleet configurations, and/or other topologies.

For instance, the vehicle 100 may support one or more DOF's that may each be articulated. Articulation may occur about an axis resulting in rotational motion, thus providing a rotational DOF, such as the rotation axis 111 in FIGS. 1A-1E. Articulation may also occur along an axis resulting in translational motion and thus a translational DOF. The various mechanisms described herein (e.g., the articulated joint 106, the payload positioning joint 2100) may also be used to constrain motion along one or more DOF's. For example, the articulated joint 106 may define a path along which a component of the vehicle 100 moves along said path (e.g., the carriage 538 is constrained to move along a path defined by the track system 536). The articulated joint 106 may also define the range of motion along the path. This may be accomplished, in part, by the articulated joint 106 providing smooth motion induced by low force inputs along a desired DOF while providing mechanical constraints along other DOF's using a combination of high strength and high stiffness components that are assembled using tight tolerances and/or pressed into contact via an external force.

It should also be appreciated the mechanisms described herein may define motion with respect to an axis or a point (e.g., a remote center of motion) that may or may not be physically located on the articulated joint 106. For example, the articulated joint 106 shown in FIGS. 1A-1E causes rotational motion about the rotation axis 111, which intersects the interior compartment of the body 108, which is located separately from the carriage 538 and the track system 536. In another example, the payload positioning joint 2100 may have one or more rails 2112 that define the translational motion of a platform (e.g., a driver's seat).

Additionally, motion along each DOF may also be independently controllable. For example, each desired DOF in the vehicle 100 may have a separate corresponding articulated joint 106. The drive system of each articulated joint 106 may induce motion along each DOF independently from other DOF's. With reference to FIGS. 1A-1E, the articulated joint 106 that causes rotation about the rotation axis 111 may not depend on other DOF's supported in the vehicle 100.

In some cases, however, articulation along one DOF of the vehicle 100 may be dependent on another DOF of the vehicle 100. For example, one or more components of the vehicle 100 may move relative to another component in response to the other component being articulated. This dependency may be achieved by mechanically coupling several DOF's together (e.g., one articulated joint 106 is mechanically linked to another articulated joint 106 such that a single drive actuator 540 may actuate both articulated joints 106 in series or simultaneously). Another approach is to electronically couple separate DOF's by linking separate drive actuators 540 together. For example, the payload positioning joint 2100 may actuate a driver seat using an onboard motor in response to the articulated joint 106 reconfiguring the vehicle 100 so that the driver maintains a preferred orientation as the vehicle 100 is reconfigured.

2.1. Reconfigurability of the Exemplary Vehicle about Various DOF's

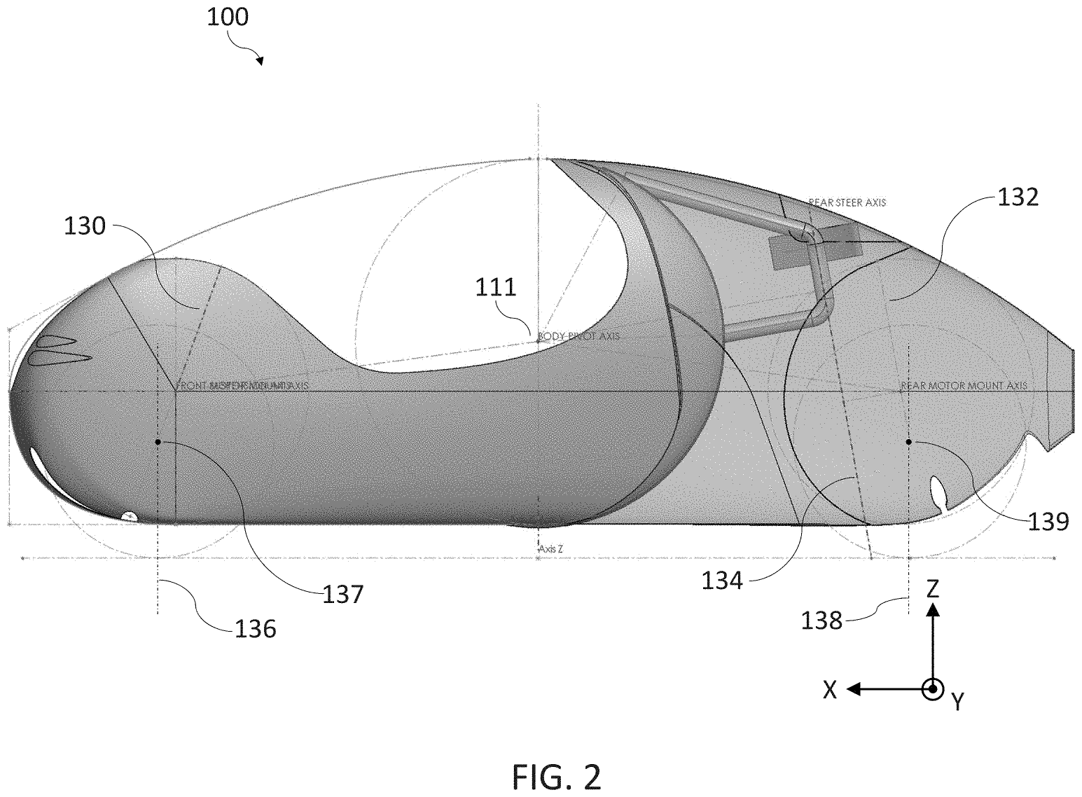

The vehicle 100 may be reconfigured about one or more DOF's, which may be used to modify various characteristics of the vehicle 100 including, but not limited to the shape, footprint, and the performance of the vehicle 100. In describing these various DOF's, a local coordinate system may be defined with respect to the vehicle 100 (e.g., the local coordinate system moves with the vehicle 100) to provide orientation of each respective axis of motion in the vehicle 100. An X-axis may be defined as the longitudinal axis of the vehicle 100 where positive X corresponds to the forward travel direction of the vehicle 100. A Z-axis may be defined as the vertical orientation axis of the vehicle 100 (e.g., normal to a horizontal surface onto which the vehicle 100 travels along), which is orthogonal to the X-axis. A Y-axis may be defined as being orthogonal to the X-axis and the Z-axis. In FIG. 2, the Y-axis is parallel with the rotation axis 111.

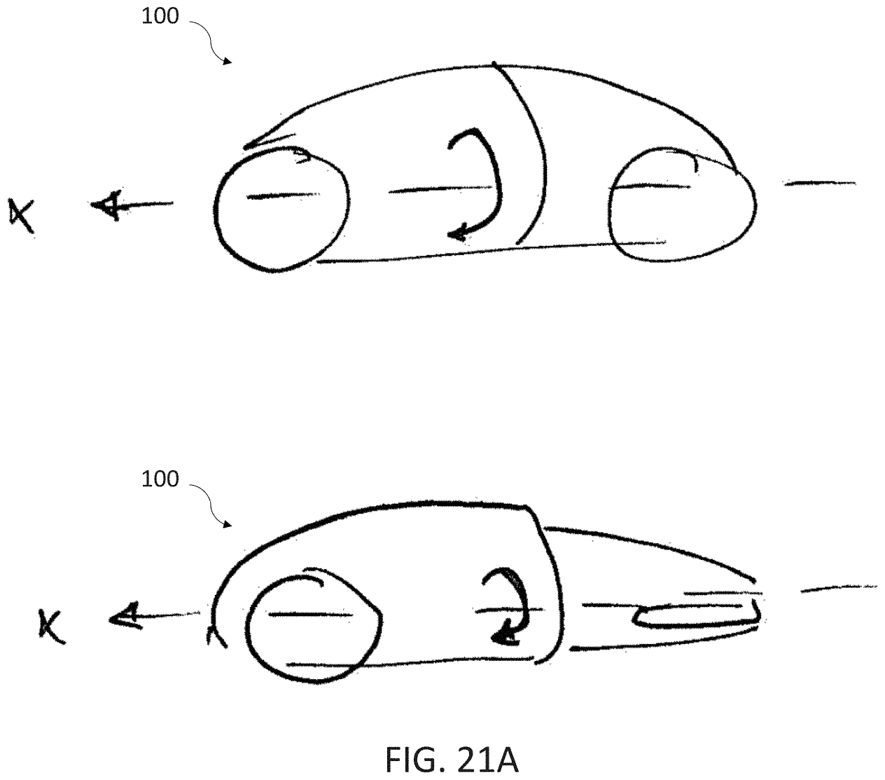

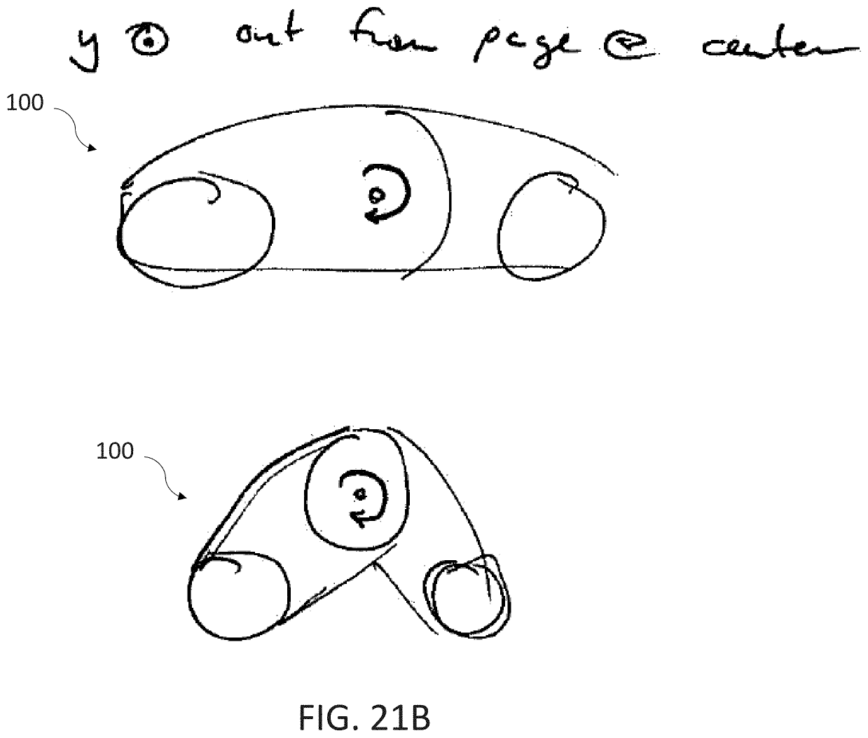

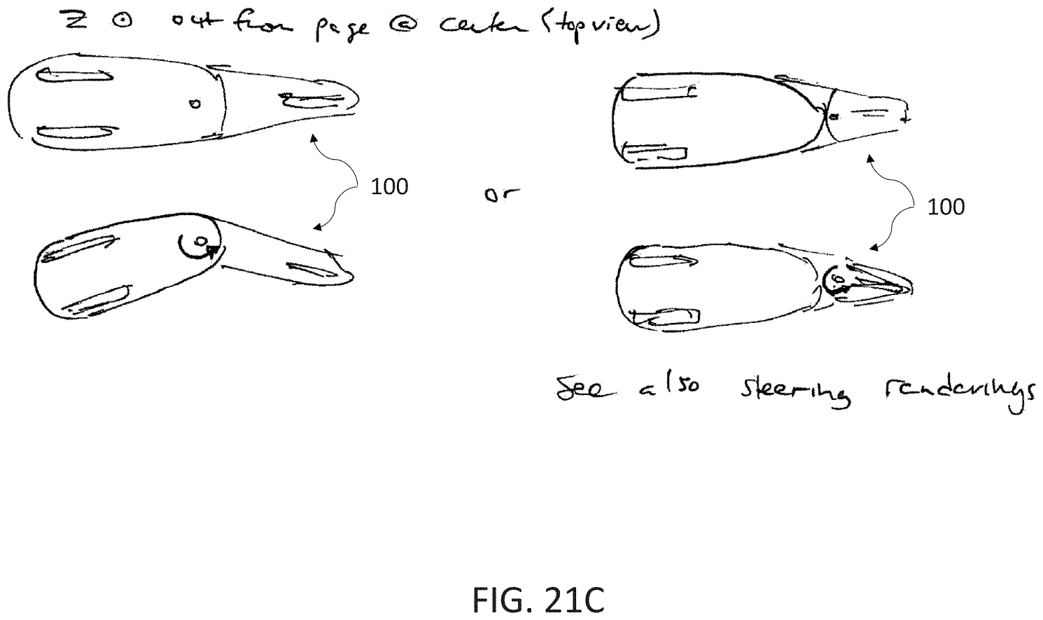

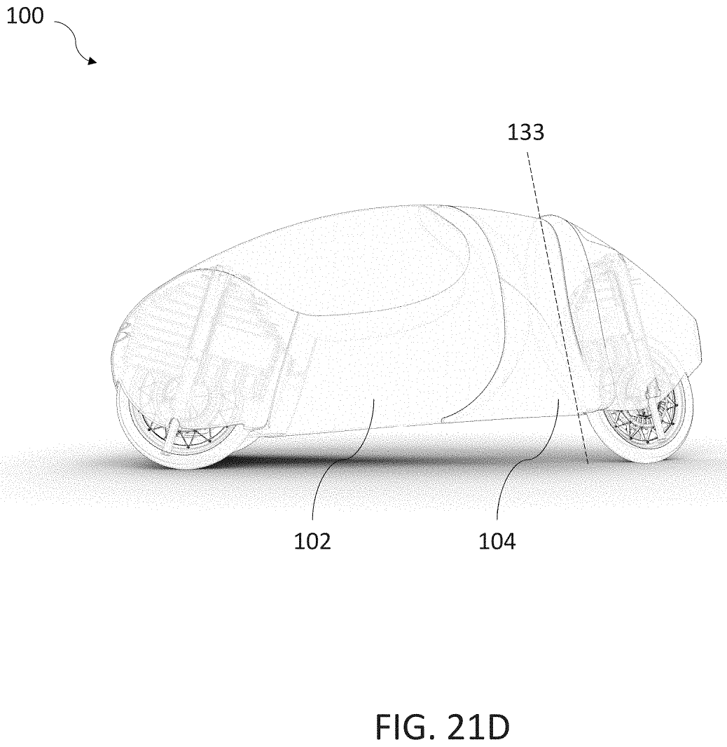

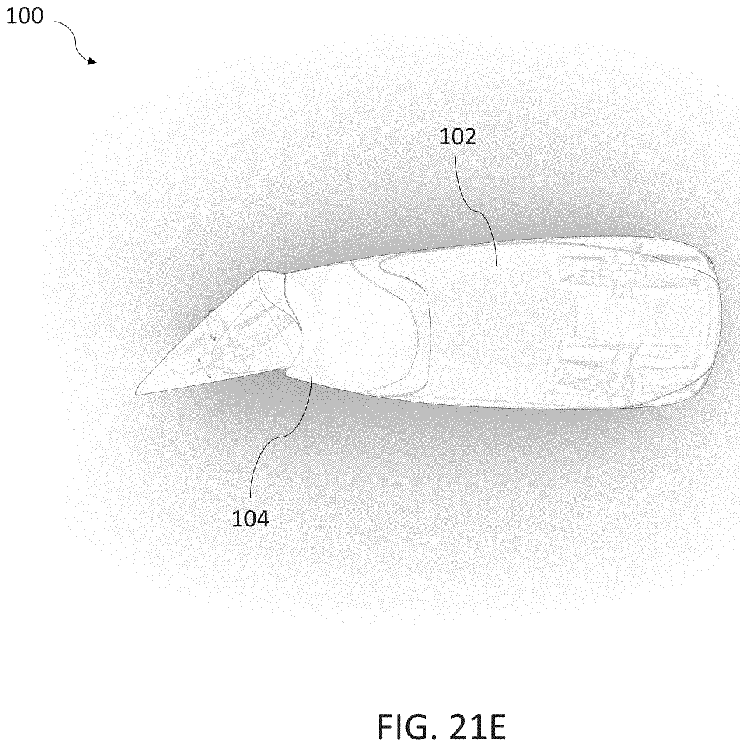

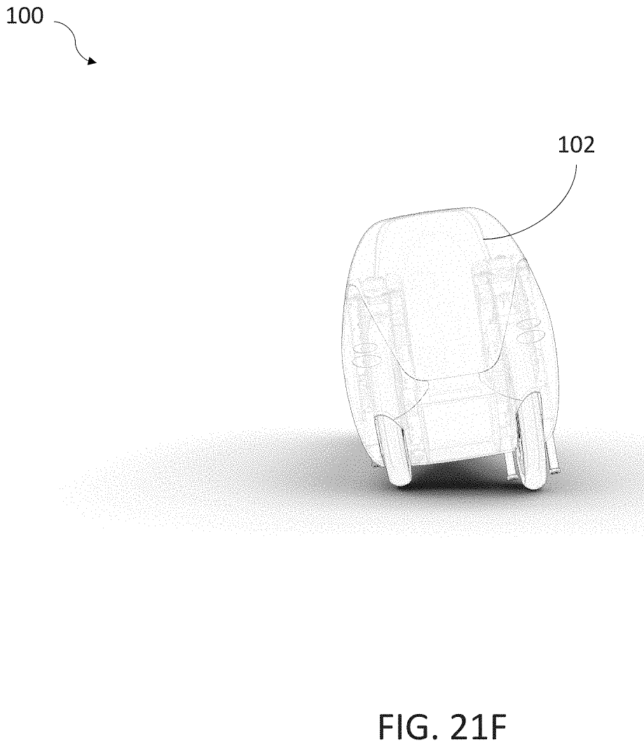

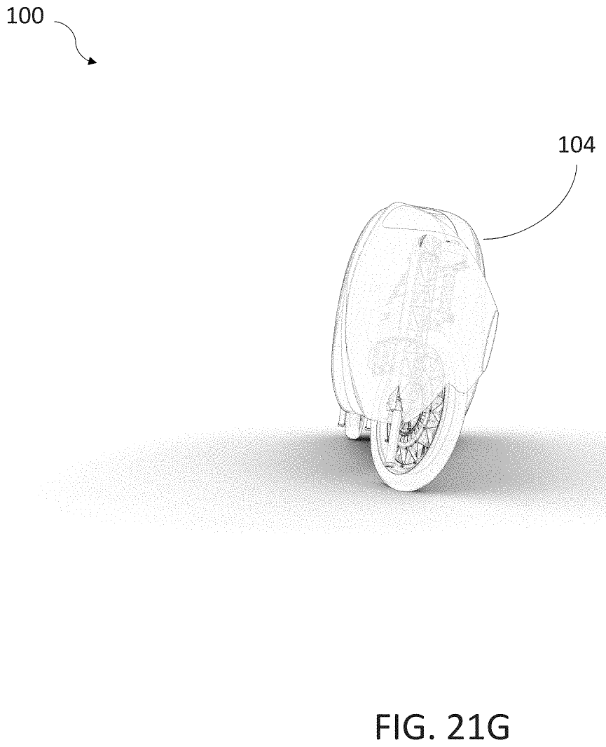

In one example, the vehicle 100 may be reconfigured about the X-axis. As shown in FIG. 21A, rotational about the X-axis may cause the front section 102 and the tail section 104 to rotate relative to one another resulting in a twisting motion between the front wheel 112 and the rear wheel 126. The twisting motion may be used, for instance, to maintain traction of the front wheel 112 and the rear wheel 126 on uneven terrain. The vehicle 100 may also be reconfigured about the X-axis in order to assist with steering the vehicle 100 when making a turn. This twisting motion may also be used to improve cornering performance by enabling the vehicle 100 to make a turn at higher speeds.

In another example, the vehicle 100 may be reconfigured about the Y-axis. This example corresponds to the vehicle 100 shown in FIGS. 1A-1E and is further shown in FIG. 21B. As shown, a rotational DOF about the Y-axis may enable the wheelbase of the vehicle 100 (defined as the distance between the front wheel 112 and the rear wheel 126) and/or the height of the vehicle 100 to be modified. This may be used to adjust the height of the payload 2000 (e.g., the visibility of a driver or placement of cargo, loading or unloading of the payload 2000 from a flatbed).

In yet another example, the vehicle 100 may be reconfigured about the Z-axis. FIG. 21C shows one exemplary implement where the vehicle 100 is able to rotate about the Z-axis. This motion may be used to provide a wagon steering mechanism, which may enable vehicles 100 with longer wheelbases to be able to maneuver around more confined environments. For example, the vehicle 100 may be reconfigured to make a turn around a corner that may otherwise not be traversable, in analog to a snake maneuvering through a narrow maze.

The vehicle 100 may also be configurable about an axis that is not aligned to one of the coordinate axes in the local coordinate system. FIGS. 21D-21G show various views of an exemplary vehicle 100 where the articulating DOF is a non-orthogonal axis 133 used, in part, to provide steering when the articulating DOF is disposed on a prescribed steering axis. As shown, the vehicle 100 may be reconfigured along the axis 133 to contort and tilt the vehicle 100, thereby causing the vehicle 100 to turn. This form of steering is distinct from conventional vehicles, which rely upon the rotation of the wheels in order to steer said vehicles. Here, the front section 102 and the tail section 104 are instead reoriented with respect to one another to steer the vehicle 100.

It should be noted that the vehicle 100 may include the morphing section 123 such that the exterior surface of the vehicle 100, as defined primarily by the body 108 and the rear outer shell 121, remains substantially smooth and continuous as the vehicle 100 turns. This may enable the vehicle 100 to maintain a desired aerodynamic performance, especially at high speeds where the aerodynamics of the vehicle 100 may be used for steering and to stabilize the dynamics of the vehicle 100.

2.2. An Exemplary Vehicle with Multiple DOFs

As shown in the above examples, the vehicle 100 may have a single articulation DOF. However, other vehicles may include multiple articulation DOF's including combinations of the articulation modes (e.g., motion about the X-axis, the Y-axis, the Z-axis, and/or the non-orthogonal axis) described above. Additional DOF's may enable a greater number of vehicle configurations by allowing more complex articulated motion. For example, a vehicle 100 reconfigured about both the X-axis and the Z-axis may be able to more readily navigate complex, tight environments than a vehicle 100 that articulates only about the X-axis or the Z-axis.

In some cases, the articulated joint 106 may intrinsically provide multiple DOF's of motion. For example, the front section 102 and the tail section 104 in the vehicle 100 may be coupled using a ball joint that allows rotation about a point along X, Y, and Z-axes. In other vehicles 100, multiple articulated joints 106 may be used that each provide a separate articulation DOF. For example, an additional body may be coupled to the vehicle 100 (e.g. a trailer having a compartment to contain an additional payload 2000) using an articulated joint 106 similar to the articulated joint 106 coupling the front section 102 to the tail section 104. Additionally, a middle section may be disposed between the front section and the tail section where each section is coupled to another section using an articulated joint 106.

FIG. 2 shows another exemplary vehicle 100 with multiple DOF's that may each be articulated. As shown, the vehicle 100 may include the rotation axis 111 previously described about which the tail section 104 may rotate relative to the front section 102 to modify the wheelbase of the vehicle 100. Additionally, each front wheel 112 may have a translational DOF along an axis 130. The rear wheel 126 may also have a translational DOF along an axis 132. The axes 130 and 132 may correspond to respective long-travel suspensions for each wheel. Furthermore, the vehicle 100 may include a steering axis 134 about which the tail section 104 (or the rear wheel 126) may also rotate to steer the vehicle 100 similar to the non-orthogonal axis 133 shown above.

The vehicle 100 may also include additional DOF's to adjust the caster angle of the front wheel 112 and/or the rear wheel 126. For example, the caster angle of the front wheel 112 may be defined as the angle between (1) the axis 130 and (2) an axis 136 that is parallel to the Z-axis of the vehicle 100 and intersects the rotational axis of the front wheel 112. Said in another way, the caster angle may be defined as the orientation of the front wheel 112 (w/the suspension) relative to the ground. The caster angle of the rear wheel 126 may be similarly defined as the angle between (1) the axis 132 and (2) an axis 138. By changing the caster angle, the stability and handling characteristics of the vehicle 100 may be modified.

### 3. AN EXEMPLARY ARTICULATED JOINT

The articulated joint 106 is used to join different components (or sections) of the vehicle 100 together and provides articulation and/or reconfiguration of said components (or sections) via motion along one or more desired DOF's as described above. The articulated joint 106 may operate by allowing dynamic motion along one or more desired DOF's while preventing unwanted motion along other unwanted DOF's as defined by the guide structure 107. In some instances, the articulated joint 106 may include a drive actuator 540 to actuate said components along the one or more desired DOF's. The articulated joint 106 may also provide a rigid chassis structure by preventing motion along unwanted DOF's in the vehicle 100. In some instances, the articulated joint 106 may include the brake 1168 to hold the articulated joint 106 and the vehicle 100 at a desired configuration. The articulated joint 106 may also support additional secondary DOF's such as the steering assembly 200 to steer a wheel (e.g., the rear wheel 126).

### 3.1. An Exemplary Guide Structure

The articulated joint 106 may generally include a guide structure 107 that defines the motion profile and, hence, the articulation DOF of the articulated joint 106. The guide structure 107 may include two reference points that move relative to one another. A first reference point may be coupled to one component of the vehicle 100 whilst a second reference point may be coupled to another component of the vehicle 100. For example, the front section 102 may be coupled to a first reference point of the guide structure 107 and the tail section 104 may be coupled to a second reference point of the guide structure 107 such that the front section 102 is articulated relative to the tail section 104.

In one aspect, the guide structure 107 may provide articulation about an axis and/or a point that is not physically co-located with the articulated joint 106 itself. For example, the articulated joint 106 may be a remote center of motion (RCM) mechanism. The RCM mechanism is defined as having no physical revolute joint in the same location as the mechanism that moves. Such RCM mechanisms may be used, for instance, to provide a revolute joint located in an otherwise inconvenient portion of the vehicle 100, such as the interior cabin of the body 108 where the payload 2000 is located or a vehicle subsystem, such as where a steering assembly, battery pack, or electronics resides.

The following describes several examples of the articulated joint 106 as an RCM mechanism. However, it should be appreciated that the articulated joint 106 may not be an RCM mechanism where the axis or point about which the DOF is defined along may be located physically with the components of the articulated joint 106.

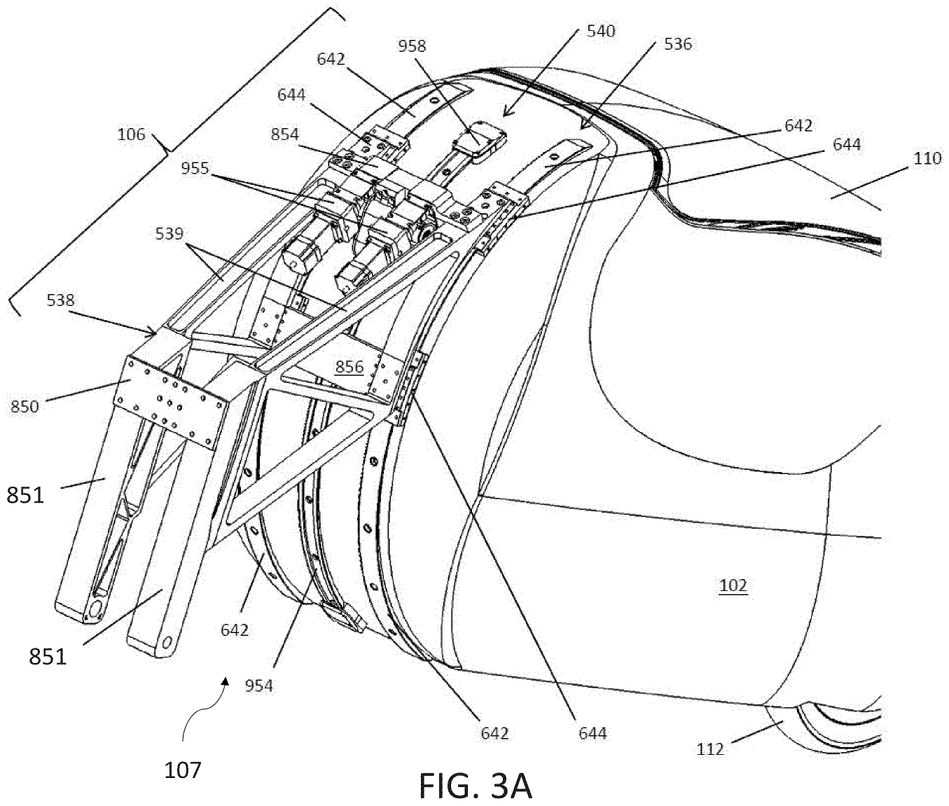

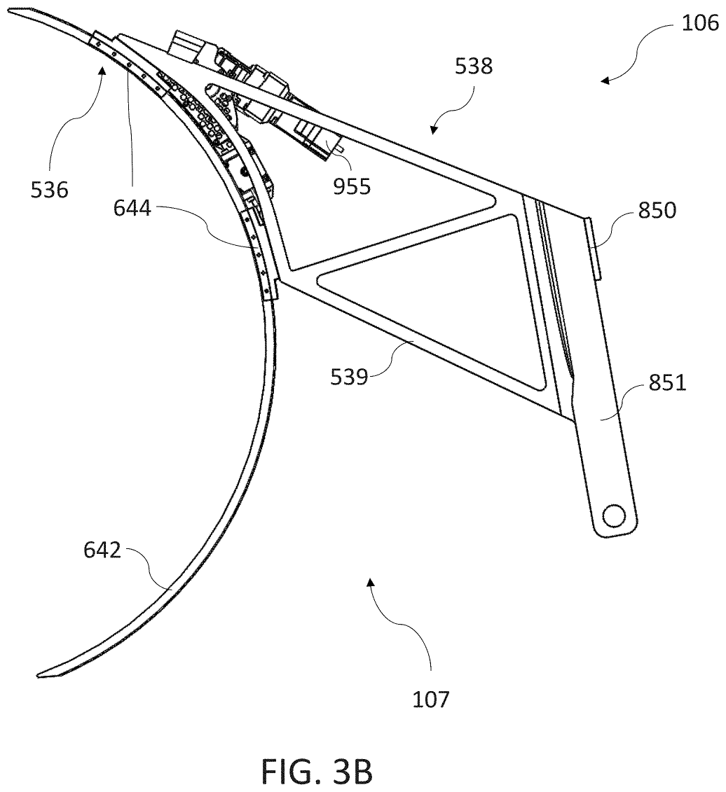

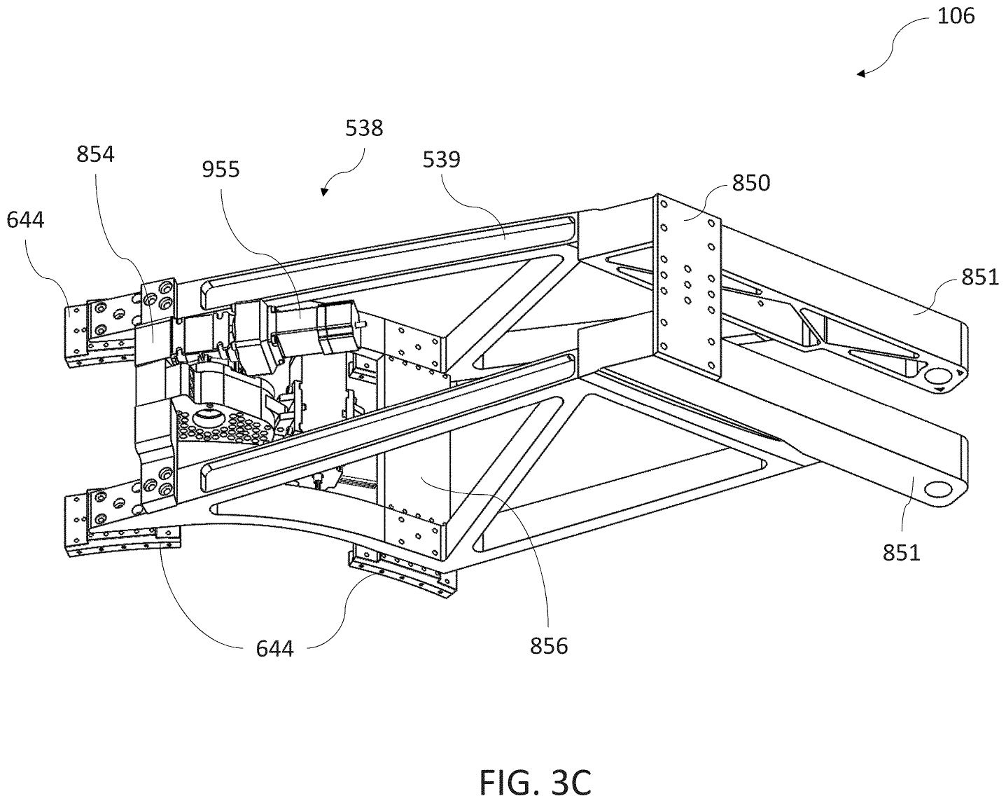

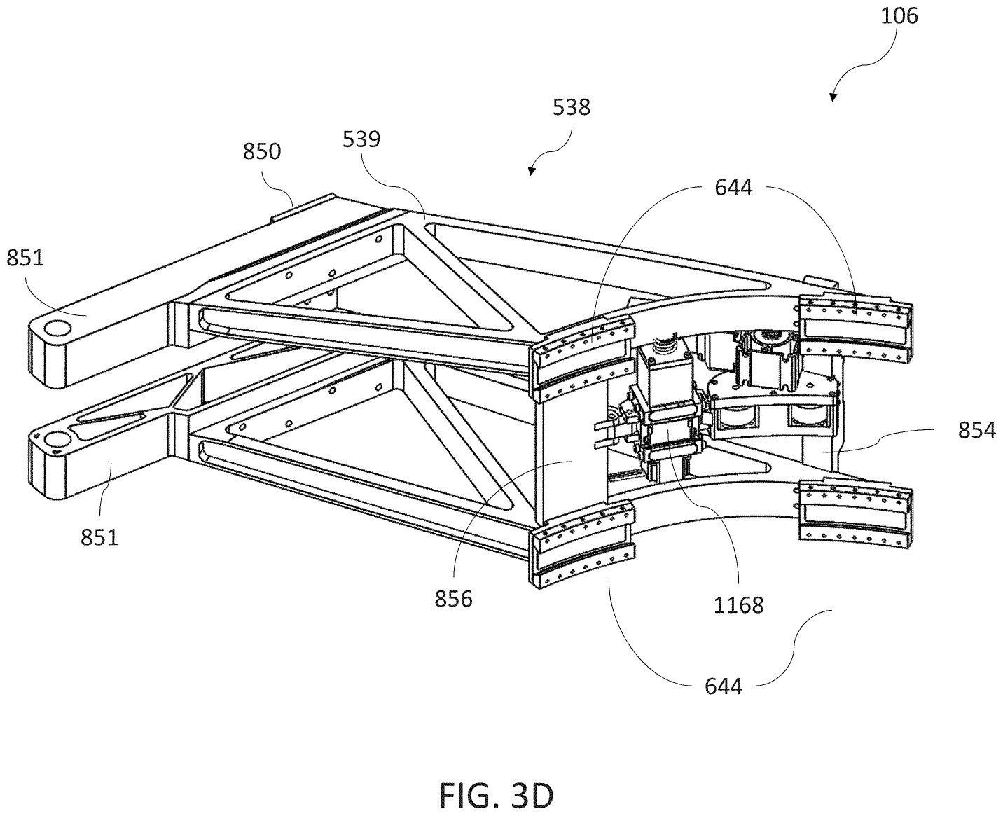

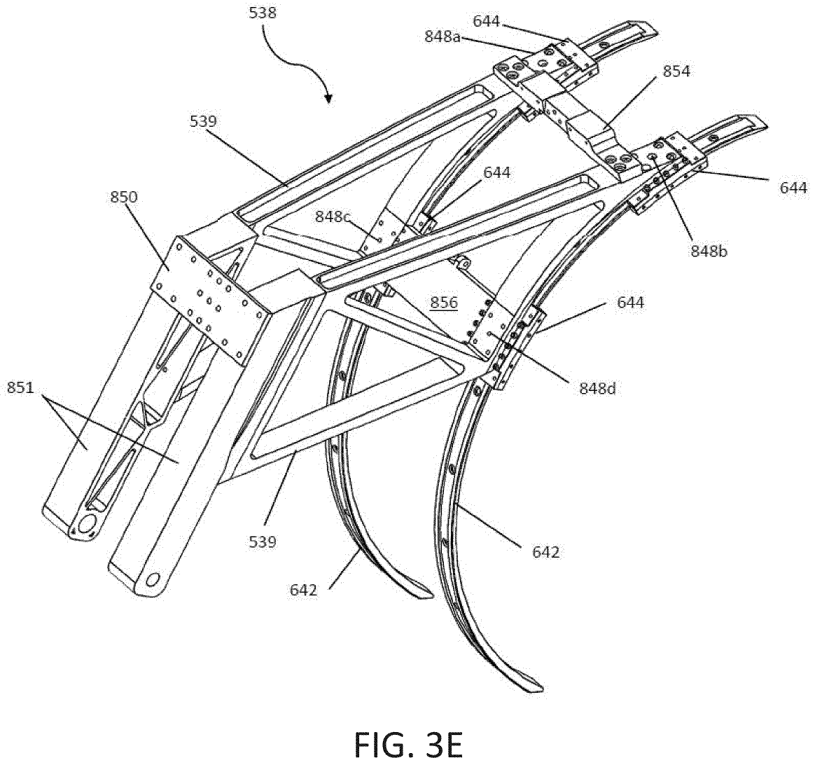

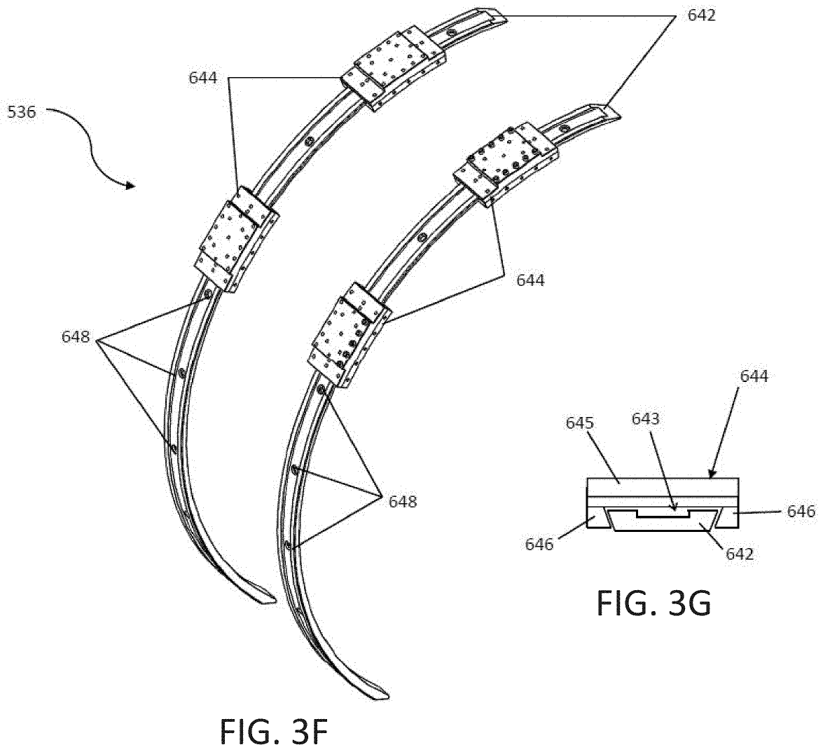

In one example, the guide structure 107 may be a carriage-track type mechanism. The articulated joint 106 shown in FIGS. 1A-1E is one example of this type of mechanism. The guide structure 107 may include the carriage and the track system 536, which are shown in greater detail in FIGS. 3A-3G. As shown in FIG. 3A, the track system 536 may be attached to the front section 102. The carriage 538 may be part of the tail section 104. As shown in FIGS. 3E and 3F, the carriage 538 may ride along a vertically oriented, curved path defined by the track system 536. The drive actuator 540 may be mounted on the carriage 538 to mechanically move the carriage 538 along the track system 536 under electrical control.

The track system 536 may include two curved rails 642 that run parallel to each other and are both coupled to a back surface of the front vehicle section 102. The curved rails 642 may be similar in design. The body 108 may be made from a molded, rigid, carbon fiber shell with a convexly curved rear surface that forms the back surface onto which the rails 642 are attached (i.e., convex with respect to viewing the front vehicle section 102 from the back). The region of the back surface onto which the rails 642 are attached and to which they conform represents a segment of a cylindrical surface for which the axis corresponds to the axis of rotation 111. In other words, the rails 642 may have a constant radius of curvature through the region over which the carriage 538 moves. The arc over which the rails 642 extend may be between about 90° to about 120°.

Each rail 642 may also include a recessed region 643 that spans a portion of the length of the rail 642. The recessed region 643 may include one or more holes Z through which bolts (not shown) can attach the rail 642 to the carbon fiber shell 108. Each rail 642 may have a cross-section substantially shaped to be an isosceles trapezoid where the narrow side of the trapezoid is on the bottom side of the rail 642 proximate to the front body shell 108 to which it is attached and the wider side of the trapezoid on the top side of the rail 642. The rails 642 may be made of any appropriate material including, but not limited to aluminum, hard-coated aluminum (e.g., with titanium nitride) to reduce oxidation, carbon fiber, fiberglass, hard plastic, and hardened steel.

The carriage 538 shown in FIGS. 3A and 3E supports the tail section 104 of the vehicle 100. The tail section 104 may further include the rear shell 121, the steering mechanism 200, and the wheel assembly 201. The carriage 538 may be coupled to the track system 536 using one or more bearings. As shown in FIG. 3G, two bearings 644 are used for each rail 642. Each bearing 644 may include an assembly of three parts: an upper plate 645 and two tapered side walls 646 fastened to the upper plate 645. The assembled bearing 644 may define an opening with a cross-section substantially similar to the rail 642 (e.g., an isosceles trapezoid), which may be dimensioned to be slightly larger than the rail 642 to facilitate motion during use. The bearing 644, as shown, may thus be coupled to the rail 642 to form a “curved dovetail” arrangement where the inner sidewalls of the bearing 644 may contact the tapered outer sidewalls of the rail 642. The bearing 644 may not be separated from the rail 642 along any other DOF besides the desired DOF defined by rotational motion about the rotation axis 111. It should be appreciated FIG. 3G shows an exaggerated representation of the tolerances between the bearing 644 and the rail 642 for purposes of illustration. The tolerances, in practice, may be substantially smaller than shown. The plate 645 and the side walls 646 may be curved to conform to the curved rail 642.

In one example, the bearing 644 may be a plain bearing where the inner top and side surfaces of the bearing 644 slide against the top and side wall surfaces, respectively, of the rail 642 when mounted. The bearing 644 may also include screw holes in the top plate to couple (e.g., via bolts) the remainder of the carriage 538 to the track system 536.

The length of the bearing 644 (e.g., the length being defined along a direction parallel to the rail 642) may be greater than the width of the bearing 644. The ratio of the length to the width may be tuned to adjust the distribution of the load over the bearing surfaces and to reduce the possibility of binding between the bearing 644 and the rail 642. For example, the ratio may be in the range between about 3 to about 1. The bearing 644 may also have a low friction, high force, low wear working surface (e.g., especially the surface that contacts the rail 642). For example, the working surface of the bearing 644 may include, but is not limited to a Teflon coating, a graphite coating, a lubricant, and a polished bearing 644 and/or rail 642. Additionally, multiple bearings 644 may be arranged to have a footprint with a length to width ratio of ranging between about 1 to about 1.6 in order to reduce binding, increase stiffness, and increase the range of motion. Typically, a bearing 644 with a longer base may have a reduced range of motion whereas a bearing 644 with a narrower base may have a lower stiffness; hence, the length of the bearing 644 may be chosen to balance the range of motion and stiffness, which may further depend upon other constraints imposed on the bearing 644 such as the size and/or the placement in the vehicle 100.

The carriage 538 may further include two frame members 539, where each frame member 539 is aligned to a corresponding rail 642. On the side of the carriage 538 proximate to the rails 642, two cross bars 854 and 856 may be used to rigidly connect the two frame members 539 together. The bearings 644 may be attached to the frame members 539 at four attachment points 848a-d. On the side of the carriage 538 furthest from the rails 642, two support bars 851 may be used to support the wheel assembly 201 and the steering mechanism 200. The two support bars 851 may be connected together by another cross bar 850.

The carriage 538 and the track system 536 described above is just one example of a track-type articulated joint 106. Other exemplary articulated joints 106 may include a single rail or more than two rails. As shown above, the RCM may be located in the cabin of the vehicle 100 where the payload 2000 is located without having any components and/or structure that intrudes into said space. However, in other exemplary articulated joints 106, the RCM may be located elsewhere with respect to the vehicle 100 including, but not limited to, on the articulated joint 106, in vehicle subsystems (e.g., in the front section 102, in the tail section 104), and outside the vehicle 100.

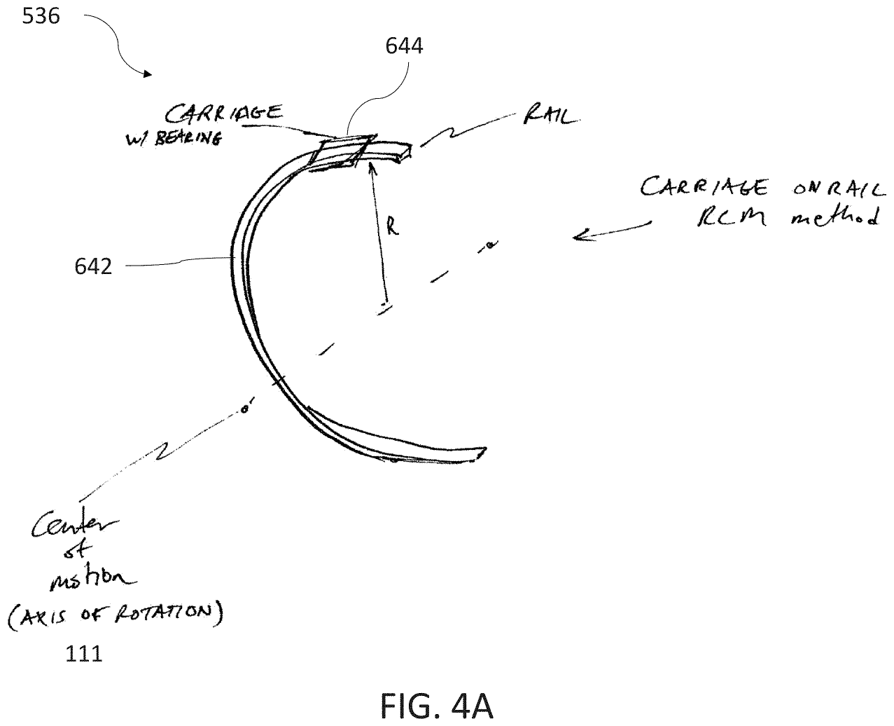

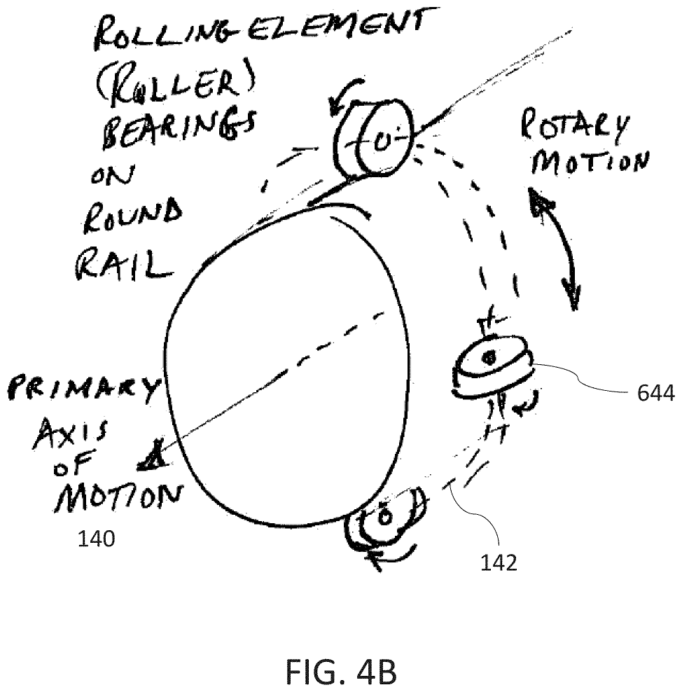

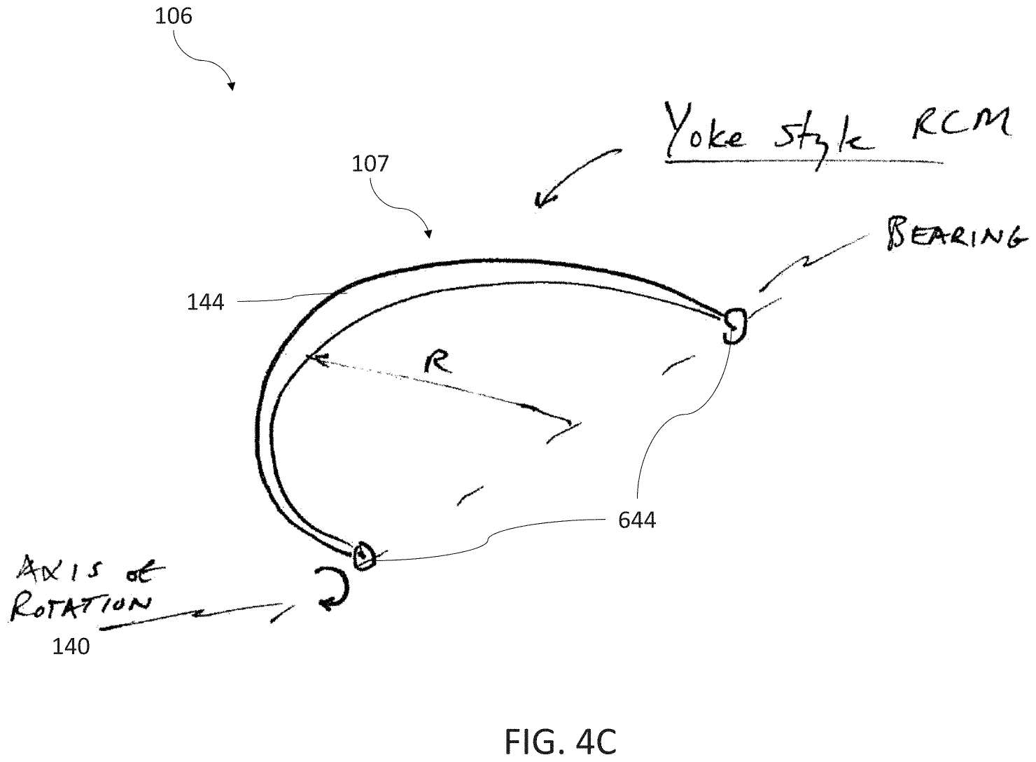

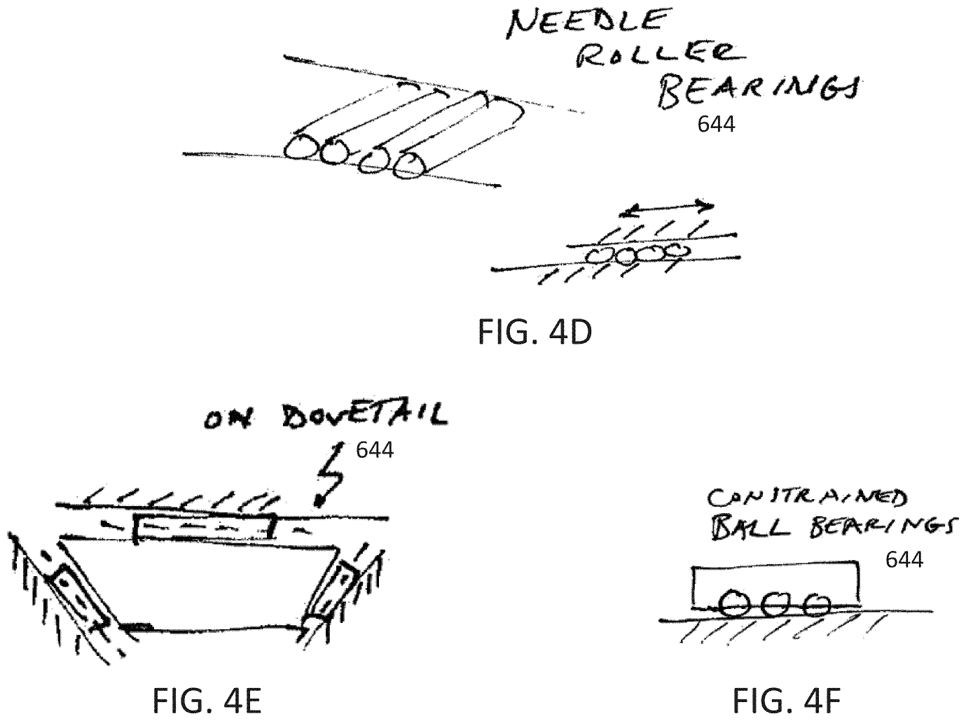

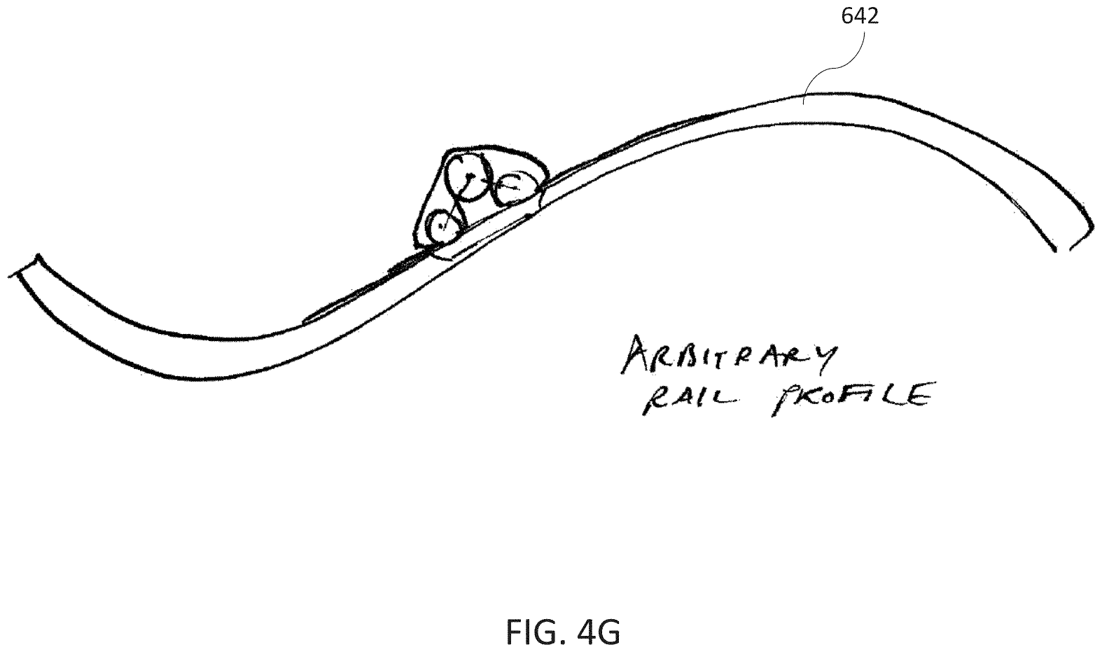

The curvature of the rails 642 described above are also based on an arc of a circle with a center point corresponding to the RCM where the rotation axis 111 is located as shown in FIG. 4A. Circular rails 642 allows the RCM to remain in a fixed location within the vehicle 100 during articulation. More generally, the rails 642 may have various curvatures including, but not limited to circular, elliptical, linear, an arbitrary curvature, and any combinations of the foregoing. FIG. 4G shows one example of a rail 642 having a sinusoidal curvature. The rail 642 may have a convex curvature and/or a concave curvature with respect to a reference point on the vehicle 100 (e.g., the passenger cabin). In some instances, the rail 642 may have a center of curvature that changes location as the carriage 538 is moved along said rail 642, such as the rail 642 shown in FIG. 4G. The rail 642 may be configured such that the center of curvature changes location but remains within a particular region of the vehicle 100, such as the passenger cabin. The carriage 538 may be constrained to the rail 642 by enveloping said rail 642 with various structures including, but not limited to a dovetail joint and a semicircular cross-section around a circular rail.

The bearing 644 described above is also just one example of a bearing that may be used in the articulated joint 106. In some cases, the shape of the rail 642 may determine the preferred type of bearing used based, in part, on the likelihood the bearing 644 and the rail 642 bind to one another. For example, the circular-shaped rail 642 may be advantageous when the bearing 644 is a plain bearing because the contact between the bearing 644 and the rail 642 does not change as the carriage 538 moves along the rail 642. This may reduce the likelihood of the bearing 644 on the carriage 538 binding to the rail 642. In another example, the bearing 644 may be an articulated bearing, which may also reduce binding between the bearing 644 and the rail 642. The articulated bearing may be a multi-segment plain bearing where the bearing is subdivided into segments that move relative to each other. However, in cases where the rail 642 has a curvature that deviates from an arc of a circle, other types of bearings may be more preferable.

Other types of bearings 644 may be used so long as the bearing 644 allows one part to move/slide relative to another part. Such bearings may include but are not limited to a plain bearing (see FIG. 4E), a roller bearing (see FIG. 4D), and a ball bearing (see FIG. 4F). The carriage 538 may also house and/or support the bearing 644 when coupled to the rail 642. For example, the carriage 538 described above may be used to support plain bearings designed to slide along the rail 642 with low friction and low wear.

In another example, the bearing 644 may use roller bearings to generate contact with the rail 642 and to constrain the motion of the carriage 538 along the desired path dictated by the geometry of the rail 642. The roller bearings may allow linear and/or rotary translation (e.g., translation along a straight path and/or a curved path). FIG. 4D shows one instance where the bearings 644 include an array of needle roller bearings to provide a substantially reduced coefficient of friction as well as more precise motion. Roller bearings may be disposed, for example, on an outer surface of a curved circular rail 642 or on a linear dovetail rail 642.

FIG. 4B shows another exemplary bearing 644 that includes roller bearings configured to provide a first rotational DOF about a primary axis of motion 140 and a second rotational DOF. As shown, the second rotational DOF may rotate about a secondary axis 142 that moves along the first rotational DOF. This type of multi-DOF bearing 644 may be used to compensate for misalignment between the carriage 538 and the track system 536 or to facilitate a kinematically constrained assembly.

FIG. 4F shows yet another exemplary bearing 644 that utilizes ball bearings. As shown, the ball bearings may be constrained by the carriage 538. Ball bearings may be used to further reduce physical contact between the bearing 644 and the rail 642 (e.g., ball bearings provide, in principle, a point contact whereas roller bearings provide a line contact), thus reducing both friction and wear.

In another example, the guide structure 107 may be a yoke-type mechanism to provide articulation about an RCM. FIG. 4C shows one exemplary articulated joint 106 that includes a yoke 144. The yoke 144 may be a curved member coupled at one (or both) ends to another component in the vehicle 100 via a bearing 644 such that the yoke 144 rotates about the axis 140. As shown, the yoke 144 may only intersect the axis 140 at one (or both ends), thus providing an RCM that may be located in an otherwise inaccessible portion of the vehicle 100. In practice, the yoke 144 may be attached to the exterior of a structure (e.g., a portion of the body 108, a portion of the rear outer shell 121) about which the yoke 144 rotates at or near the axis of rotation 140. This type of mechanism may be used in a similar manner to a visor on a helmet.

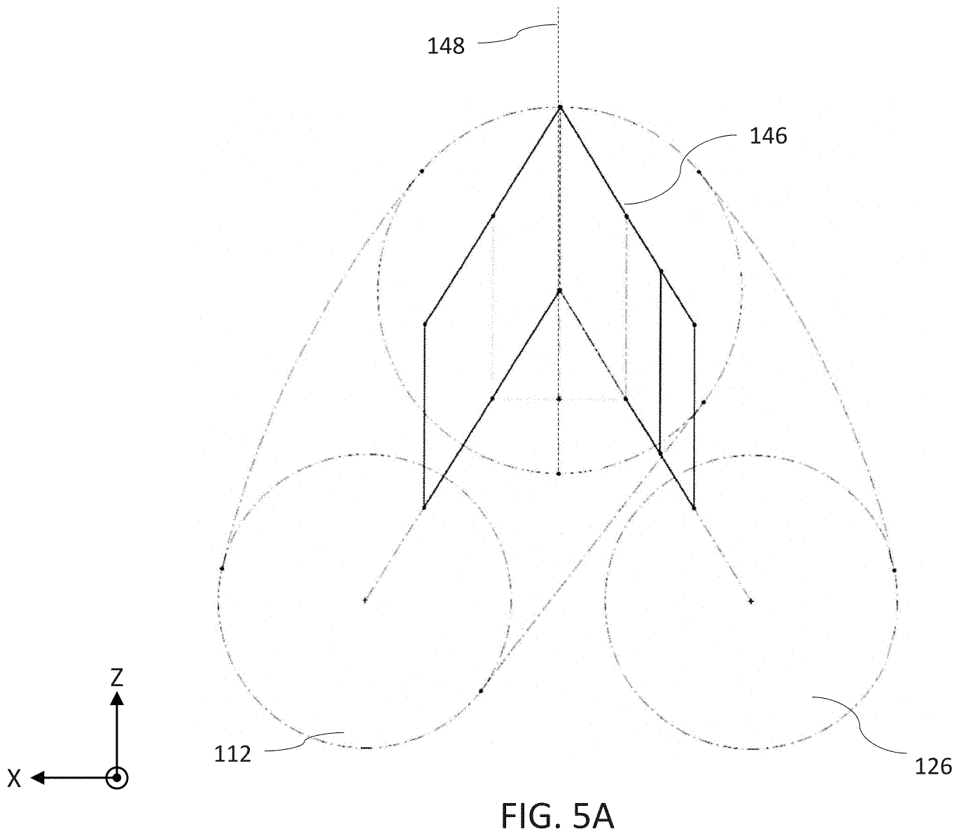

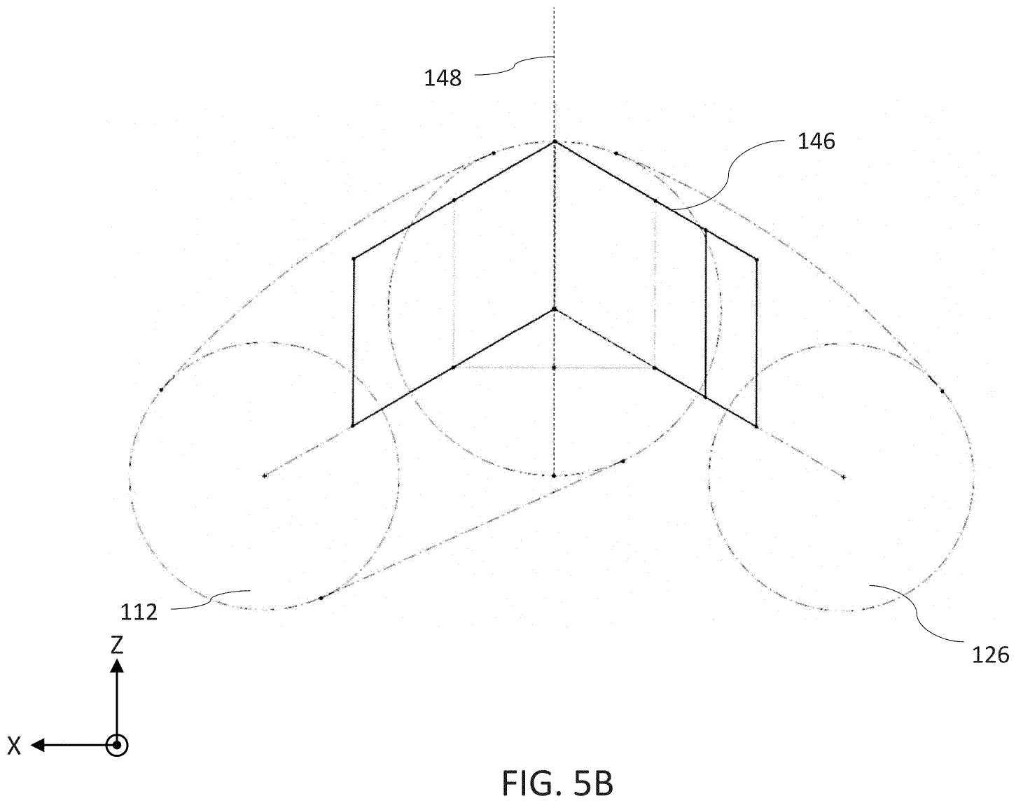

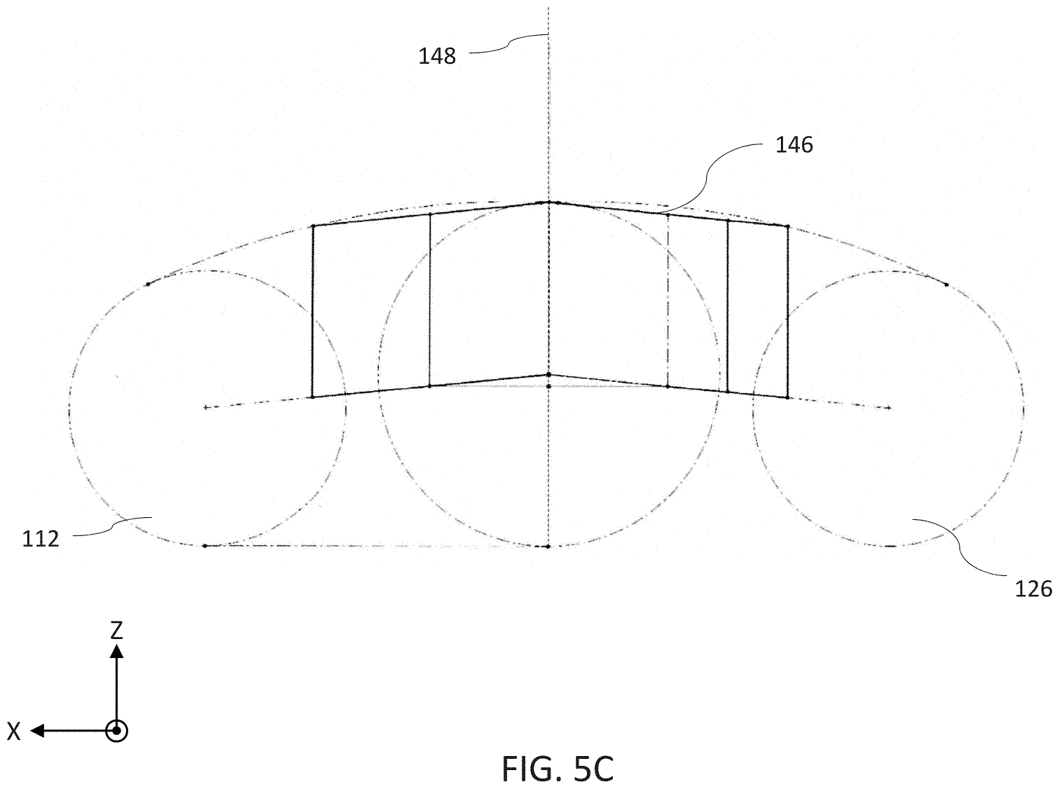

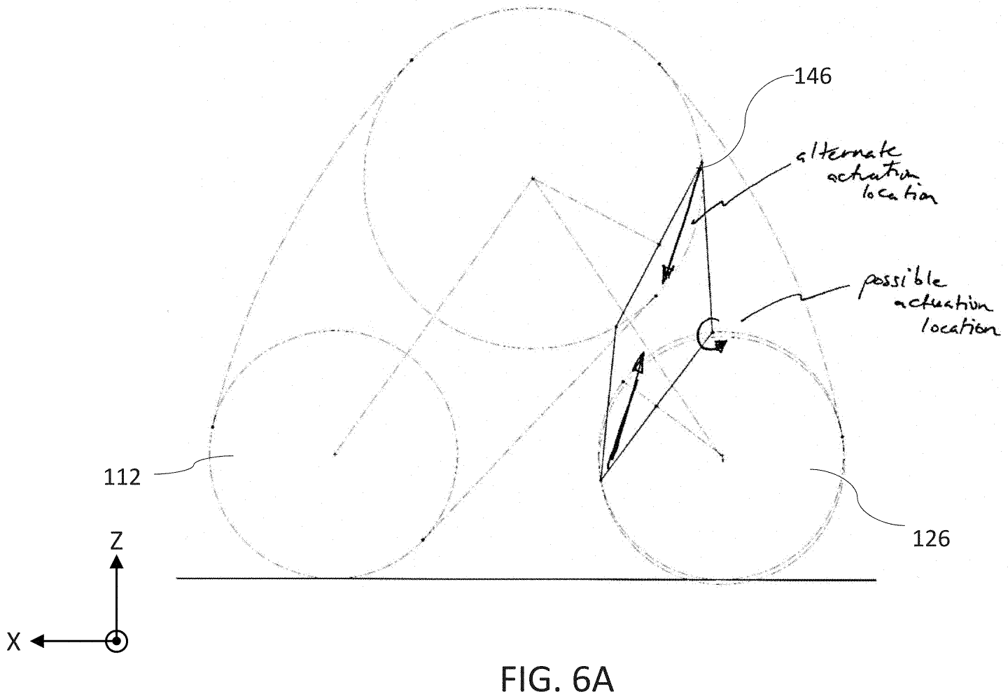

In yet another example, the guide structure 107 may be linkage-type mechanism comprised of multiple links coupled to one another via bearing joints. FIGS. 5A-5C show one exemplary articulated joint 106 that utilizes a four-bar linkage mechanism 146 to approximate a rotational DOF. As shown, the linkage mechanism 146 may reconfigure the vehicle 100 from a high profile configuration (FIG. 5A) to a low profile configuration (FIG. 5C). The linkage mechanism 146 may further allow other configurations between the high and low profile configurations, such as an intermediate profile configuration (FIG. 5B).

The linkage mechanism 146 may also be used, for example, to control the caster angle of a wheel (e.g., the front wheel 112 and/or the rear wheel 126) on the vehicle 100. As shown in FIGS. 5A-5C, the linkage mechanism 146 may change the caster angles of both the front wheel 112 and the rear wheel 126 as the vehicle 100 is reconfigured. In applications where small changes to the caster angle is preferable during articulation, the linkage mechanism 146 may replace the use of a separate mechanism (e.g., another articulated joint 106) that only adjusts the caster DOF of the wheel.

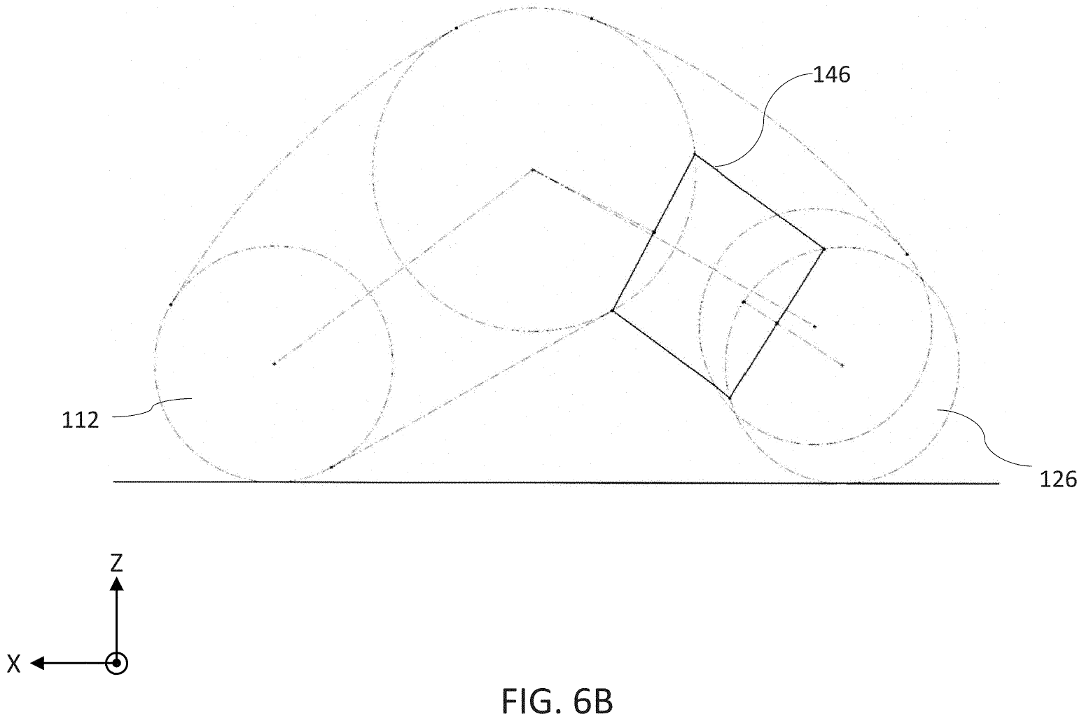

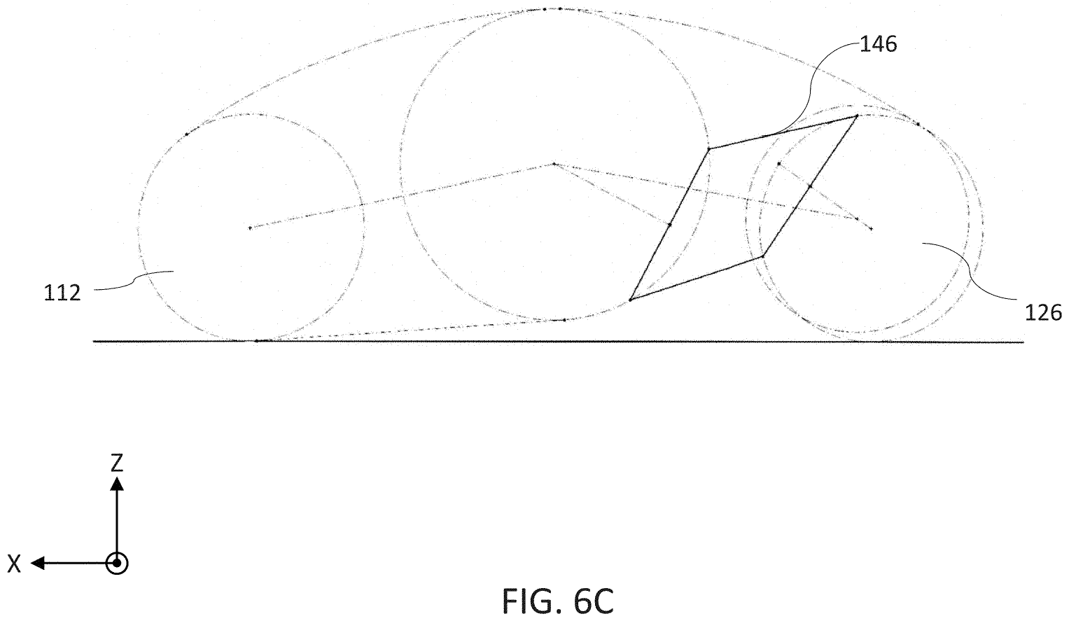

Additionally, the manner in which the four-bar linkage mechanism 146 is designed may also alter the extent by which the caster angle of the front wheel 112 and the rear wheel 126 is changed. FIGS. 5A-5C show the linkage mechanism 146 is a symmetric four-bar linkage about a center plane 148 of the vehicle 100 (e.g., the plane may be defined as containing the Y-axis and the Z-axis). This linkage mechanism 146 may provide symmetric motion of both the front wheel 112 and the rear wheel 126, thus maintaining a caster angle that is equal in magnitude between the two wheels. FIGS. 6A-6C show another exemplary four-bar linkage mechanism 146 mounted primarily on the rear wheel 126. This linkage mechanism 146 may be used to reconfigure the vehicle 100, change the caster angle of the rear wheel 126, and translate the rear wheel 126 along an axis (e.g., the axis aligned with the suspension of the rear wheel 126) relative to other components of the tail section 104.

Furthermore, two four-bar linkage mechanisms may be used, which may not have identical geometry, to independently change the caster angles of the front wheel 112 and the rear wheel 126 as the vehicle 100 is being articulated between the low-profile configuration and the high-profile configuration. The linkage mechanisms 146 in FIGS. 5A-5C and 6A-6C may be driven by an actuator (e.g., the drive actuator 540) about one or more of the joints or between two distal links or joints.

Other linkage-type articulated joints 106 may also be used in the vehicle 100 to articulation one component of the vehicle 100 with respect to another component. In one example, articulation about the Z-axis, as described above, may be facilitated by a single point pivot linkage mechanism. This linkage mechanism may be driven by a linear or a rotary actuator that causes the link to move about a pivot point defined by the mechanism.

### 3.2. An Exemplary Drive Actuator

The articulated joint 106 may receive an input force and/or torque to generate motion along one or more articulation DOF's. In some instances, an input force/torque applied externally to the vehicle 100 may be sufficient to provide actuation. For example, adaptive headlights disposed on the vehicle 100 may change orientation to increase driver visibility based on a centrifugal force applied to the vehicle 100 as the vehicle 100 makes a turn. In another example, an onboard display in the vehicle 100 may be reconfigured to maintain line of sight with a driver as the vehicle 100 is transitioning between a low profile configuration to a high profile configuration based on a gravitational force applied to said onboard display (e.g., the gravitational force causes the onboard display to slide along a rail configured to reorient said onboard display based on the configuration of the vehicle 100).

The articulated joint 106 may also receive an input force/torque from a drive actuator 540 disposed on the vehicle 100. The drive actuator 540 may be directly coupled to the other components of the articulated joint 106 (e.g., the drive actuator 540 may be installed onto the carriage 538). The drive actuator 540 may also be indirectly coupled to the other components of the articulated joint 106 (e.g., relative rotational motion of the front wheel 112 and the rear wheel 126 may cause actuation of the guide structure 107). Depending on the desired configuration of the vehicle 100 as well as the guide structure 107 used to provide articulation, various drive actuators 540 may be used including, but not limited to a belt drive, a rack and pinion system, a gear and chain drive, a pulley system, and a cable drive system.

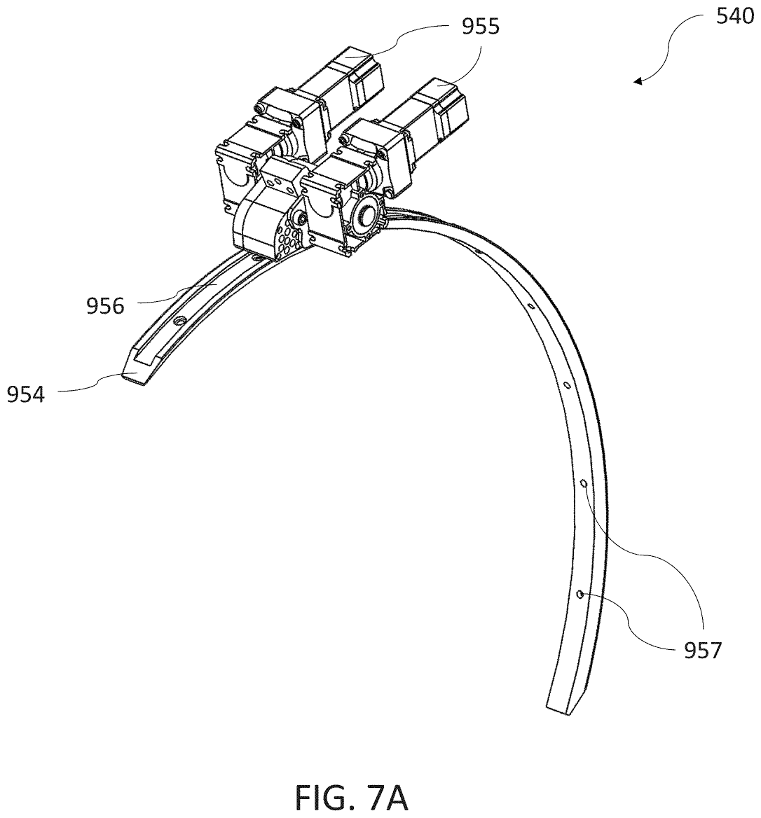

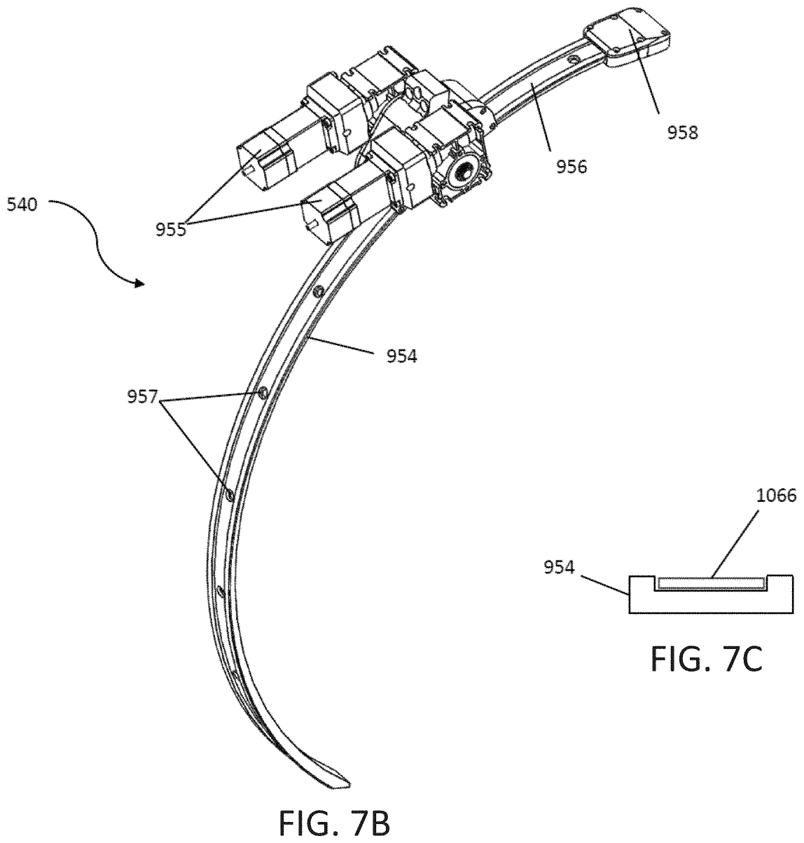

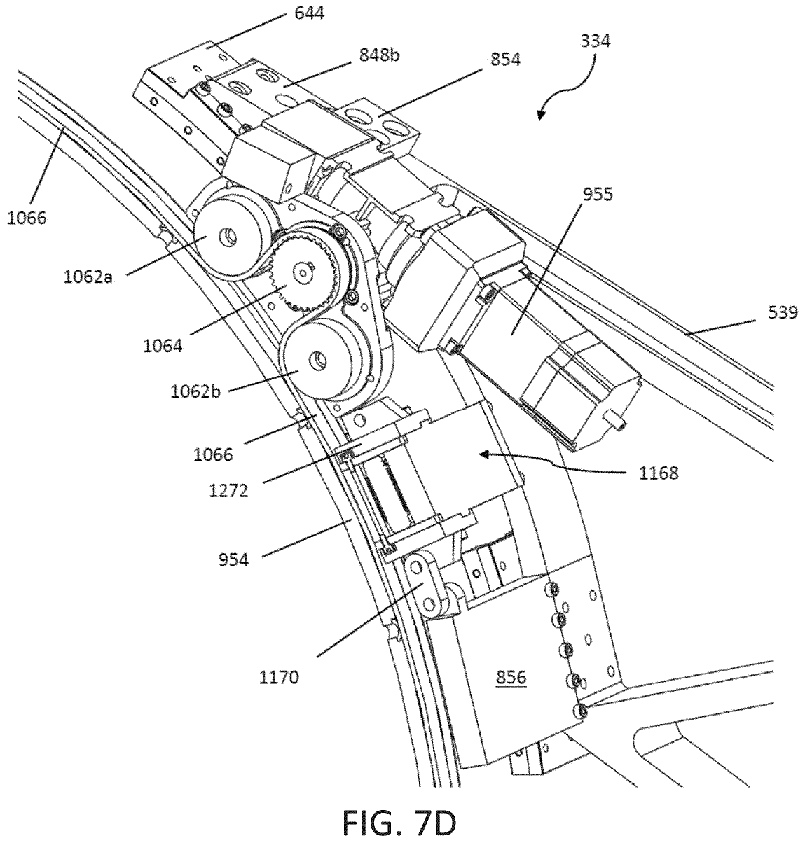

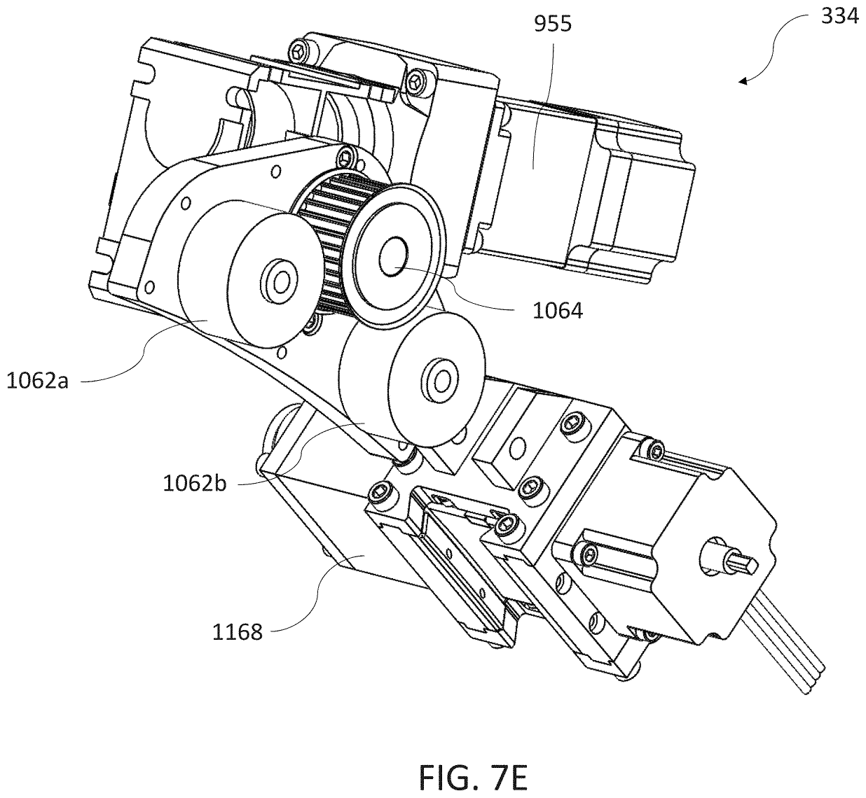

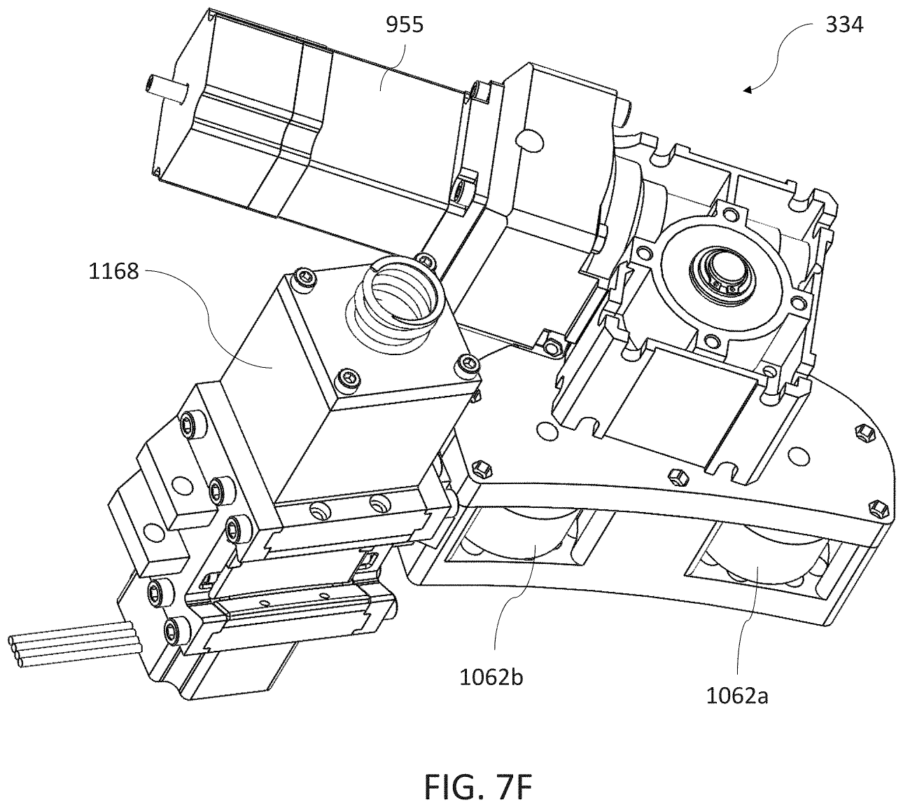

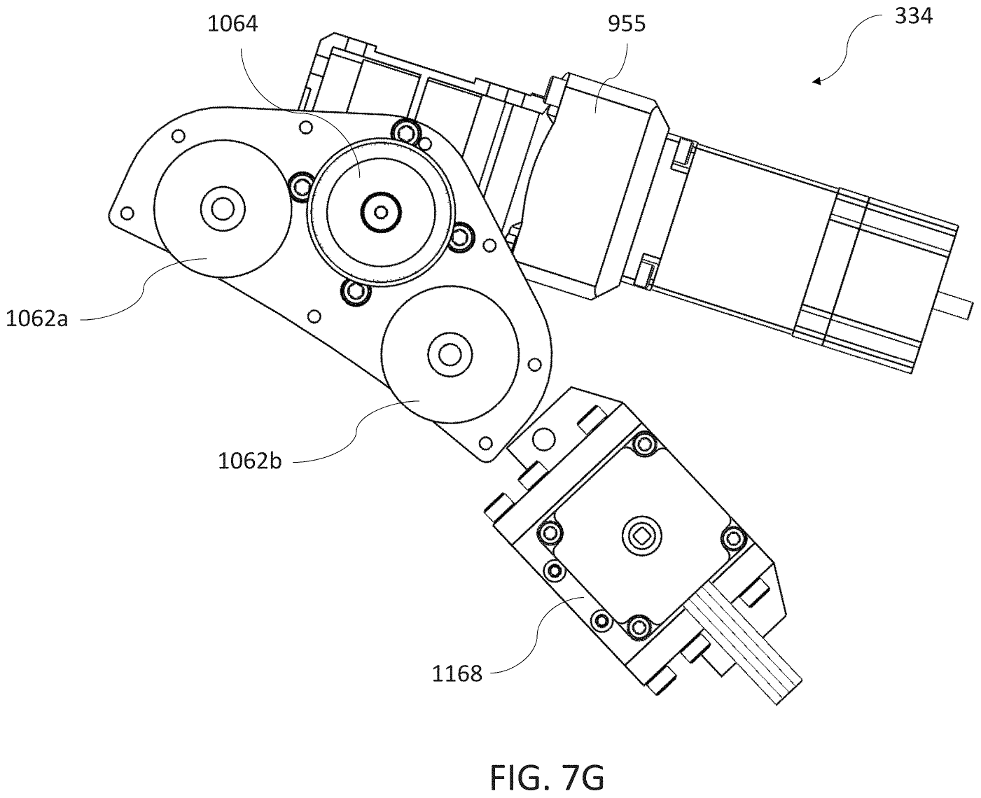

In one example, FIGS. 7A-7G show several views of an exemplary drive actuator 540 that moves the carriage 538 along the track system 536, which may be a track-type mechanism as shown. The drive actuator 540 may include a rail 954 and an actuator assembly 334. The rail 954 may have various cross-sectional shapes including, but not limited to a curved cross-section, a rectangular cross-section (as shown in FIG. 7C), and a polygonal cross-section. The rail 954 may also include a channel 956 that may be configured to hold a drive belt 1066 as shown in FIG. 7C.

The rail 954 may be similar to the rails 642 in the track system 536 on which the carriage 538 rides in that the rail 954 may have a curvature, such as an arc of a circle with a center point located on the axis of rotation 111. The rail 954 may further include one or more holes 957 formed along the length of the rail 954 in the channel 956 for receiving a coupling member, such as a bolt, to couple the rail 954 onto the back surface of the front vehicle section 102. The drive belt 1066 may be a toothed drive belt (e.g., such as a timing belt) with teeth located along an inner surface (e.g., the surface oriented towards and contacting the channel 956). The drive belt 1066 may be rigidly attached to a lower end of the rail 954 and adjustably attached to an upper end of the rail 954 using an adjustable belt clamp 958, thus holding the drive belt 1066 to the rail 954. The adjustable belt clamp 958 may include a tensioning device to adjust the tension of the drive belt 1066 on the rail 954 such that the drive belt 1066 is placed snugly into the channel 956 of the rail 954 and fully engaged with the actuator assembly 334. The drive belt 1066 may be made from various materials including, but not limited to neoprene with a fiberglass core and a high torque drive (HTD) timing belt.

The actuator assembly 334 may be mechanically coupled to a portion of the carriage 538, such as a first cross bar 854 as shown in FIGS. 3A and 7D. The actuator assembly 334 may include one or more motors 955 to move the actuator assembly 334 (and thus the carriage 538) along the length of the rail 954. The motor 955 may be various types of motors including, but not limited to a worm drive motor. In some instances, the actuator assembly 334 may include a single motor so long as said motor can output sufficient torque to actuate the articulated joint 106. In FIGS. 7A-7G, the motor(s) 955 may be used to operate a belt drive actuator 540. The belt drive actuator 540 may include a toothed drive gear 1064 positioned between two idlers 1062a and 1062b. The drive belt 1066 may snake under one idler 1062a, loop up over the drive gear 1064 so that the teeth of the gear 1064 engage with the teeth on the underside of the drive belt 1066, and then snake down under the other idler 1062b as shown in FIG. 7D. The idlers 1062a and 1062b may guide the belt 1066 onto the drive gear 1064 and ensure said belt 1066 is engaged with the drive gear 1064. The idlers 1062a and 1062b may also be used to align the belt 1066 with the channel 956 on the rail 954 by seating the belt 1066 at the entrance and exit of the drive actuator 540.

In this manner, the motor(s) 955 may rotate the drive gear 1064 such that the drive gear 1064 moves along the toothed belt 1066, thus pulling the carriage 538 along the rails 642 of the track system 536 described above and, hence, changing the configuration of the vehicle 100. The motor(s) 955 may be electronically controllable using an open loop controller (e.g., the actuator assembly 334 includes an encoder to monitor the position of the actuator assembly 334 without reference to the rail 954) or a closed loop controller (e.g., the drive belt 1066 and/or the rail 954 may have markings, which may be read using mechanically or optically, to track the position of the actuator assembly 334 along said drive belt 1066 and/or rail 954).

In another example, the drive actuator 540 may be a rack and pinion system. The rack may be a rail with teeth on at least one side. The rack may be straight or curved. In some instances, the rack may conform to a surface of the vehicle 100 onto which the rail 644 is mounted. For instance, the rack may be mounted onto the rear side of the front section 102. The pinion may be coupled to a motor on an opposing side of the rack (e.g., the tail section 104). The pinion may be a component (e.g., a gear) with teeth that mesh with the teeth of the rack. Thus, the motor may rotate the pinion causing the pinion to move along the rack and, hence, articulating the articulated joint 106. The pinion may be mechanically constrained to maintain contact with the rack as the pinion moves along the rack. This may be accomplished by applying a force (e.g., via a tensioned spring that applies a compressive force) such that the pinion is pressed onto the rack.

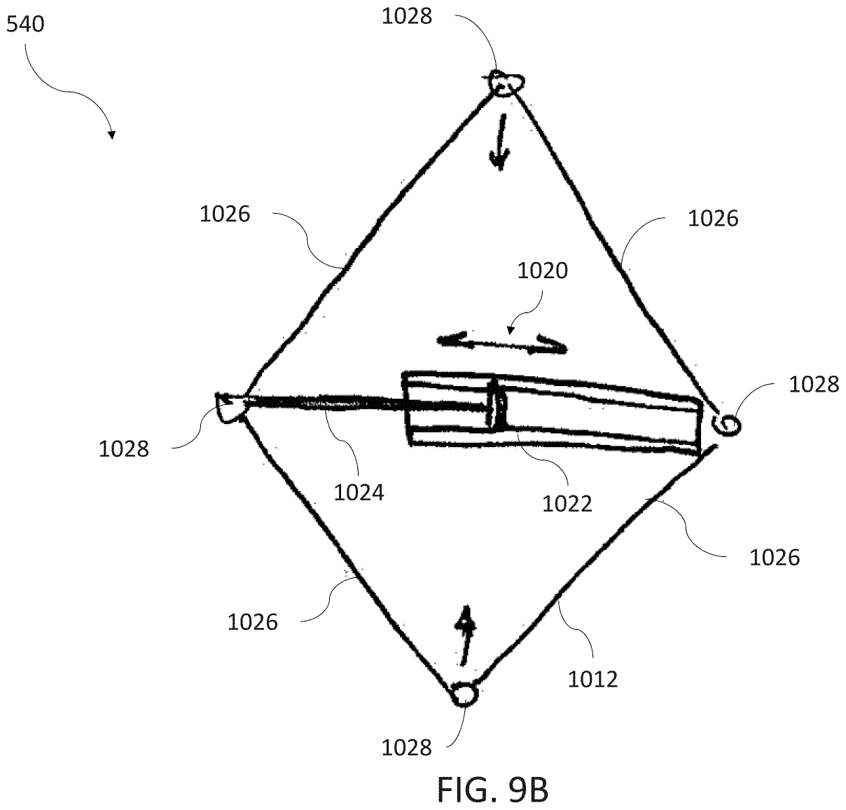

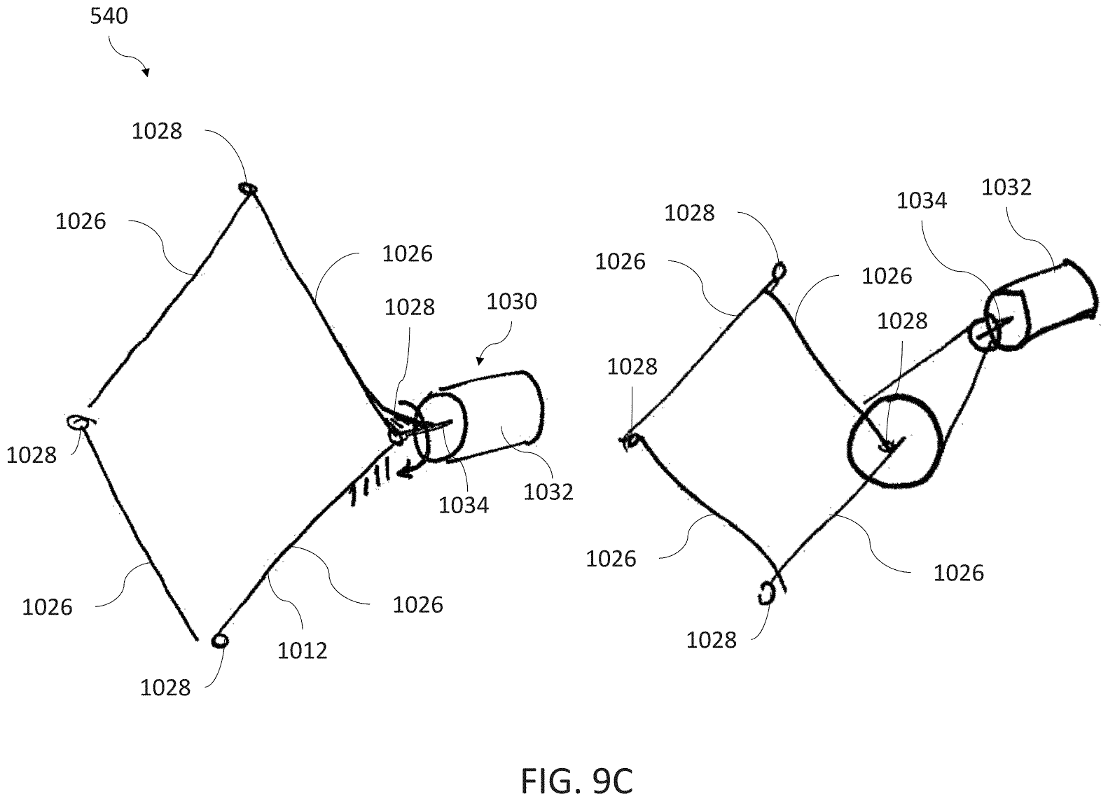

In another example, the drive actuator 540 may be a cable drive. FIG. 9A shows an exemplary cable drive 1010 used to actuate the articulated joint 106. The cable drive 1010 may include a support structure 1012 and a compliant cable 1014 coupled to the support structure 1012 via one or more pulley-type mechanisms to allow the compliant cable 1014 to slidably move relative to the support structure 1012. The compliant cable 1014 may be spun into one or more take up spools (e.g., take up spools 1016a and 1016b). A motor may be coupled to each take up spool and used to apply a torque to pull and/or maintain the compliant cable 1014 in tension. The support structure 1012 may be coupled to one component of the vehicle 100 (e.g., the front section 102) and the compliant cable 1014 may be coupled to another component of the vehicle 100 (e.g., the tail section 104). Furthermore, the compliant cable 1014 may conform to various shaped surfaces based on the shape of the support structure 1012. The cable drive 1010 may be used to actuate a track-type mechanism (e.g., the articulated joint 106 shown in FIGS. 3A-3G) or a linkage-type mechanism (e.g., the articulated joint 106 shown in FIGS. 5A-6C).

In another example, the drive actuator 540 may include a linear actuator to apply a linear force onto the articulated joint 106. FIG. 9B shows an exemplary drive actuator 540 that includes a linear actuator 1020 coupled to a support structure 1012. As shown, the support structure 1012 may include multiple links 1026 that are coupled to one another via pivot joints 1028. The linear actuator 1020 may include a housing 1022 and a piston 1024 that extends or retracts with respect to the housing 1022. The piston 1024 and the housing 1022 may each be coupled to a pivot joint, a link, or a component of the vehicle 100 (e.g., the front section 102 or the tail section 104). In other words, the housing 1022 may be coupled to one component of the vehicle 100 and the piston 1024 may be coupled to another component of the vehicle 100 (e.g., the housing 1022 is coupled to the front section 102 or the tail section and the piston 1024 is coupled to the tail section 104 or the front section 102, respectively). Thus, as the linear actuator 1020 is extended or retracted, the support structure 1012 may be correspondingly shortened or elongated, respectively, along an axis orthogonal to the linear actuator 1020. The linear actuator 1020 may be used to actuate a linkage-type mechanism including the four-bar linkage mechanisms shown in FIGS. 5A-6C and the single pivot point mechanism described above.

In another example, the drive actuator 540 may include a rotary actuator to apply a torque onto the articulated joint 106. FIG. 9C shows an exemplary drive actuator 540 that includes a rotary actuator 1030 coupled to a support structure 1012. The support structure 1012 may include multiple links 1026 joined to one another using pivot joints 1028. The rotary actuator 1030 may include a housing 1032 and a rotor 1034 that rotates with respect to the housing 1032, thus applying a torque to a component coupled to said rotor 1034. Similar to the linear actuator 1020 described above, the rotor 1034 and the housing 1032 may each be coupled to a pivot joint, a link, or a component of the vehicle 100 (e.g., the front section 102 or the tail section 104). In particular, the rotary actuator 1030 may be coupled to a link at the pivot joint, via a gear train, or via a belt. For instance, the housing 1032 is coupled to the front section 102 or the tail section and the rotor 1034 is coupled to the tail section 104 or the front section 102, respectively. As shown in FIG. 9C, the rotary actuator 1030 may be coupled to a pivot joint 1028 such that an applied torque causes rotation of at least one link 1026, thus actuating the support structure 1012. In this manner, the rotary actuator 1030 may also be used to actuate the four-bar linkage mechanisms shown in FIGS. 5A-6C and the single pivot point mechanism described above.

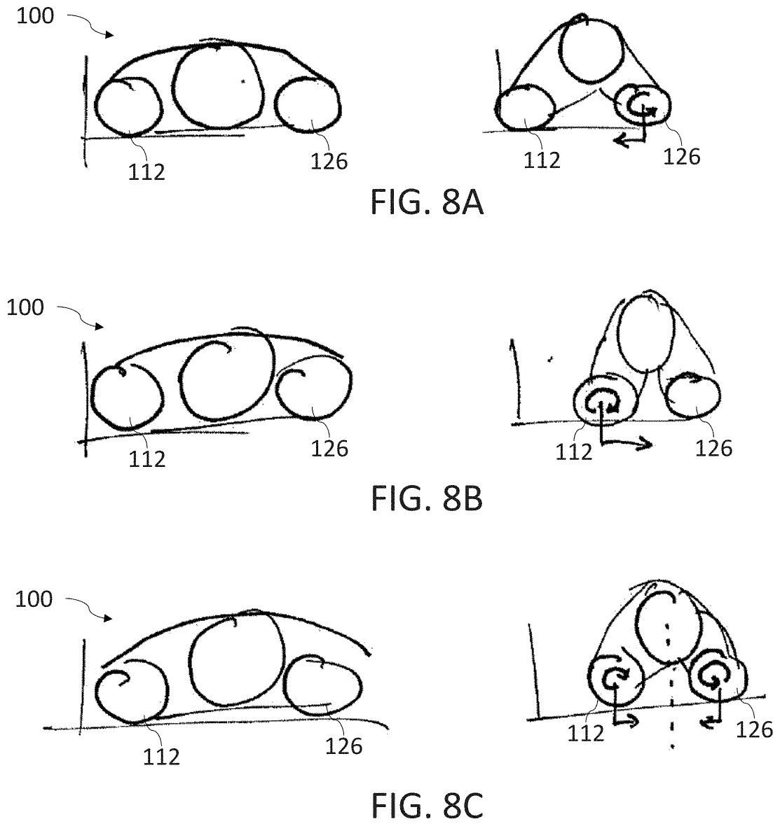

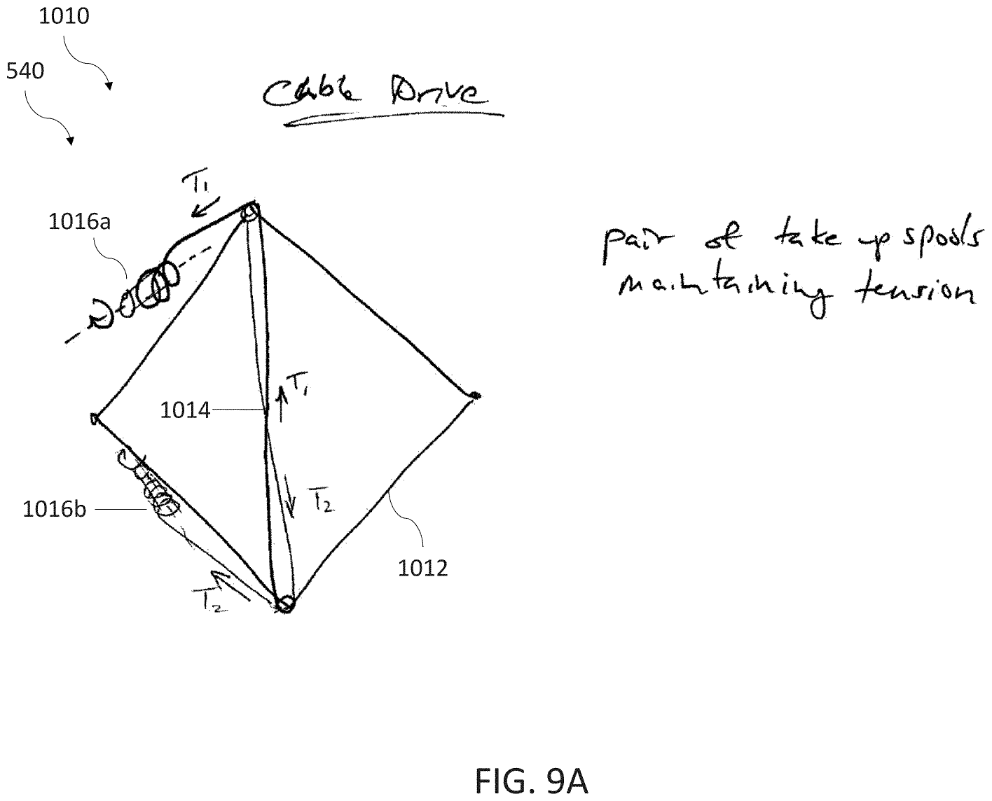

In yet another example, the drive actuator 540 may use the traction motors of the articulated vehicle 100 to drive and/or assist the articulation motion of the articulated joint 106. Each wheel of the vehicle 100 (e.g., the front wheel 112 and the rear wheel 126) may each have a traction motor to drive said wheels when moving the vehicle 100. If the traction motors apply a different torque to the front wheel 112 and the rear wheel 126, the resultant relative motion of the front wheel 112 and the rear wheel 126 may actuate the articulated joint 106. FIGS. 8A-8C show several various configurations where one or both wheels of the vehicle 100 are driven. For instance, FIG. 8A shows on example where the rear wheel 126 is driven and the front wheel 112 is being held in place by a brake, thus causing the rear wheel 126 to rotate towards the front wheel 112, thereby changing the vehicle 100 from a low profile configuration to a high profile configuration. FIG. 8B shows a similar approach where the front wheel 112 is driven and the rear wheel 126 is held in place by a brake. FIG. 8C shows another approach where both the front wheel 112 and the rear wheel 126 are driven. In this approach, actuation may occur if the front wheel 112 and rear wheel 126 are driven differently.

This drive actuator 540 may augment other drive actuators 540 disposed on the vehicle 100, which may be undersized and/or unable to output a sufficient driving force to actuate the articulated joint 106. Additionally, driving the front wheel 112 and the rear wheel 126 separately may also allow more complex articulation motion profiles. For instance, the vehicle 100 may have an inchworm type motion along a desired trajectory by alternating between braking the front wheel 112 while driving the rear wheel 126 and braking the rear wheel 126 while driving the front wheel 112. In another instance, the front wheel 112 and the rear wheel 126 may be driven such that a center point of the vehicle 100 may be held to desired position with respect to the local coordinate system of the vehicle 100 or follow a desired trajectory.

### 3.3. An Exemplary Brake

The drive actuator 540 described above may include one or more motors 955 that are not readily back-drivable. In other words, the motor(s) 955 tend to hold respective components of the vehicle 100 (e.g., the front section 102 and the tail section 104) at the desired configuration. However, relying upon the motor(s) 955 as a brake between articulated components in the vehicle 100 may damage the drive belt 1066 due to sustained static and/or dynamic loading while the vehicle 100 is parked or driving.

For at least this reason, the articulated joint 106 may also include a brake 1168 to hold the articulated joint 106 at a desired configuration. The brake 1168 may be an active system or a passive system. For both types of systems, the brake 1168 may hold a position of the guide structure 107 when the drive actuator 540 is not actuating the articulated joint 106. In an active system, the brake 1168 may consume energy to generate a force that constrains the motion of the guide structure 107 along the articulation DOF. For instance, the brake 1168 may include a plunger that imparts a force told the guide structure 107 in place when energized by a motor. When the plunger is not energized, the guide structure 107 may be allowed to move. A passive system may operate in substantially opposite manner to the active system where the brake 1168 does not consume energy (e.g., from a battery) to hold the guide structure 107 in place, but instead may consume energy when releasing the brake (e.g., again by energizing a plunger).

The choice between an active and a passive brake 1168 may depend, in part, on the frequency and duration in which the articulated joint 106 is used. For example, the articulated joint 106 that actuates the vehicle 100 between a low profile configuration and a high profile configuration in FIGS. 1A-1E may not be used for extended periods of time when the vehicle 100 is parked or being driven for long stretches in a single environment (e.g., along a highway). Thus, a passive brake 1168 may be more appropriate to reduce power consumption. In another example, an articulated joint 106 used to assist with steering may be frequently used, especially when the vehicle 100 is being driven in an urban environment (e.g., in a city). Thus, an active brake 1168 may be more appropriate to reduce power consumption.

Additionally, a passive brake 1168 may provide some advantages related to safety. For instance, the passive brake 1168 may maintain a holding force even when various subsystems of the vehicle 100 lose power. This allows the articulated joint 106 to remain sufficiently rigid for vehicle dynamic stability and/or crash integrity.

In the following description, several exemplary passive brakes 1168 are discussed that utilize stored mechanical energy and various mechanisms to hold a position of the guide structure 107. However, it should be appreciated that other types of braking mechanisms may be used to impart a constraining force to prevent unwanted motion of the guide structure 107. In one aspect, the design of the brake 1168 may depend, in part, on the type of guide structure 107 used in the articulated joint 106. As described above, the configuration of the brake 1168 may also depend on the manner in which the articulated joint 106 is used in the vehicle 100. Various types of actuators may be used in the brake 1168 including, but not limited to a hydraulic actuator, a pneumatic actuator, and an electromechanical actuator.

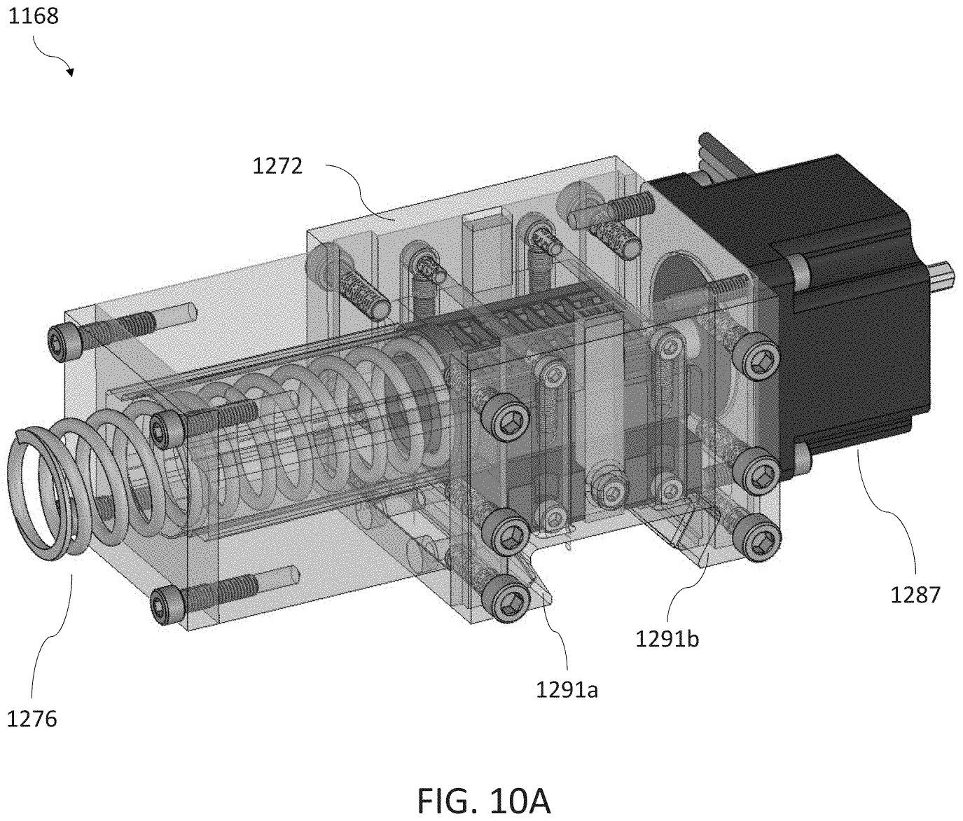

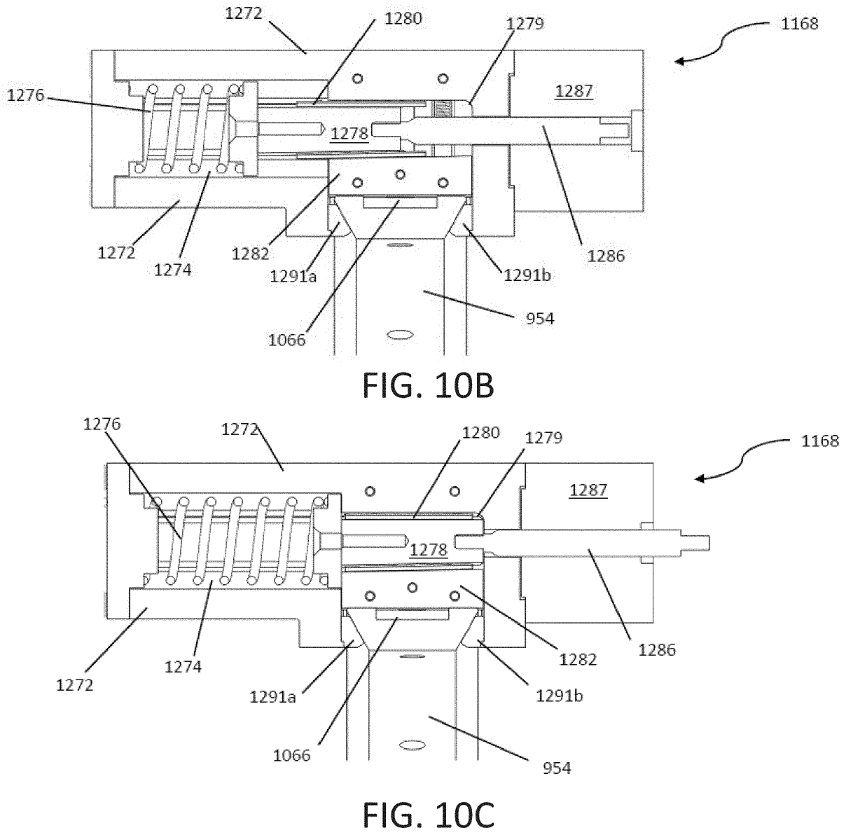

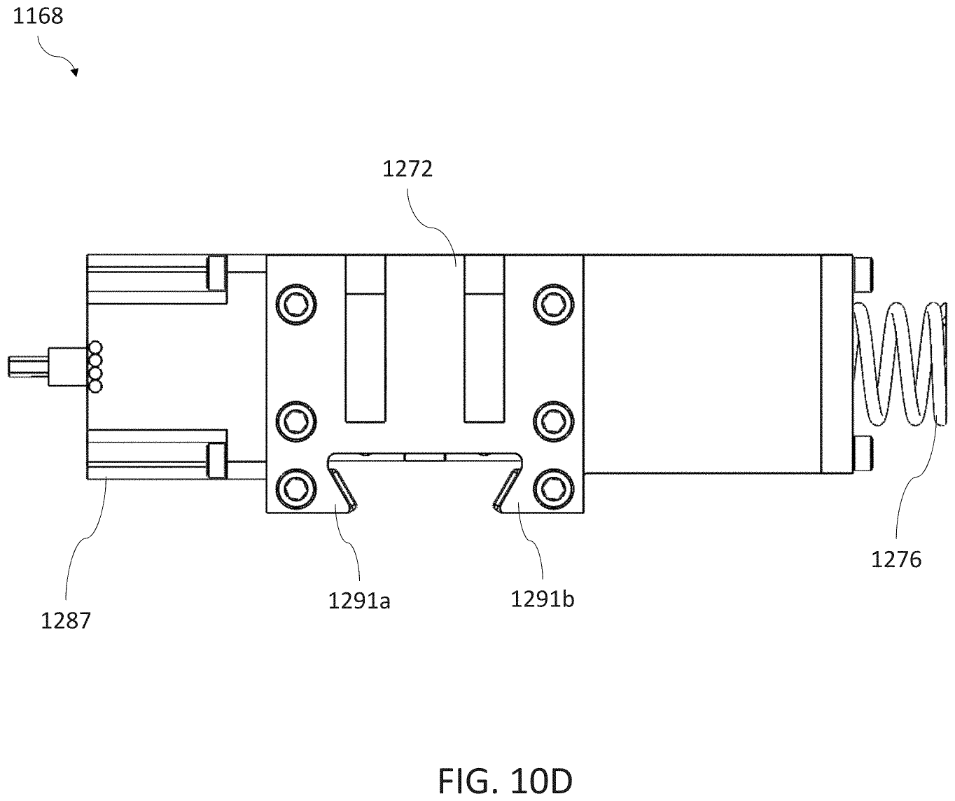

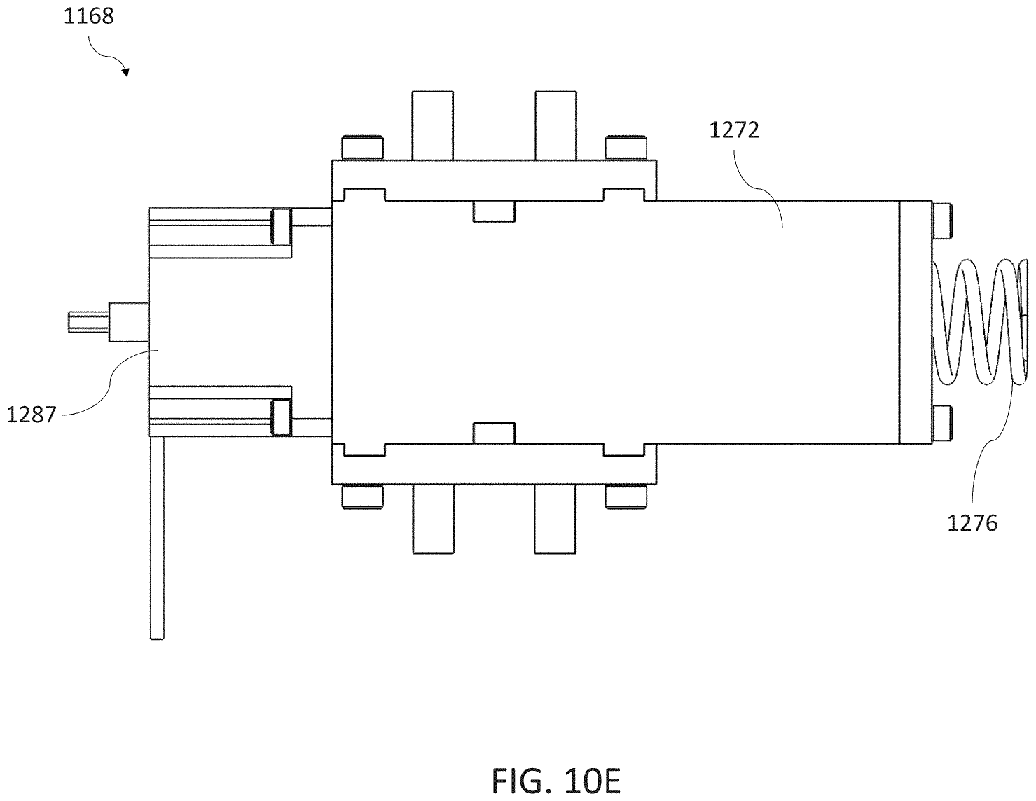

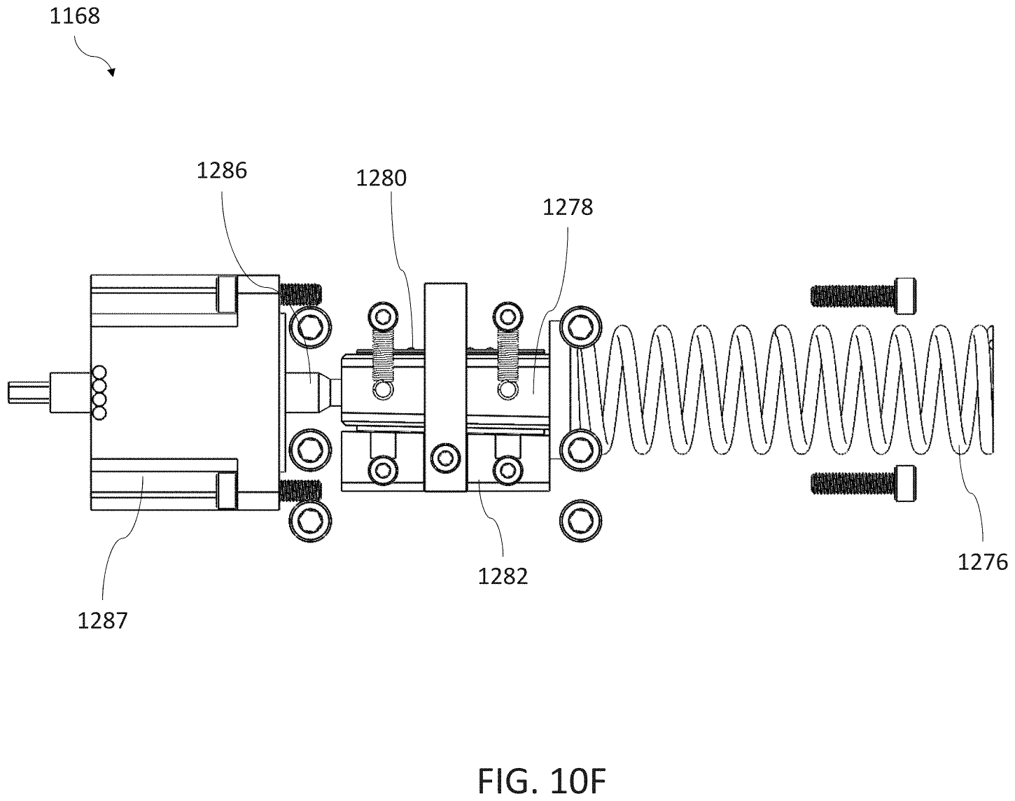

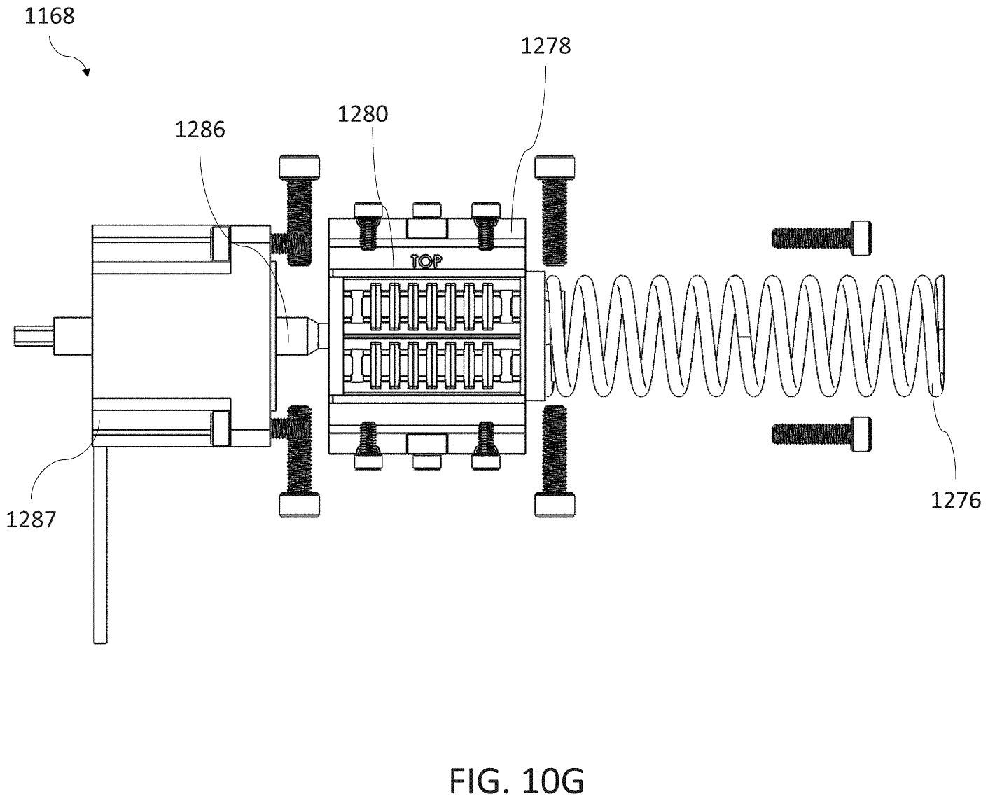

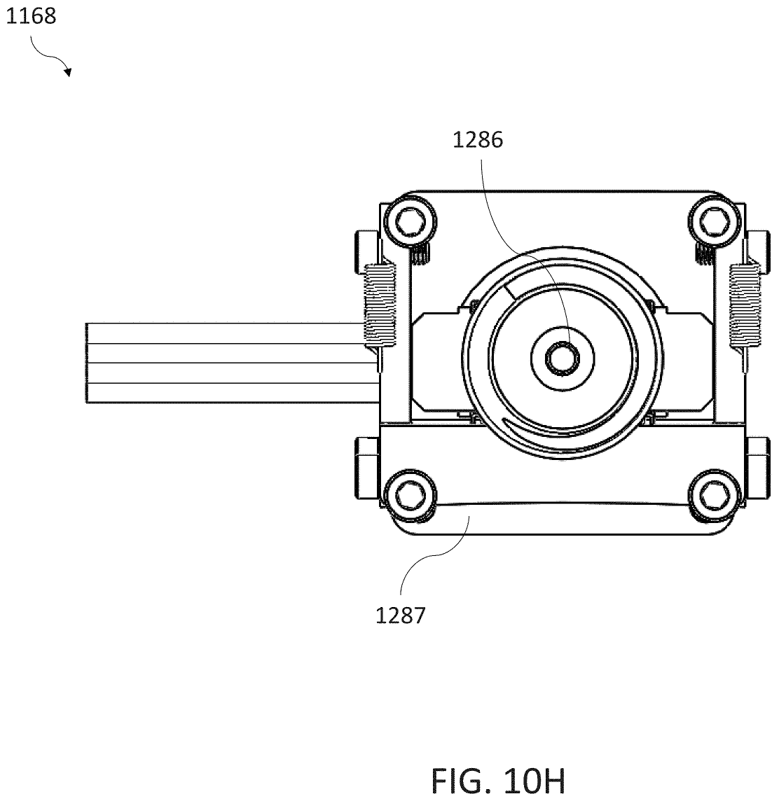

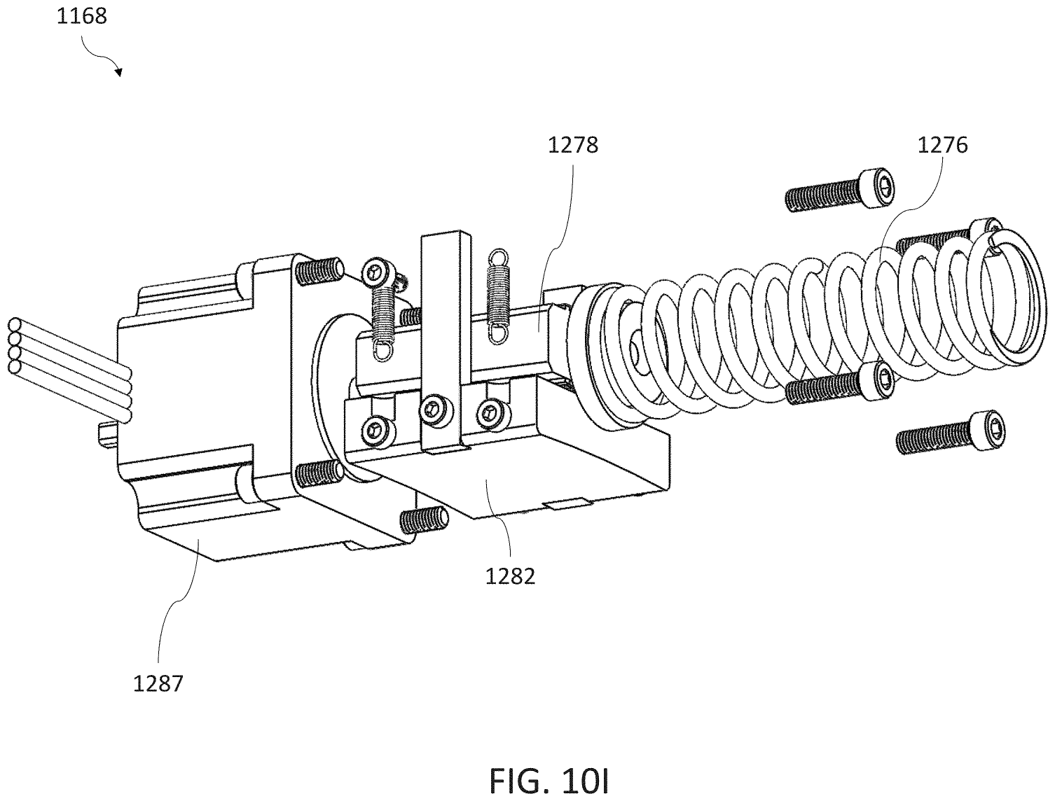

FIGS. 10A-10I show several views of an exemplary brake 1168 configured to work in the articulated joint 106 shown in FIGS. 3A-3G. As shown, the brake 1168 may include a housing 1272, an actuator 1287 disposed on one side of the housing 1272 to operate a plunger 1286, a compression spring 1276 held within a chamber 1274 defined by the housing 1272 on another side of the housing 1272 opposing the actuator 1287, and a brake mechanism 1275 located between the actuator 1287 and the compression spring 1276. The brake mechanism 1275 may include a brake shoe 1282, a movable wedge member 1278, and bearings 1280 (e.g. needle roller bearings) between the movable wedge member 1278 and the housing 1272 and between the wedge member 1278 and the brake shoe 1282.

The brake shoe 1282 may be shaped as a right rectangular prism or a rectangular parallelepiped with an angled upper surface (i.e., the surface adjacent to the wedge member 1278) producing a taper. The taper of the brake shoe 1282 is such that the brake shoe 1282 is thinner on the side nearest the compression spring 1276 and thicker on the side nearest the actuator 1287. The wedge member 1278 may also be shaped as a right rectangular prism or a rectangular parallelepiped, similar to the brake shoe 1282, with an angled lower surface (i.e., the surface adjacent to the brake shoe 1282) producing a taper that meshes with the taper of the brake shoe 1282. The taper of the wedge member 1278 is such that the wedge member 1278 is thicker on the side nearest the compression spring 1276 and thinner on the side nearest the actuator 1287. FIGS. 10B and 10C show the brake shoe 1282 may be held within the housing 1272 such that the brake shoe 1282 may move vertically up and down, but not horizontally from side to side. On the other hand, the wedge member 1278 may move horizontally in and out of the chamber 1274. The housing 1272 may be mounted onto the rail 954 by two wedge-shaped retainer bars 1291a and 1291b such that the bottom surface of the brake shoe 1282 contacts the top of the rail 954.

The compression spring 1276 may be configured to apply a force on the wedge member 1278 that pushes the wedge member 1278 towards the actuator 1287 and into greater engagement with the brake shoe 1282 as shown in FIG. 10C. In other words, the compression spring 1276 imparts a force onto the brake shoe 1282 via the wedge member 1278 to increase the frictional force holding the carriage 538 on the rail 954. If the actuator 1287 is energized, the plunger 1286 may apply a force sufficient to push the wedge member 1278 towards the compression spring 1276, which causes the spring 1276 to be compressed and disengagement of the wedge member 1278 from the brake shoe 1282 as shown in FIG. 10B. The force imparted from the wedge member 1278 onto the brake shoe 1282 is progressively reduced until the wedge member 1278 is moved out of the chamber 1274, which then allows the brake shoe 1282 to be moved upwards thus releasing the brake on the rail 954. The strength of the compression spring 1276 may be selected to ensure the carriage 538 does not slide along the rails 954 under anticipated operating conditions (e.g., higher external loads on the vehicle 100), thus holding the selected vehicle configuration.

The taper on the wedge member 1278 and the brake shoe 1282 may have a slope defined as the ratio of (1) the width of each respective component (i.e., the horizontal distance from the side closer to the compression spring 1276 to the side closer to the actuator 1287) and (2) the height of the taper (i.e., the difference in the height of the component on the side closer to the compression spring 1276 and the height of the component on the side closer to the actuator 1287). The slope may range between about 1:1 to about 50:1. In other words, the force applied on the wedge member 1278 by the compression spring 1276 may result in a force on the brake shoe 1282 that is amplified by a factor ranging between about 1 to about 50. In some cases, the ratio may vary beyond this range depending on several factors including, but not limited to the holding force used to support the articulated joint 106 at a desired configuration, the amount of force available for actuation, the tolerance of the brake shoe to the braking surface, the actuation distance available.

The brake 1168 may be coupled on one side to the cross member 856 using links 1170 and coupled on another side to the belt drive actuator 540 using other similar links (not shown). The links 1170 may be used to adjust the angle between the brake shoe 1282 and the rail 954 to compensate for possible manufacturing inconsistencies, to reduce wear on the brake shoe 1282, and/or to adjust the braking force when the brake shoe 1282 is engaged with the rail 954.

It should be appreciated the use of the wedge member 1278 and the brake shoe 1282 in combination with the compression spring 1276 and the actuator 1287 is one example of the brake 1168 that may be used in the articulated joint 106. In another example, the brake 1168 may be a detent system with an actuator that similarly obstructs movement of the carriage 538 over the track system 536 when the actuator is not activated. In addition, the brake 1168 may also be configured to interface with the rails 642 of the track system 536 or some other surface of the vehicle 100 rather than the rail 954 of the drive actuator 540.

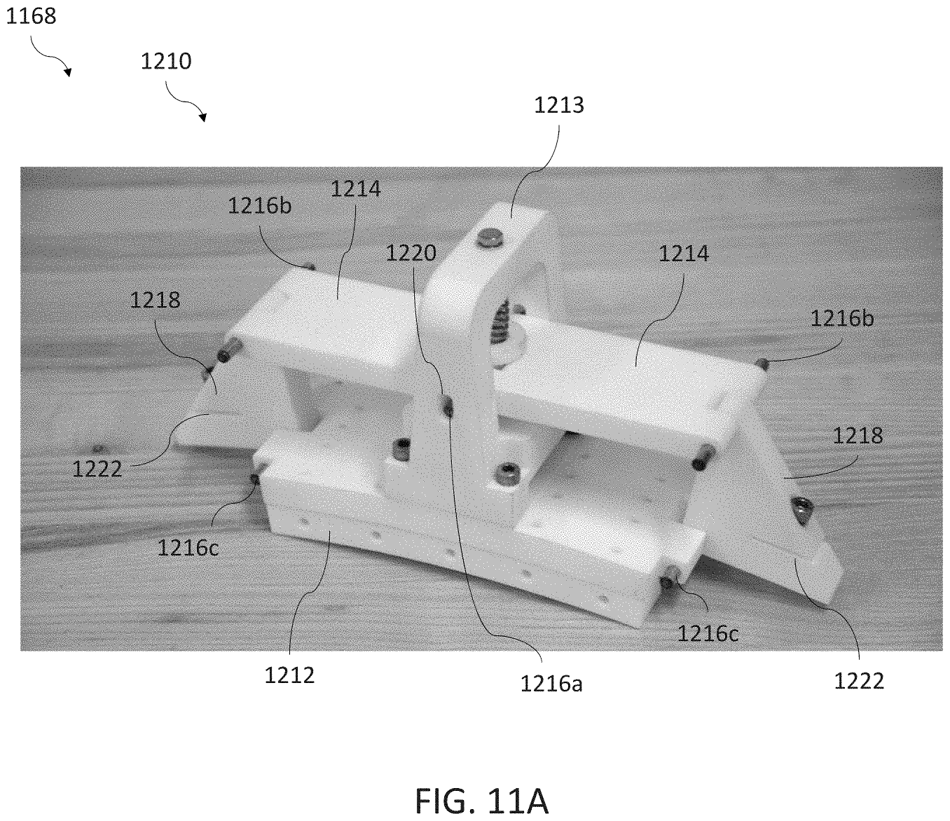

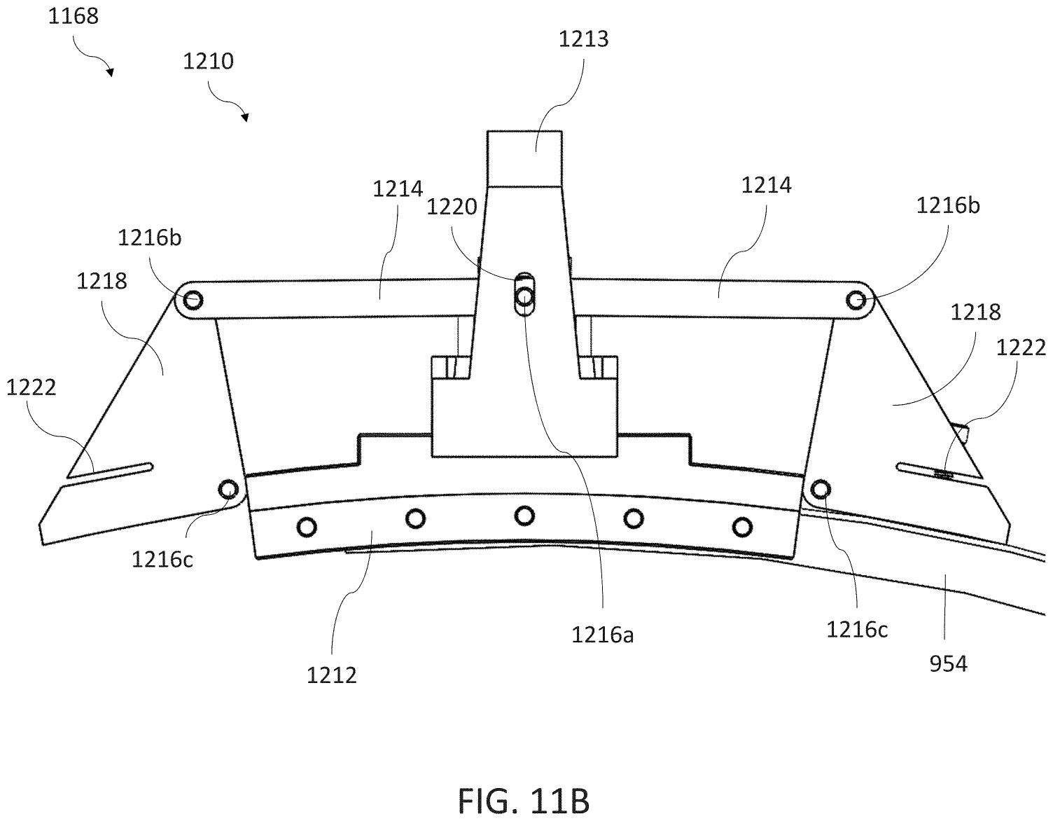

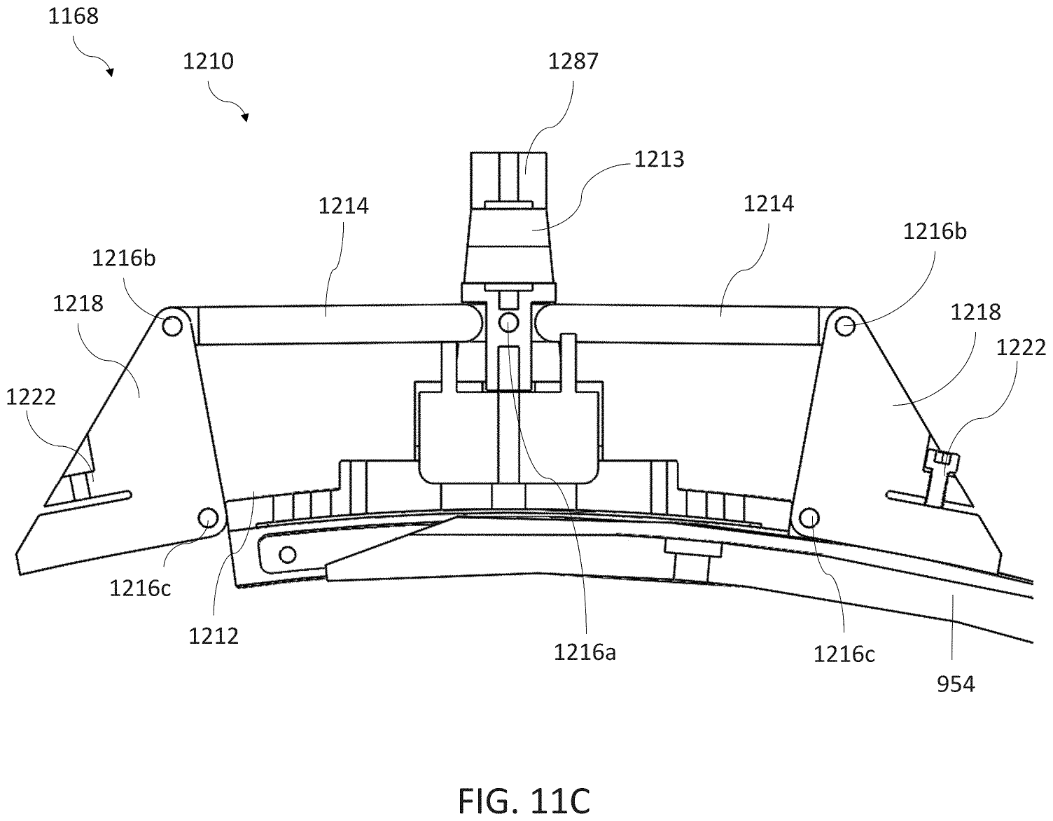

FIGS. 11A-11C show another exemplary brake 1168 that utilizes a toggle linkage mechanism 1210 to control the braking force applied onto the rail 954 of the drive actuator 540 (or the rail 642 of the track system 536). The linkage mechanism 1210 may include a support structure 1212 mounted onto the rail 954 using by two wedge-shaped retainer bars similar to that previously described. Thus, the support structure 1212 may slide along the rail 954. In this manner, the support structure 1212 may be directly coupled to the carriage 538 and the rail 954 coupled to the track system 536. The support structure 1212 may also be curved to conform to a curvature of the rail 954.

The support structure 1212 may further include a holder 1213 with two opposing slots 1220. A pair of links 1214 may each be rotatably coupled to one another via a pivot joint 1216a where the pivot joint 1216a is slidably adjustable along a path defined by the slots 1220. Each link 1214 may also be rotatably coupled to a braking member 1218 via a pivot joint 1216b. The braking member 1218 may also be rotatably coupled to the support structure 1212 via a pivot joint 1216c as shown.

In this manner, as the pivot joint 1216a is moved along the slots 1220, the relative motion of the two links 1214 that results may cause the braking members 1218 to be either: (1) pressed into the rail 954 thereby imparting a braking force to hold the carriage 538 onto the track system 536 or (2) released from the rail 954 allowing the carriage 538 to be moved along the track system 536 unimpeded. The mechanism 1210 may include an actuator 1287 to controllably move the pivot joint 1216a along the slots 1220. The braking force applied by the braking members 1218 onto the rail 954 and the motion profile of the braking members 1218 with respect to the pivot joint 1216a may depend on various factors including, but not limited to the length of the slot 1220 (e.g., affects travel distance of joint 1216a), the relative orientation of the links 1214 (e.g., convex angle or concave angle relative to the rail 954, substantially parallel), and the possible inclusion of a spring along the axis of the actuator 1287 to position the pivot joint 1216a to one side of the slot 1220 when the actuator 1287 is inactive.

Additionally, each braking member 1218 may include an adjustment feature 1222 to adjust the braking force applied by the braking member 1218 on the rail 954. For instance, the adjustment feature 1222 may be tuned to impart a braking force sufficient to maintain a desired configuration during normal operating conditions without causing excessive wear on the braking member 1218. In one example, the adjustment feature 1222 may include a slot formed into the braking member 1218 and a fastener as shown in FIG. 11B. The fastener is used to adjust the width of the slot (e.g., larger or smaller), which affects the contact between the braking member 1218 and the rail 954 and, hence, the braking force.

Although the primary function of the brake 1168 is to constrain thus maintaining a desired configuration of the vehicle 100, the brake 1168 may allow for some compliance along one or more DOF's, which can enable additional modes of operation that benefit operation of the vehicle 100 and the payload 2000 stored within the vehicle 100. For example, a compliant element may be incorporated in a series arrangement with the brake mechanism such that the brake mechanism may hold a fixed position in the guide structure 107 while the compliant member allows some compliance (e.g., a predetermined fixed or variable rate) along one or more DOF's. This form of compliance may be referred to as a continuous duty dynamic compliance, which may be present during normal operation of the vehicle 100.

In one application, the continuous duty dynamic compliance may be used as part of the suspension of the vehicle 100 (e.g., the vehicle 100 may still have a dedicated suspension system in addition to the compliance provided by the brake 1168). By allowing some compliance, the brake 1168 may reduce forces imparted on the payload 2000 (e.g., the driver, the goods transported by the vehicle 100) from the road on which the vehicle 100 is being driven along. This form of suspension may increase user comfort by reducing and/or damping noise and vibrations from the road. This suspension may also reduce fatigue on the vehicle 100 (e.g., the chassis, other subsystems of the vehicle 100) by damping the energy input from the road onto the vehicle 100 directly.

In another example, the compliant element may be configured to be a consumable component designed for single use under certain conditions. For example, the compliant element may reduce and, in some instances, mitigate damage when the vehicle 100 experiences a high impact event (e.g., a crash, hitting a pothole, hitting a curb of a sidewalk). The compliant element in the brake 1168 may fail when the vehicle 100 receives an external force input that exceeds a predetermined threshold (e.g., a yield strength) based on the design of the compliant member. For example, when the front wheel 112 hits a pothole, the compliant element may break in order to reduce damage to the body 108 in the front section 102 or the rear outer shell 121 in the tail section 104. In this manner, such external force inputs may only damage a low cost, replaceable element in the vehicle 100, thus reducing the time and expense of repair. In conventional vehicles, damage to the vehicle chassis (e.g., bending, deformation, fracture) may lead to high costs to repair said damage.

In the event of a crash (e.g., vehicle collision), the compliant element may be used to attenuate, at least to some extent, the forces imparted on the vehicle 100 during said crash. Although the body 108 of the vehicle 100 (e.g., a composite monocoque chassis shell) may be mechanically strong and survivable in a crash scenario, it is also important to protect the payload 2000 (e.g., the occupants). The primary approach to protecting occupants in vehicular accidents is to absorb as much energy as possible in the chassis of the vehicle during a crash event. In the case of the articulated vehicle 100, the ability for the vehicle 100 to change configuration may be leveraged to absorb at least some of the energy during the crash (e.g., a head on collision may cause the vehicle 100 to change configuration by transitioning from a low profile configuration to a high profile configuration). In some instances, the articulated joint 106 may be tuned to the crash absorption by applying loads to the vehicle 100 (e.g., the front section 102 or the tail section 104) that reduce or even cancel the loads from the crash impulse, thus reducing the acceleration (or deceleration) imparted on the payload 2000.

The brake 1168 may be regarded as a safety critical element. When considering various designs for the brake 1168, considerations should be made with respect to various parameters that may affect braking performance including, but not limited to wear, corrosion, and contamination. In one aspect, the components of the brake 1168 that impart said braking force may be formed from various materials that have a high coefficient of static friction including, but not limited to aluminum, cast iron, and iron. The brake 1168 may also be configured to accommodate some degree of wear (e.g., similar to brake pads in conventional vehicles). The brake 1168 may also be designed to facilitate cleaning and maintenance by incorporating clearances and/or removable components in the brake 1168 that allow contaminants to be readily removed.

### 3.4. An Exemplary Secondary DOF in the Articulated Joint

The articulated joint 106 may also support additional DOF's in conjunction with the articulation DOF described thus far. These additional DOF's may or may not be coincident with the articulation DOF. For example, the multi-DOF bearing shown in FIG. 4B is one example of multiple DOF's coinciding with a primary articulation DOF. In another example, the articulated joint 106 may include the steering mechanism 200 to facilitate steering of a wheel in the vehicle 100 (e.g., the front wheel 112 and/or the rear wheel 126) about an axis different from the primary articulation DOF.

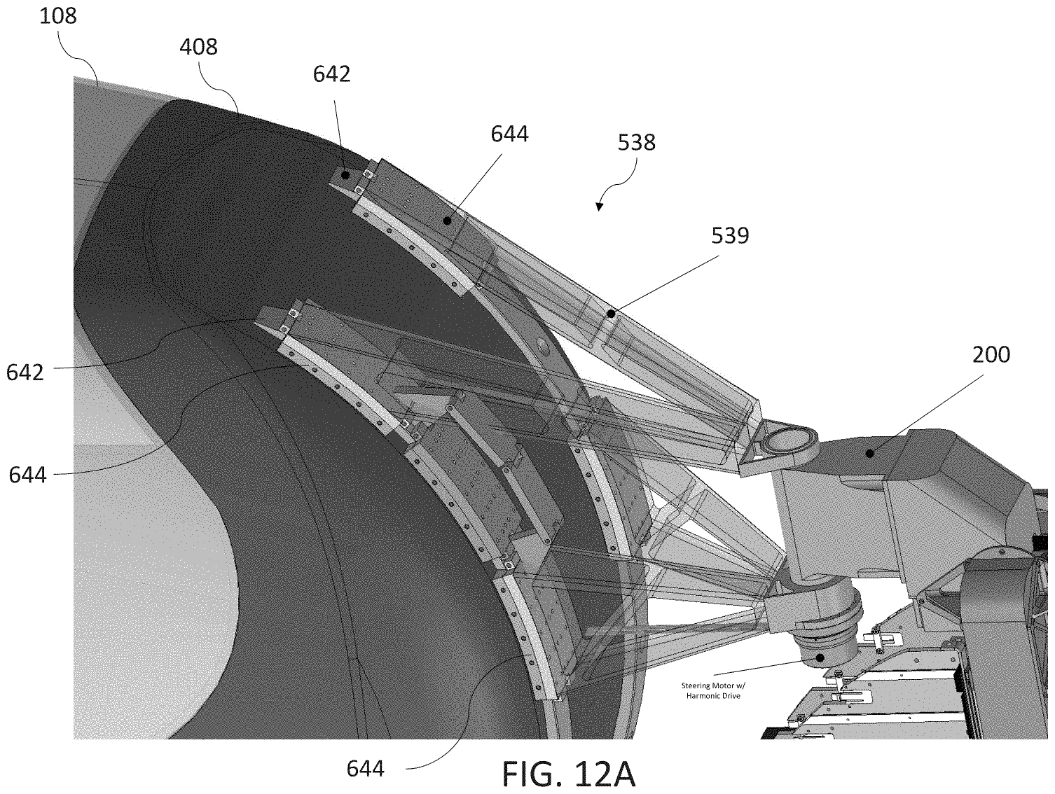

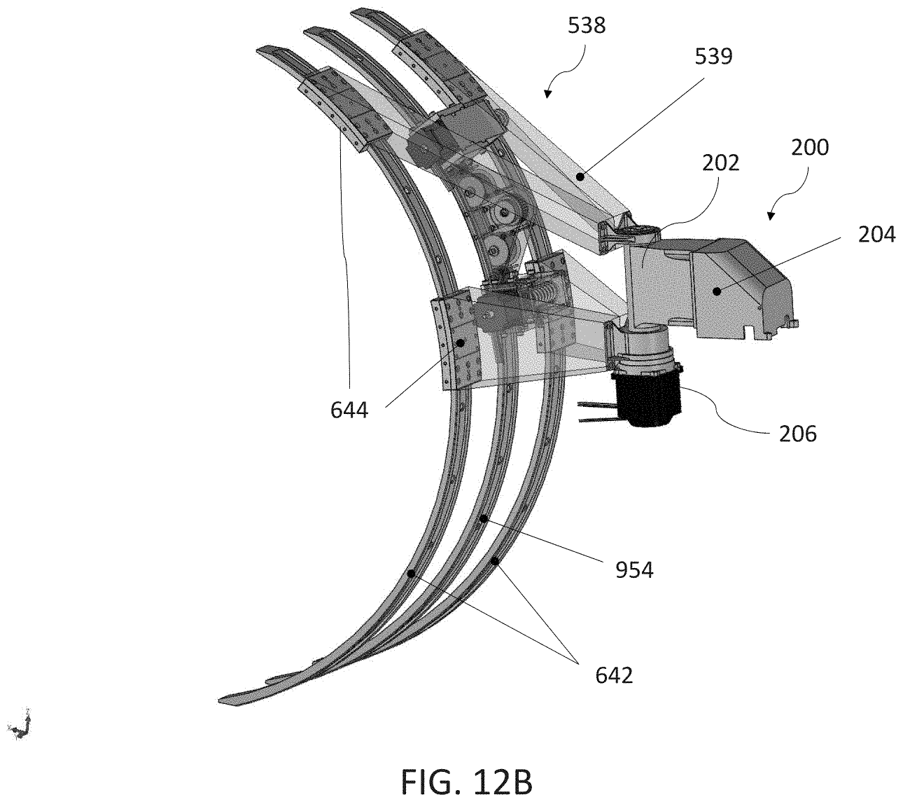

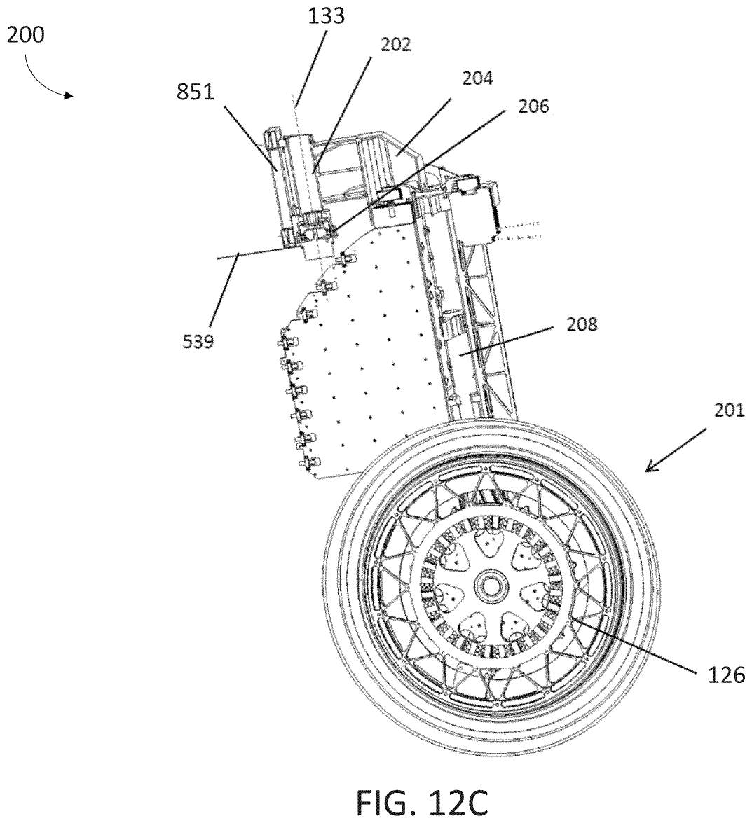

FIGS. 12A-12C show an exemplary steering mechanism 200 coupled to the carriage 538 to steer the rear wheel 126. As shown, the steering mechanism 200 may include a fork suspension assembly 208, a wheel assembly 201 held at a lower end of the fork suspension assembly 208, a bearing assembly 202 that defines a steering axis 134 (e.g., the non-orthogonal axis 133 described above), a steering box 204 that connects the upper end of the fork suspension 208 to the bearing assembly 202 and defines the steering trail of the rear suspension, and a steering motor 206 that rotates the steering box 204 about the steering axis 134. In some configurations, the steering motor 206 may only rotate the rear wheel 126 relative to other components in the tail section 104. In some configurations, the steering motor 206 may rotate both the rear wheel 126 and the other components in the tail section 104 together. The steering motor 206 may be electronically controlled by the driver or an onboard computer.

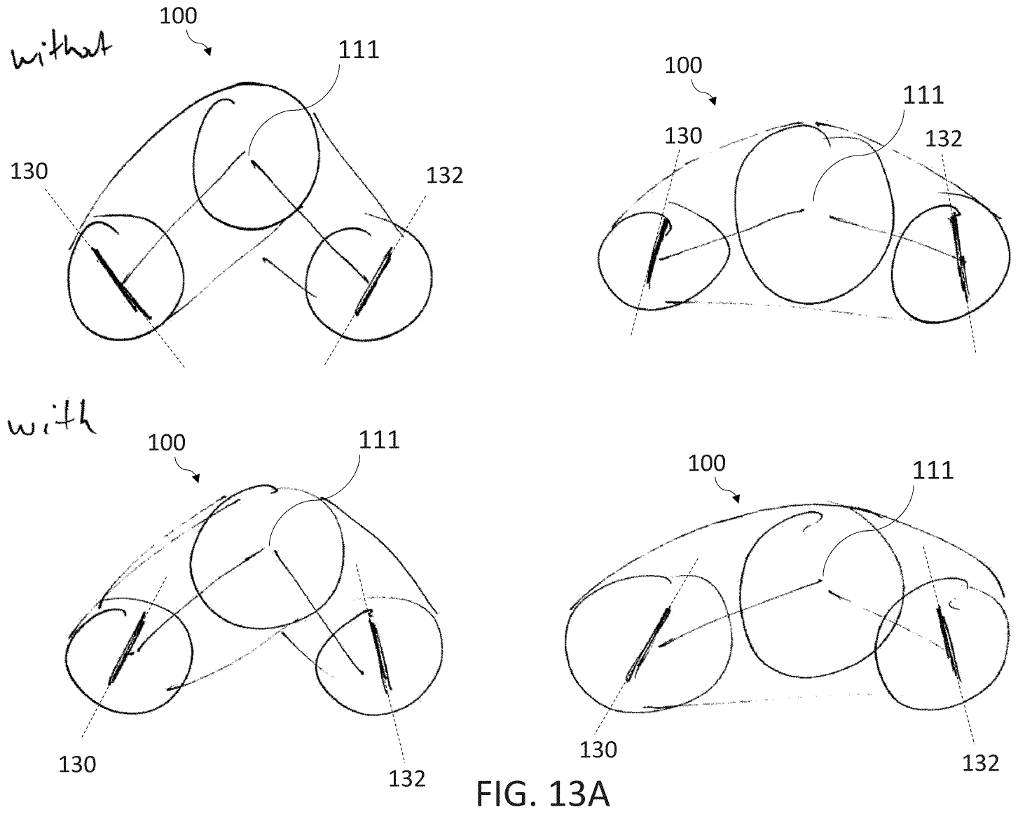

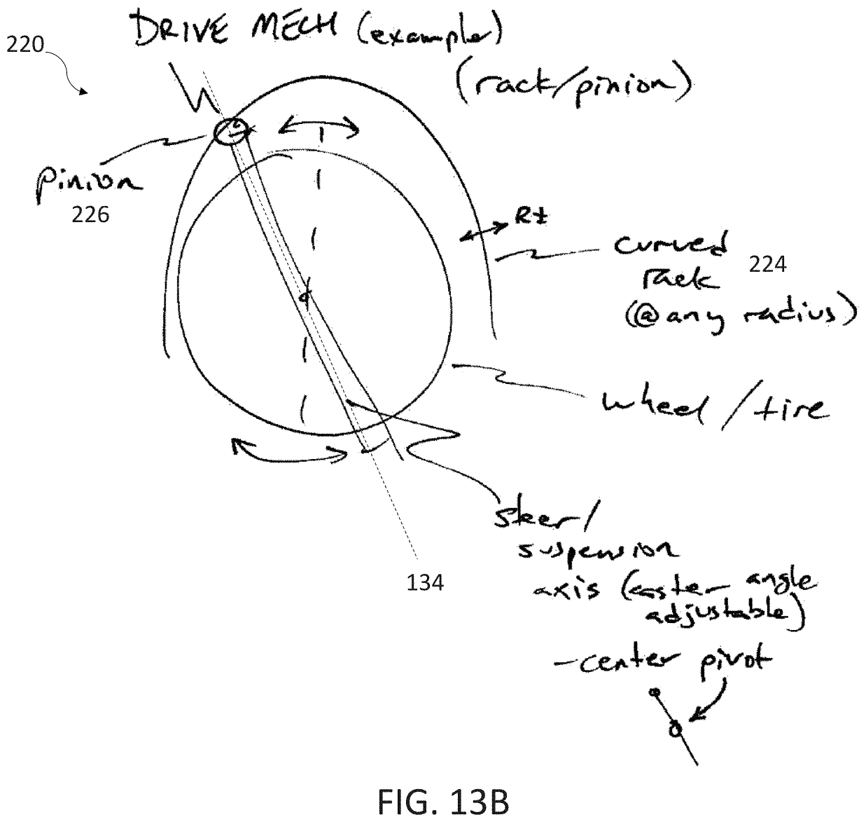

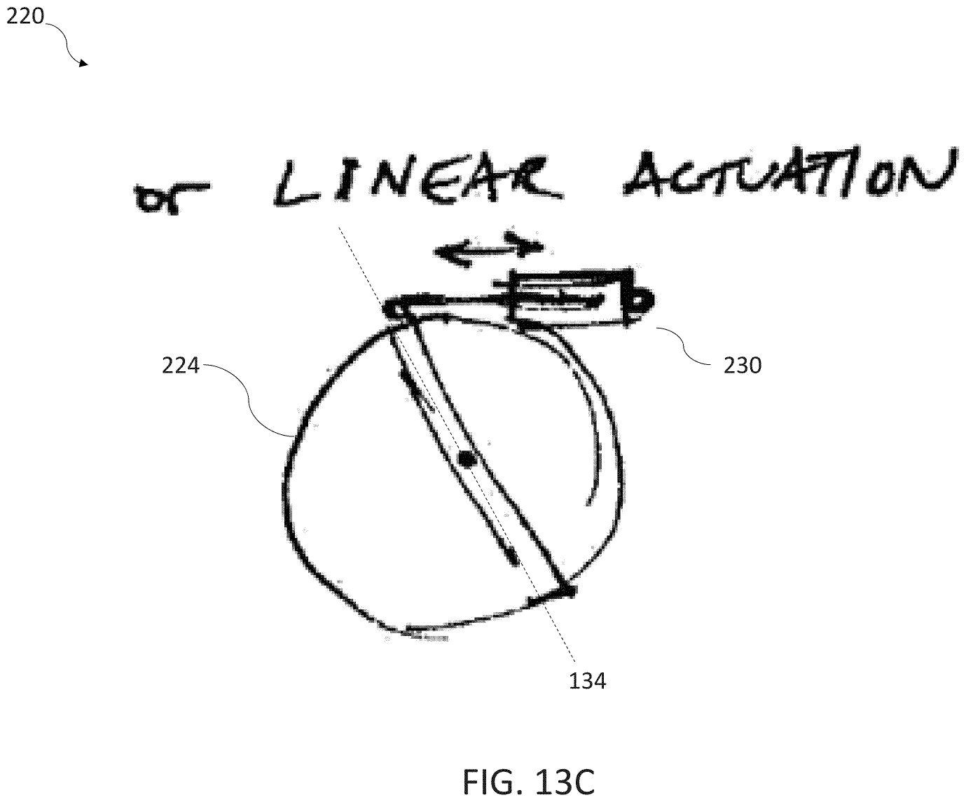

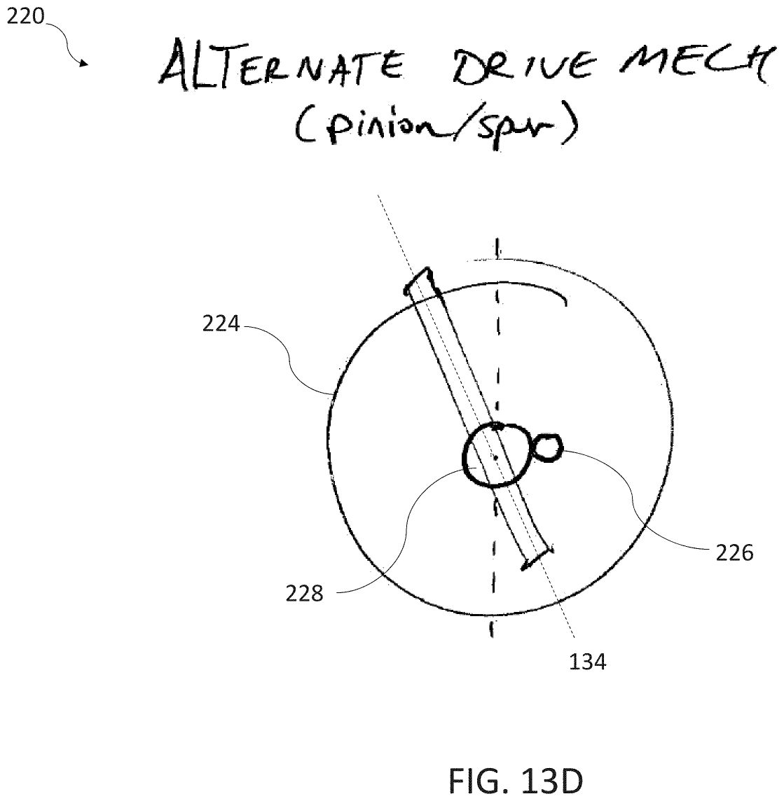

In another example, the carriage 538 may also include a caster angle adjuster to adjust the caster angle of one or more wheels on the vehicle 100. As described above, the caster angle may be defined based on the rotational position of the wheel and the suspension relative to the axle of the wheel. In some instances, the steering axis 134 may be parallel to the direction of the suspension axes 130 and/or 132. Thus, the caster angle may also be defined as the angular displacement of the steering axis 134 relative to a vertical axis (e.g., the Z-axis). In a vehicle 100 without a caster angle adjuster, the caster angle may change with respect to the ground as the as the vehicle articulates as shown in FIG. 13A, which can alter the driving performance (e.g., suspension characteristics, steering) in an undesirable manner. A caster angle adjuster may thus be used to maintain a constant caster angle for each wheel relative to the ground as the vehicle 100 articulates.

Each wheel supported by the carriage 538 may have a caster angle that can be adjusted independently with respect to the other wheel(s). FIGS. 13B-13D show several exemplary caster angle adjusters 220 where the steering axis 134 is aligned to a suspension axis 130 and/or 132. Generally, the steering axis 134 of the wheel may be rotatably coupled at one (or both ends) to a rack 224 that defines a path along which the caster angle may be varied. The rack 224 may be curved such that the steering axis 134 can rotate about the wheel axis (wheel axes 137 and 139 for the front wheel and rear wheel, respectively) as the end(s) of the steering axis 134 moves along the rack 224. This curvature may be circular (e.g., with a center point coincident with the wheel axis) or non-circular (e.g., the wheel may rotate about the wheel axis and translate along the steering axis 134).

FIG. 13B shows one example where the steering axis 134 and the rack 224 are coupled using a rack 224 and pinion 226. The rack 224 may have a set of teeth that mesh with corresponding teeth on the pinion 226. A motor may be coupled to the pinion 226 to move the pinion 226 along the rack 224, thus adjusting the caster angle. FIG. 13C shows another example using a linear actuator 230 to adjust the end(s) of the steering axis 134 along the rack 224. FIG. 13D shows yet another example where a pinion 226 and a spur 228 are used to drive the steering axis 134 about the rack 224. The pinion 226 or the spur 228 may be coupled to a motor for actuation. Other actuators may be used in the caster angle adjuster including, but not limited to an electromechanical, pneumatic, or hydraulic actuator. Additionally, actuation may also be achieved using a traction motor (e.g., the Indigo Technologies Traction T1 motor) when said motor is not used for other functions, such as active suspension or steering.

In practice, the caster angle adjusters may be used to continuously adjust vehicle dynamics, particularly when the vehicle 100 is at a fixed configuration, by adjusting the caster angle of each wheel to accommodate various speeds and terrains or to achieve desired performance characteristics. Additionally, when the vehicle 100 changes configuration, the caster angle of each wheel may remain fixed with respect to the vehicle 100, but changes with respect to the road. Thus, the caster angle adjusters may be used to set the caster angle of each wheel to a desired global or absolute caster angle defined with respect to the road. The desired caster angles of each wheel may depend on various factors including, but not limited to the vehicle's loading, speed, and articulated configuration.

It should be appreciated that the mechanism described above to adjust the caster angle may also be separately disposed from the articulated joint 106 on the vehicle 100 (e.g., the front wheels 112 of the vehicle 100).

### 4. STRUCTURAL AND EXTERIOR DESIGN OF THE ARTICULATED VEHICLE

The overall shape and dimensions of the articulated vehicle 100 may vary depending on the desired functionality of the vehicle 100 (e.g., an off roading vehicle, a passenger vehicle, a cargo transport, a high performance vehicle) and the environment in which the vehicle 100 operates in (e.g., high speed driving on a highway, low speed driving in an urban environment such as a parking lot, inside of a building, a shop, a workplace, or a home). Generally, the desired functionality and/or characteristics of a vehicle may engender a preferred vehicle configuration (e.g. shape, form, size). Conventional vehicles typically exhibit predominantly fixed characteristics defined during the design stage of vehicle development and thus are only able to provide a limited range of functions and/or characteristics unless the vehicle is modified after production. In contrast, the ability for the articulated vehicle 100 to be reconfigured may enable better performance across a broader range of functionalities and/or provide characteristics that are not possible in conventional vehicles with a single rigid body (e.g., articulating the vehicle 100 to traverse a set of stairs or to walk over an obstacle).

In other words, the articulated vehicle 100 may allow for greater flexibility in designing the structure and/or exterior of the vehicle 100. In the following description, an exemplary body 108, an exemplary canopy 110, and an exemplary morphing section 123 are described. However, it should be appreciated that other bodies, canopies, and morphing sections may be used to provide similar functionality and/or properties as is apparent to one of ordinary skill in the art.

### 4.1. An Exemplary Body of the Articulated Vehicle

The body 108 of the vehicle 100 may define an interior space into which the payload 2000 may be disposed and/or provide a base structure to support other vehicle subsystems. The body 108 may have be constructed in various forms including, but not limited to a unibody, a monocoque frame/shell, a space frame, and a body-on-frame construction. The body 108 may be formed from various materials including, but not limited to carbon fiber, aluminum, fiberglass, carbotanium, and any combinations of the foregoing. Several aspects of the body 108 may be considered in the design including, but not limited to the stiffness, the strength, the weight, the volume of the interior space, the drag coefficient, and the aesthetics.

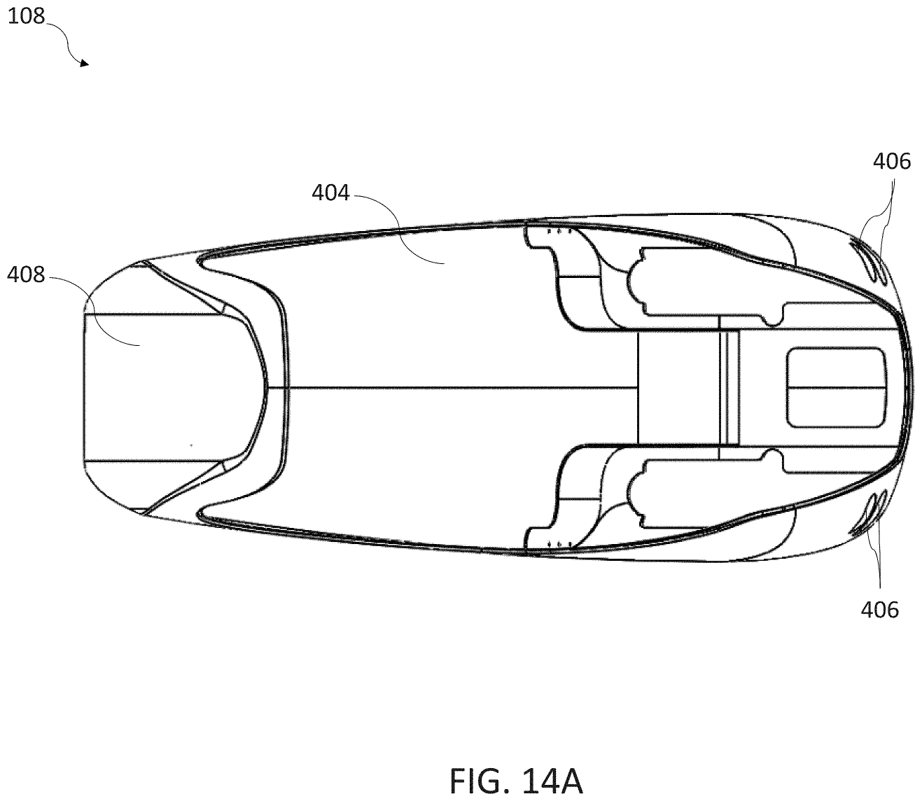

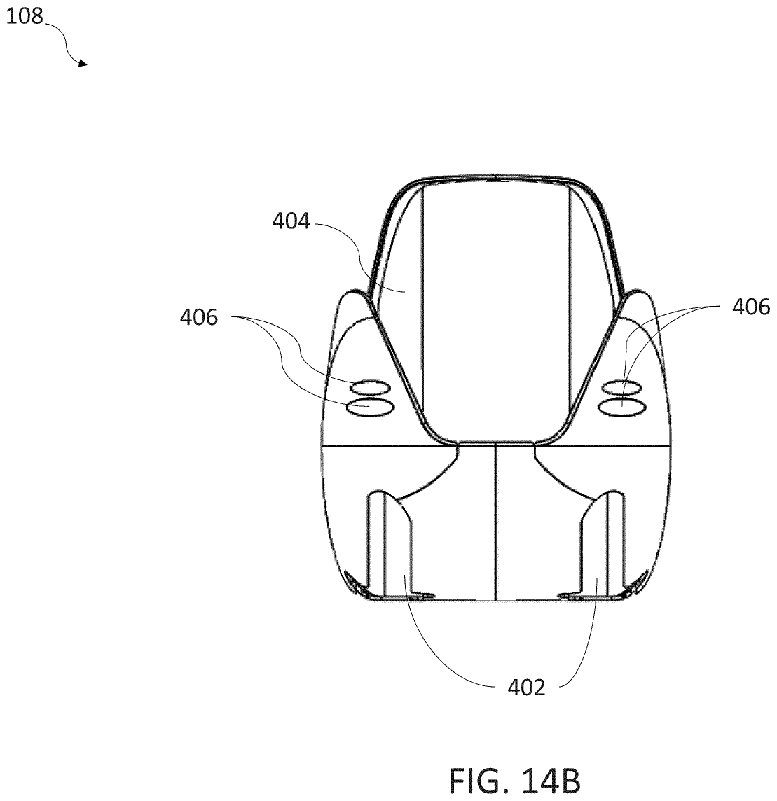

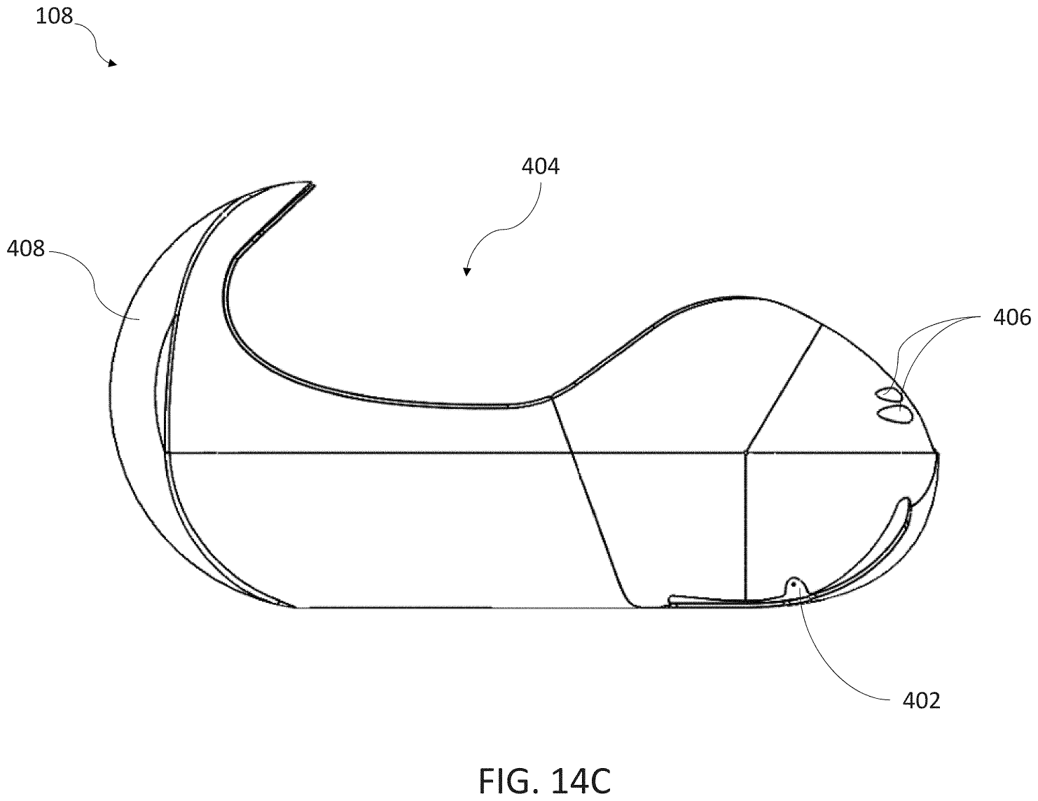

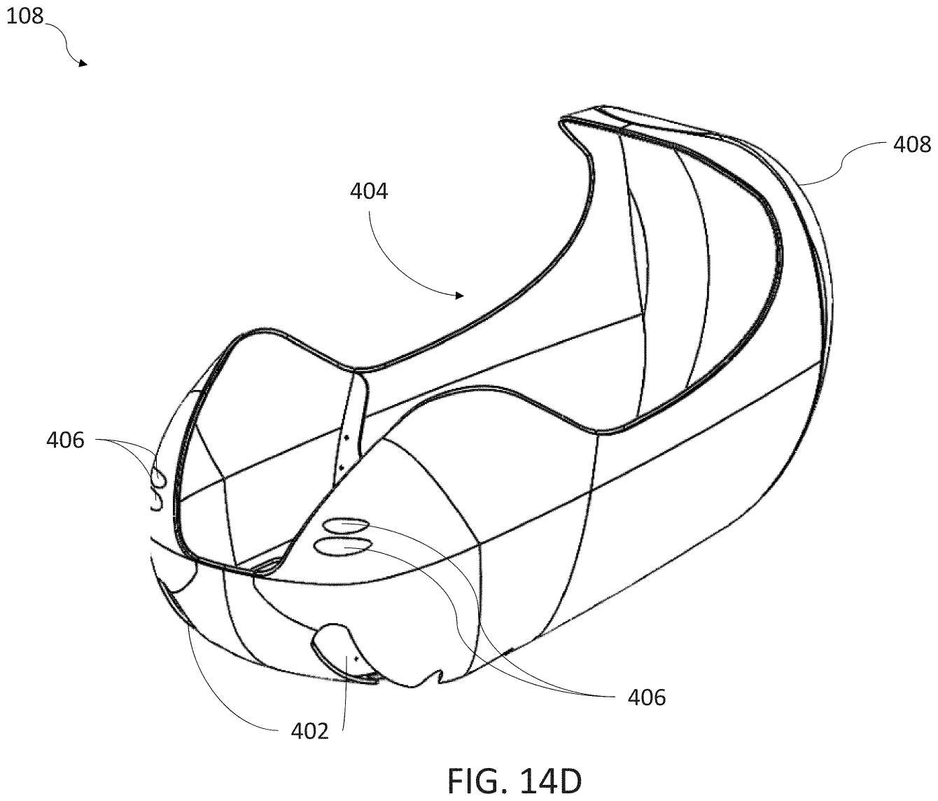

FIGS. 14A-14D show several views of an exemplary body 108 used in the front section 102 of the vehicle 100. The body 108 shown is a monocoque where loads typically applied to a chassis are carried by the external skin and/or frame of the body 108. The body 108 may include several features to facilitate assembly of the vehicle 100 including a wheel well 402 for each front wheel 112, an opening 404 to accommodate and mount the canopy 110, a recess 406 for mounting headlights, and a rear surface 408 onto which the guide structure 107 in the articulated joint 106 may be mounted. The rear surface 408 may be shaped to have a curvature that conforms to the desired motion profile of the articulated joint 106. For instance, FIG. 14C shows the rear surface 408 as having a circular curvature such that the RCM remains stationary during articulation.

A monocoque construction may reduce the weight of the vehicle 100 and increase the volume of the interior space for the payload 2000 by eliminating a load-carrying internal frame and instead moving structural load carrying functions to the exterior surface of the vehicle 100. The combination of the monocoque with the RCM mechanisms and brake assemblies described above may provide a mechanically strong yet lightweight foundation for distributing chassis loads in the vehicle 100 while reducing the overall size and weight of the body 108. In this manner, the vehicle 100 may be lightweight with a small external footprint while having a relatively large interior volume to improve comfort and/or increase storage for the payload 2000 contained therein.

It should also be appreciated that the use of a monocoque body 108 lends quite nicely to the notion of a bespoke vehicle. For instance, an aerodynamic shell and structure may be arranged by utilizing the robotic motors and articulation elements to create a form which encapsulates a particular occupant. For example, a 5th percentile adult may benefit from a smaller vehicle form than a 95th percentile adult. Alternatively, a range of discrete sizes (i.e., small, medium, large) is also achievable and may allow for more compelling personalization of the vehicle 100 than is afforded by traditional vehicle architectures.

The canopy 110 may be mounted onto the opening 404 of the body 108 to form a substantially smooth and continuous exterior surface of the vehicle 100 to reduce, in part, the aerodynamic drag as will be described below. The canopy 110 may be coupled to the body 108 using a cable driven four-bar linkage mechanism (not shown) to open/close the canopy 110 for loading/unloading the payload 2000. The canopy 110 may be opened/closed via a forward sweeping motion (e.g., the canopy 110 rotates about an axis parallel to the Z-axis and located towards the top of the body 108) thus reducing the clearance near the vehicle 100 during ingress/egress. The linkage mechanism may allow the canopy 110 to be opened regardless of the configuration of the vehicle 100 (e.g., in the low profile configuration, the high profile configuration, or any configuration in between) for safety and/or convenience. The linkage mechanism may also be configured such that the overall height of the vehicle 100 when the vehicle 100 is in the high profile configuration and the canopy 110 is fully opened is less than the height of a typical garage. The canopy 110 may also be shaped and positioned to provide cover to the vehicle cabin in order to prevent rainwater and/or other vertically projected contaminants from entering the vehicle 100. The cable drive used to actuate the canopy 110 may also be robust, lightweight, and reduces visual obstruction of the occupant.

Conventional small and/or lightweight vehicles are typically considered to be less safe, especially when compared to larger, heavier vehicles. However, the articulated vehicle 100 may have several features that improve safety despite the smaller form factor. For instance, the body 108 may be a monocoque, which can typically withstand large crash loads with small deflection and no destructive failure. The relatively large interior volume of the body 108 may also be partially filled with an energy absorbing material (e.g., airbags). As described above, the articulated joint 106 may also be compliant, at least in part, and/or actuate in response to a collision to further absorb at least a portion of the energy from the crash. These safety features, when used individually or preferably in combination, may enable the articulated vehicle 100 to be as safe, if not safer than traditional automotive configurations. Furthermore, a lightweight vehicle (e.g., vehicle 100) may pose a smaller threat to other vehicles and pedestrians on the road than larger traditional vehicles.

The overall shape of the body 108 (in combination with the canopy 110) may also be influenced by a desired aerodynamic form. For example, if energy consumption is an important factor to the operation of the vehicle 100, the vehicle 100 should be able to efficiently travel at high speeds while using a small amount of energy (e.g., from the battery, fuel). The aerodynamic efficiency of the vehicle 100 is primarily dictated by the drag force applied to the vehicle 100, which depends on the fluid through which the vehicle 100 is traveling through (e.g., air), the size of the body 108, the shape of the body 108, and the speed of the vehicle 100. Two attributes of the vehicle 100 (in particular the body 108) may be modified to reduce aerodynamic drag: (1) the coefficient of drag, C_{d}, which is related to the shape and form of the vehicle 100 and (2) the projected cross sectional area of the front side of the vehicle 100 normal to the direction of travel.

The reconfigurability of the vehicle 100 may be used to modify the drag coefficient, C_{d}, and/or the cross-sectional area. For example, the vehicle 100 in the low profile configuration may exhibit less drag and, hence, may be preferable when operating the vehicle 100 at high speeds (e.g., driving on a highway). The body 108 shown in FIGS. 14A-14D and used in the vehicle 100 in FIGS. 1A-1E was calculated to have a drag coefficient of C_{d}=0.038 in the low profile configuration, which is substantially smaller than the best performing standard passenger vehicles, which typically have a C_{d}>0.2. The vehicle 100 may also have a small frontal cross-sectional area of A_{c}=0.9 m² in the low profile configuration due, in part, to the narrow track width of the vehicle 100 and the ability of the vehicle 100 to reduce its height be near a factor of 2 when transitioning from the high profile configuration to the low profile configuration.

### 4.2. An Exemplary Morphing Section

The articulated vehicle 100 may be comprised primarily of rigid sections (e.g., the front section 102 and the tail section 104) in order to provide structure and form to the vehicle 100. However, as the vehicle 100 changes configuration (by moving through the range of articulated motion), mechanical interferences may arise on the vehicle 100 due to the relative motion of the rigid sections, thus creating undesirable gaps and/or openings in the vehicle exterior. These areas of the vehicle 100 where mechanical interferences occur may be covered by one or more morphing sections 123. The morphing section 123 may be a compliant material or structure that changes shape as the vehicle 100 is articulated in order to maintain continuity in the vehicle exterior surface for aerodynamic, sealing, and/or aesthetic purposes. The morphing section 123 may be coupled to components of the vehicle 100 via one or more sealing members 702. Additionally, the sealing member 702 may also be disposed between rigid sections of the vehicle 100 in regions where a smaller gap is present.

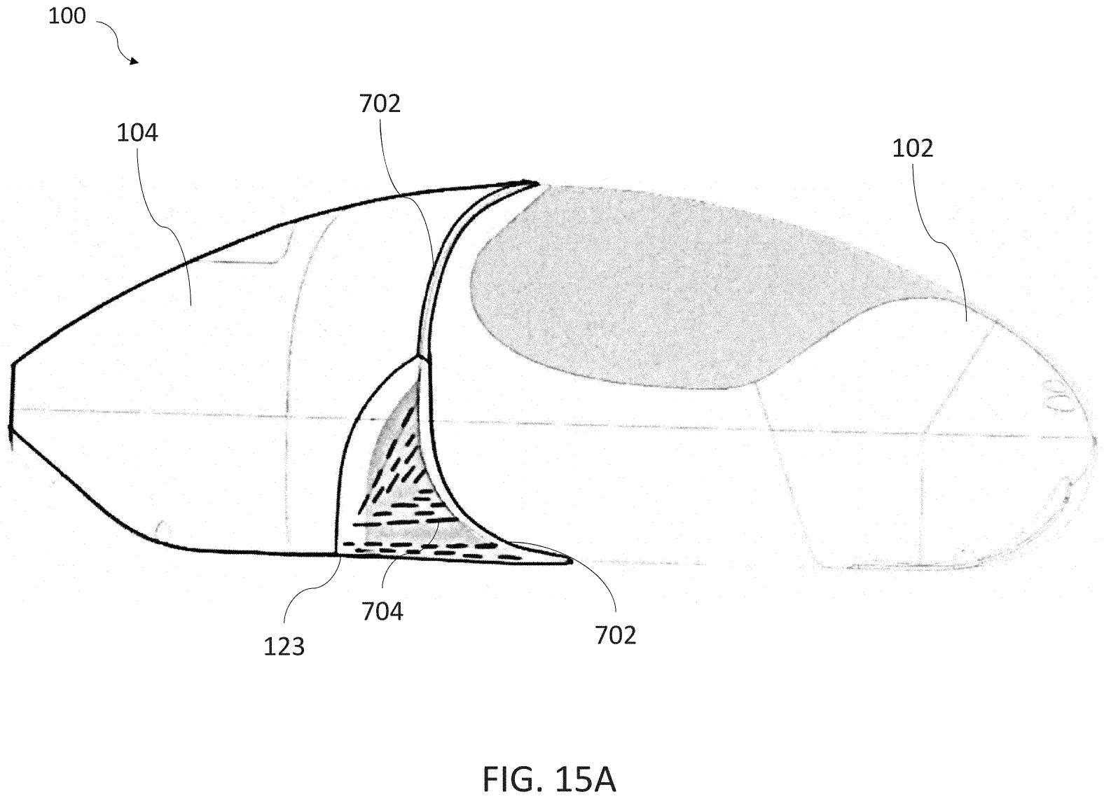

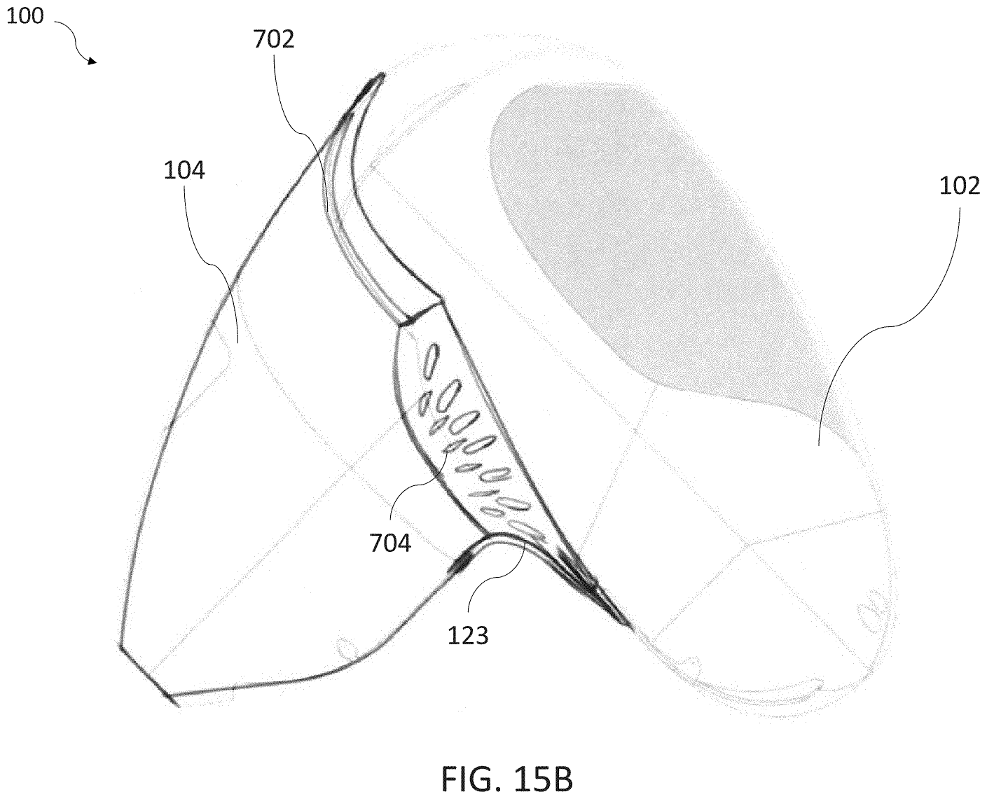

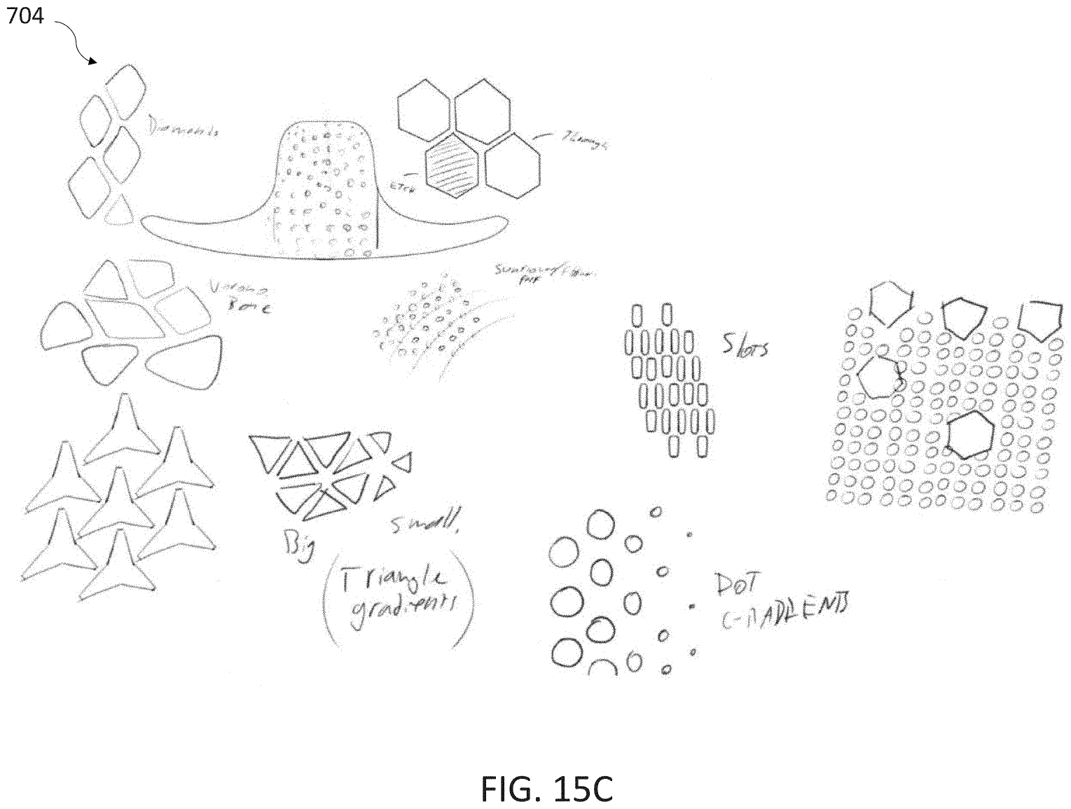

FIGS. 15A and 15B show an exemplary articulated vehicle 100 with the morphing section 123 disposed on the underside of the vehicle 100 between the front section 102 and the tail section 104. As shown, the morphing section 123 may change shape as the vehicle 100 transitions from a low profile configuration to a high profile configuration such that the underside of the vehicle 100 remains substantially smooth and continuous. Depending on the particular region of the vehicle 100 and the interaction between articulating components, the relative compliance of the morphing section 123 may be tuned to follow a desired path and/or to maintain a desired form throughout the range of articulated motion. The morphing sections 123 may utilize various compliant materials and/or structure including, but not limited to a flexible material, a segmented structure with overlapping segments, a foldable structure (e.g., origami structure, an accordion structure), or any combination of the foregoing.

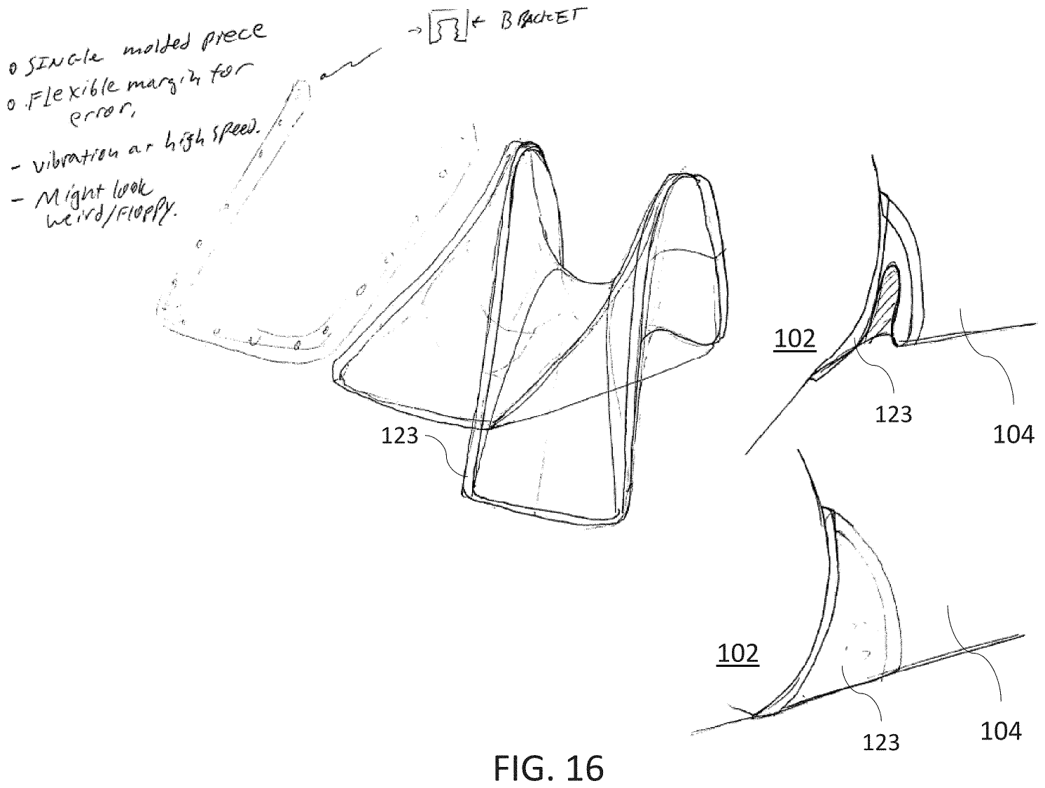

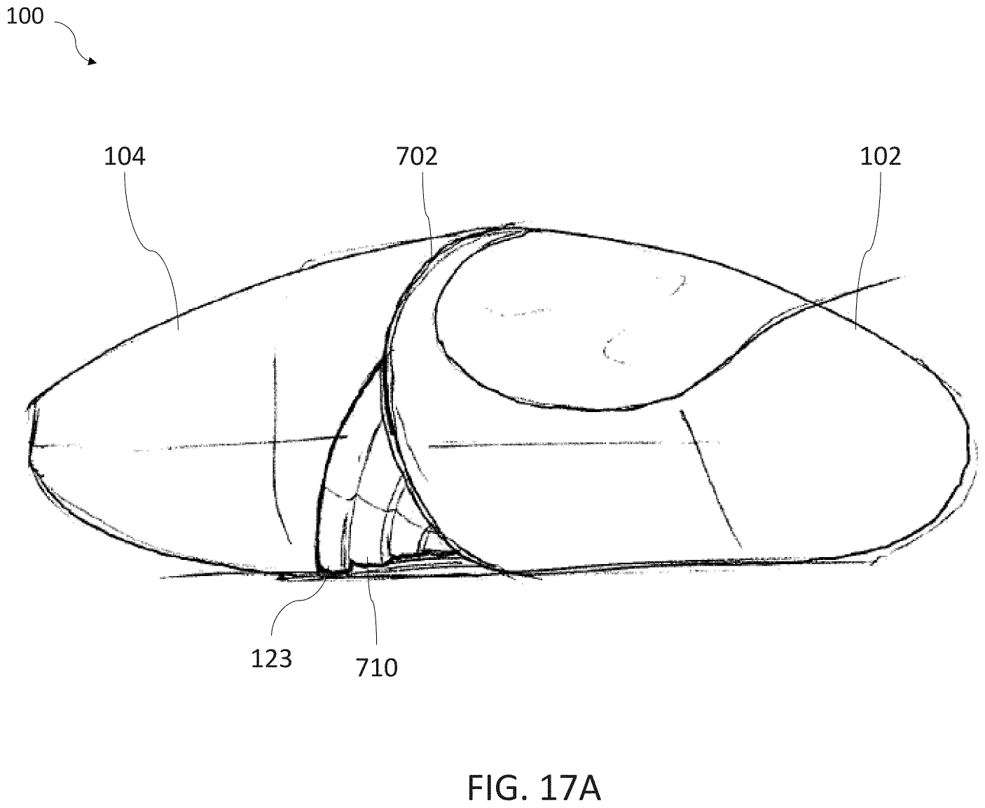

The morphing section 123 shown in FIGS. 15A and 15B is formed from a flexible, compliant material. FIG. 16 shows another exemplary flexible morphing section 123. As shown, the morphing section 123 may be formed as a single part. In some designs, the morphing section 123 may have a variable thickness, thus making certain portions of the morphing section 123 more compliant. For example, one or more outer edges on the morphing section 123 may be thicker for mounting the morphing section to the rigid sections of the vehicle 100 and a central portion of the morphing section 123 may be thinner to increase compliance.

The morphing section 123 may be formed from various materials including, but not limited to rubber, silicone, fabric, and plastic. As shown, the morphing section 123 may include a plurality of openings 704 that may change shape and/or orientation as the morphing section 123 changes shape. These openings 704 may provide various functions including, but not limited to being (1) an aerodynamic element to increase downforce and/or to redirect air flow to cool a brake, a motor, or a battery, (2) a mechanical element to control how the morphing section 123 changes shape and/or relieves mechanical stress within certain portions of the morphing section 123, and (3) a pattern to improve the aesthetic appearance. FIG. 15C shows various designs of the openings 704 that may be disposed on at least a portion of the morphing section 123.

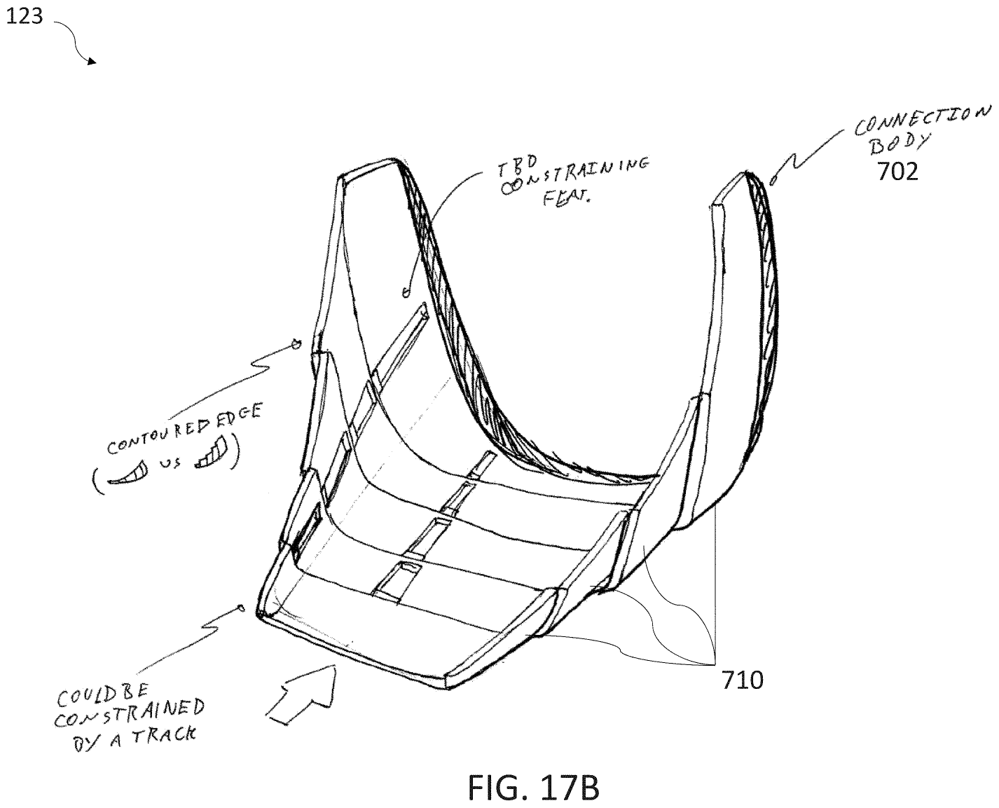

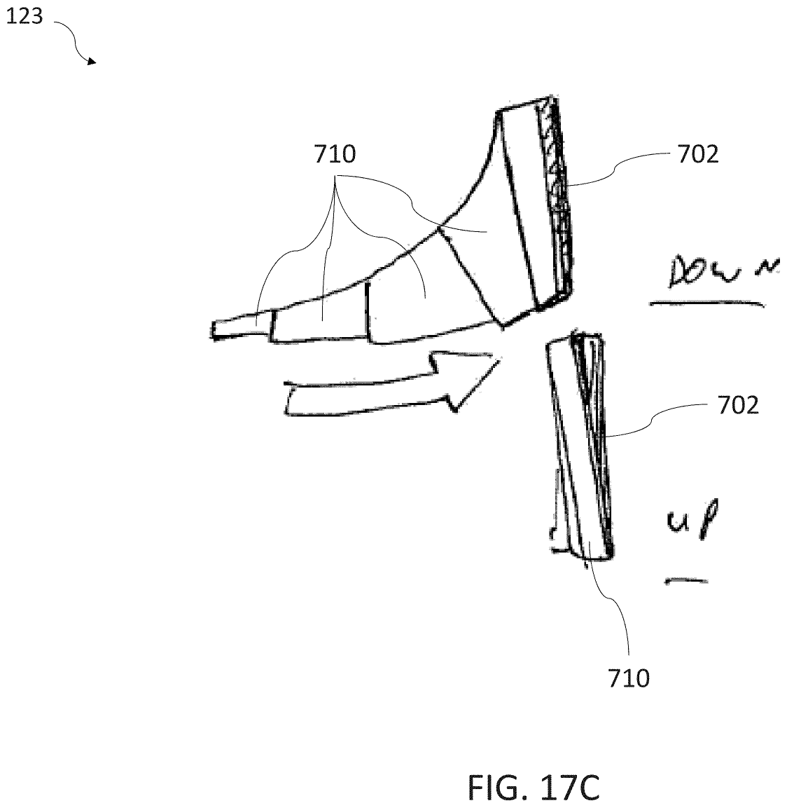

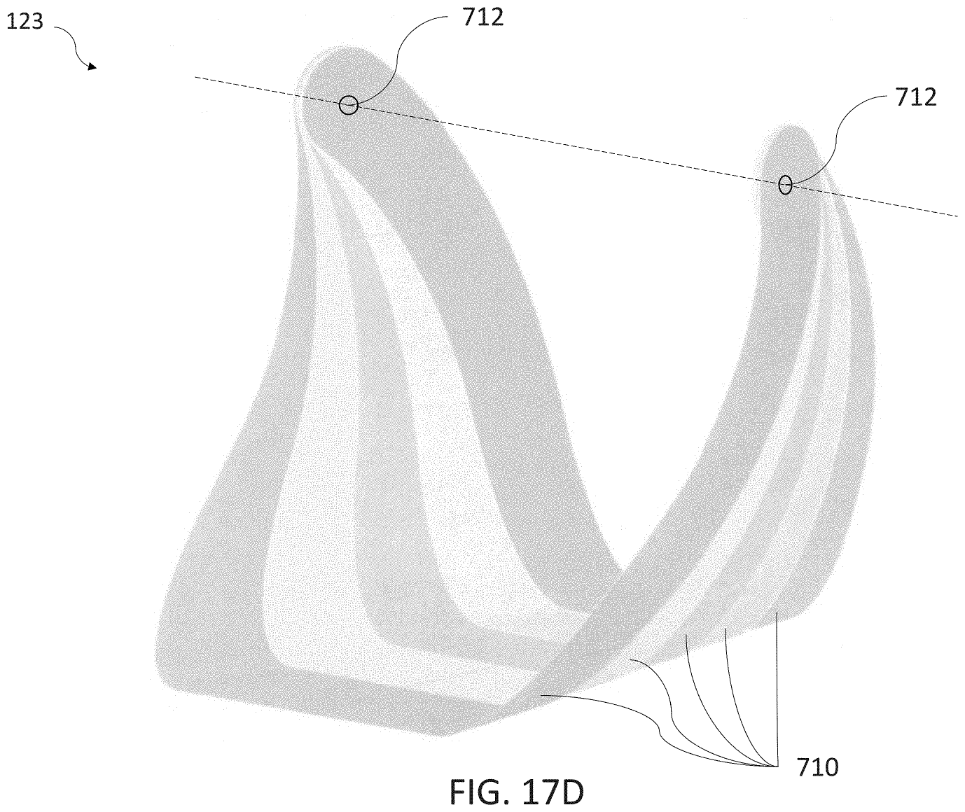

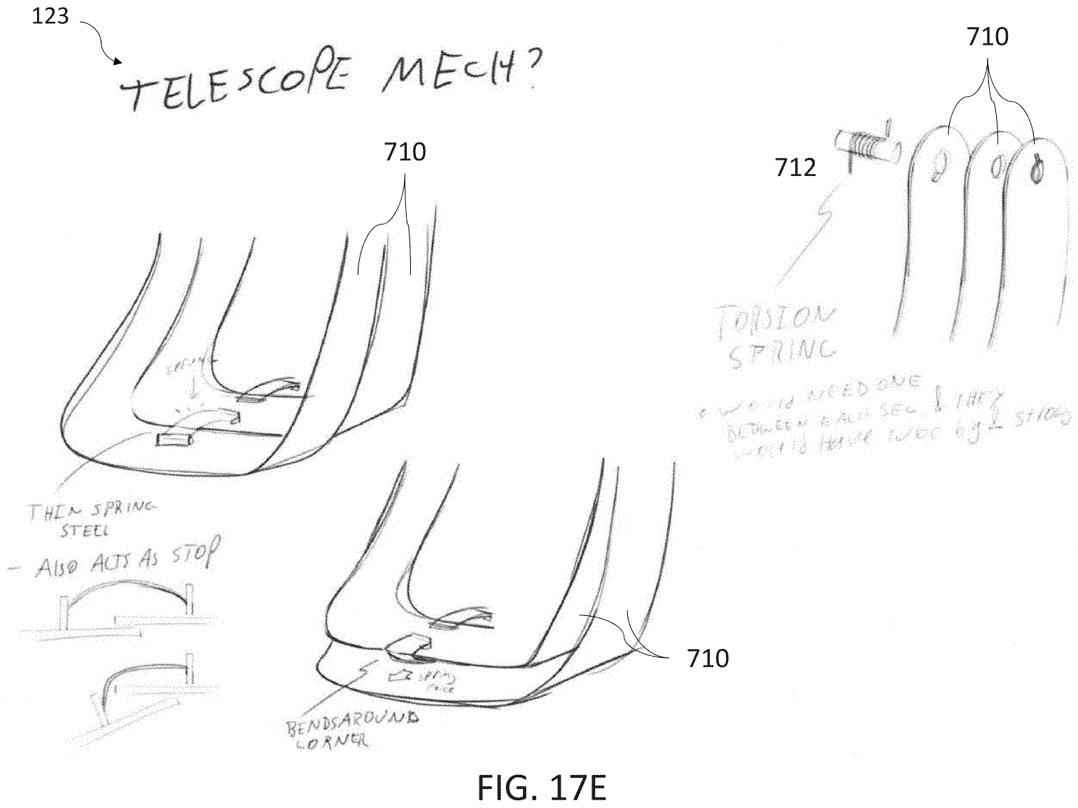

In another example, the morphing section 123 may be formed using multiple rigid components that move relative to one another in a telescoping manner. For instance, FIGS. 17A-17C shows a morphing section 123 using a segmented arrangement of rigid panels (e.g., similar to an armadillo). As shown, each segment in the morphing section 123 may be shaped such that the resultant assembly of the segments conforms to the gap and/or mechanical interference in the vehicle 100. Each segment may be slidable with respect to an adjoining segment such that when the morphing section 123 is contracted, each segment may be nested within another segment as shown in FIG. 17C. The slidable DOF of each segment may be facilitated through the use of a track (not shown) coupled to two or more segments. In order to reversibly extend and contract the morphing section 123, the segment nearest the front section 102 may be coupled to the front section 102 and the segment nearest the tail section 104 may be coupled to the tail section 104. Each segment may be formed from a rigid material including, but not limited to carbon fiber, aluminum, fiberglass, carbotanium, and any combinations of the foregoing.

FIGS. 17D and 17E show another exemplary morphing section 123 that uses multiple segments 710 that are rotatably coupled to a pivot joint 712. Each segment may again be shaped and sized such that when the morphing section 123 is contracted, each segment may be nested within another segment. The morphing section 123 may include a torsion spring at the pivot joint 712 to either extend and/or contract the morphing section 123. The morphing section 123 may also include thin springs coupling each adjoining segment to either extend and/or contract the morphing section 123.

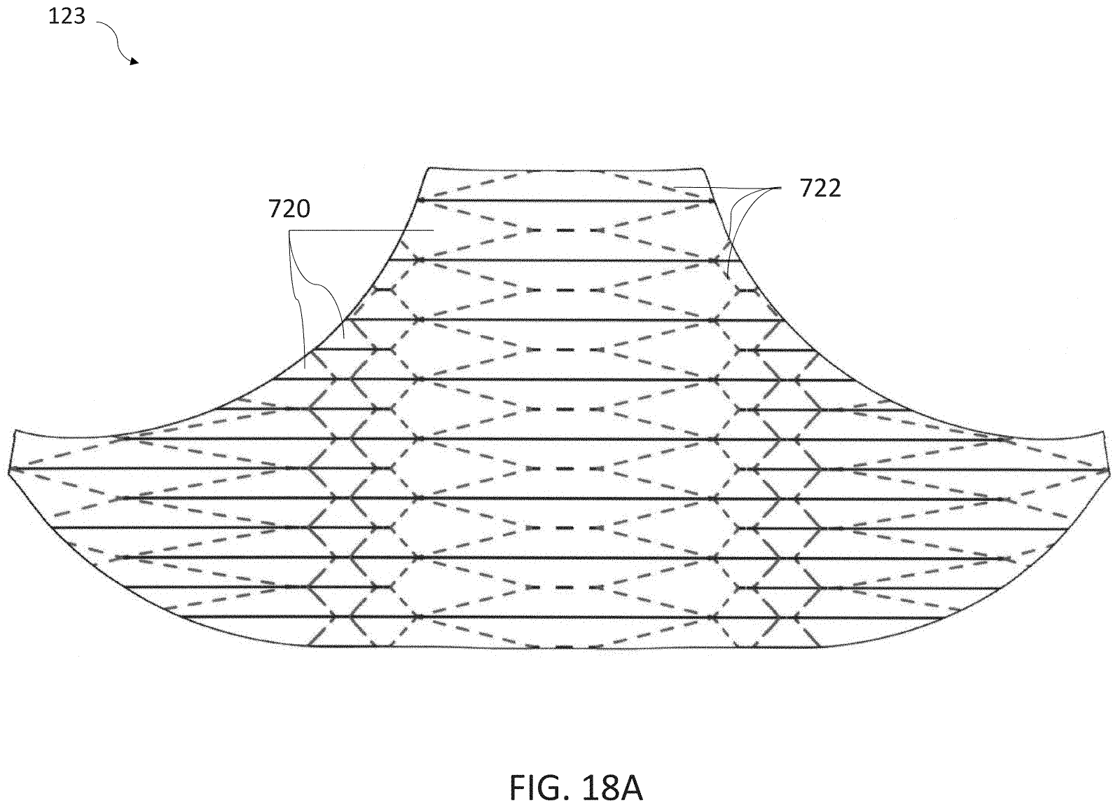

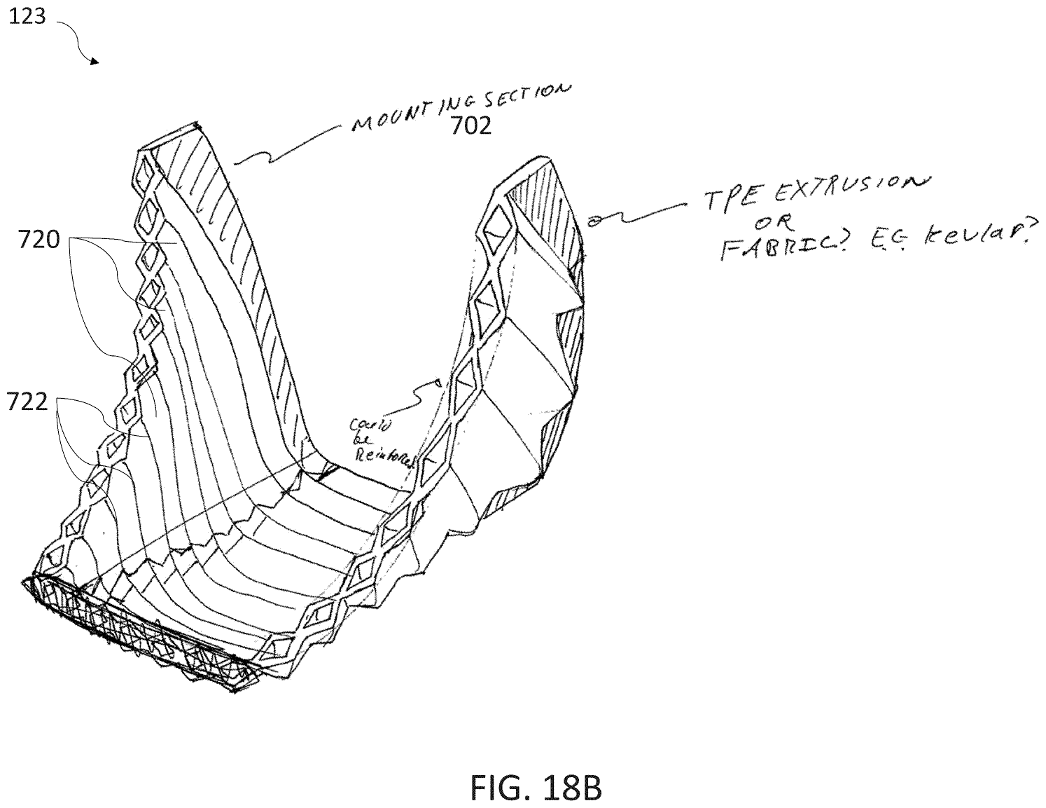

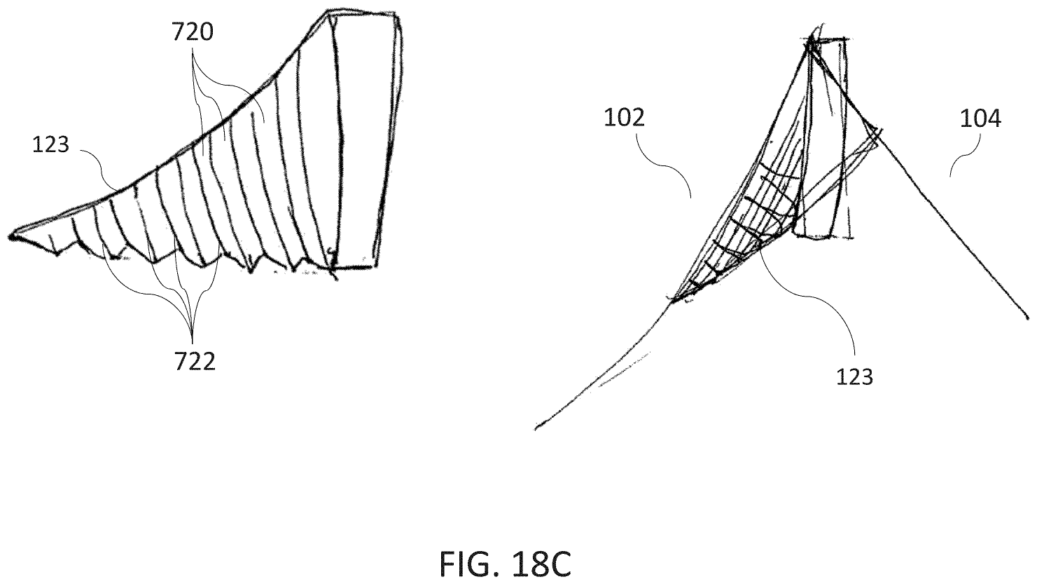

In another example, the morphing section 123 may be a foldable structure that includes an arrangement of semi-rigid panels that are each joined to one another via a compliant hinge 722. FIG. 18A shows one exemplary morphing section 123 that utilizes an origami-type structure with a plurality of panels 720 and compliant hinges 722. FIGS. 18B and 18C show another exemplary morphing section 123 structured like the bellows of an accordion. The panels 720 and the compliant hinges 722 may be arranged similar to a scissor-type linkage to extend and contract the morphing section 123 as shown in FIG. 18C. The compliant hinges 722 may provide some spring force to extend and/or collapse the morphing section 123. Wishbone springs may also be disposed between adjoining panels in the bellows structure to also exert a force to extend and/or collapse the morphing section 123.

Additionally, the morphing section 123 may include one or more rails (not shown) to reinforce and guide the morphing section 123 as the panels 720 are extended/contracted. For instance, a pair of rails may be mounted onto the rear surface 408 of the body 108 in the front section 102. Each rail may be curved to conform to the rear surface 408. The panels 720 may be slidably coupled to the rail such that the extension and/or contraction of the morphing section 123 is akin to opening or closing a shower curtain. The panels 720 and the compliant hinges 722 may be formed from similar materials including, but not limited to Kevlar, fabric, thermoplastic elastomer, and rubber.

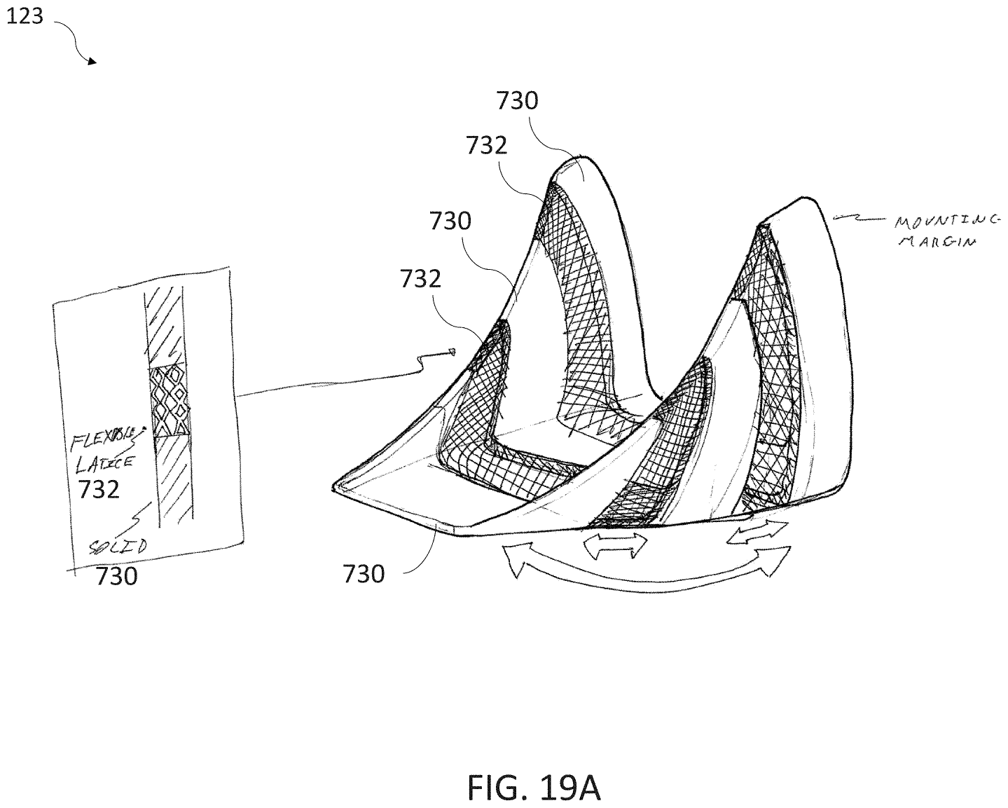

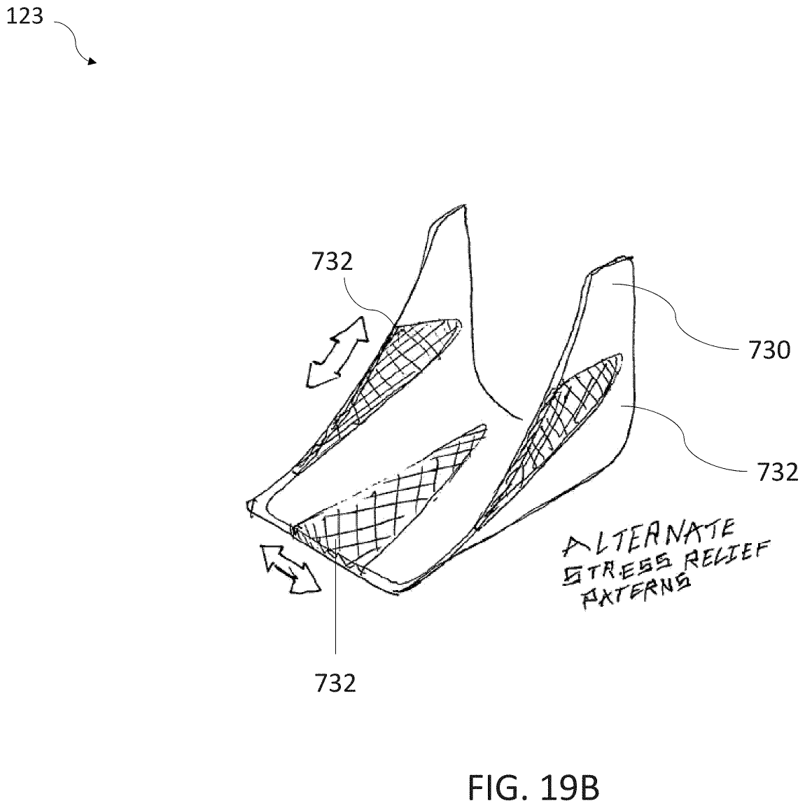

In yet another example, the morphing section 123 may be a composite structure comprised of rigid portions and compliant portions. FIGS. 19A and 19B show exemplary composite morphing sections 123. As shown in FIGS. 19A and 19B, the morphing section 123 may include both a solid region 730 and a flexible region 732. The flexible region 732 may be a collapsible lattice structure that allows the solid regions 730 to join together, thus changing the overall shape of the morphing section 123. The solid regions 730 may be rigid or compliant (though more rigid than the flexible regions 732). The flexible regions 732 may be designed to provide flexibility along one or more DOF's. For example, the flexible region 732 shown in FIG. 19A is designed similar to a scissor-linkage that collapses along a single DOF. The composite morphing section 123 may be formed as a single part or may be an assembly of multiple parts. Various materials may be used including, but not limited to carbon fiber, aluminum, fiberglass, carbotanium, rubber, silicone, fabric, and plastic.

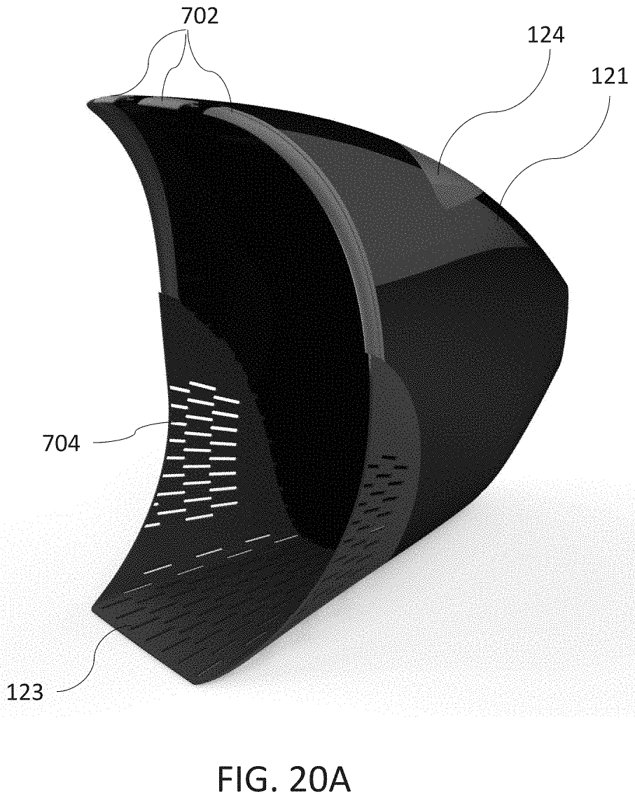

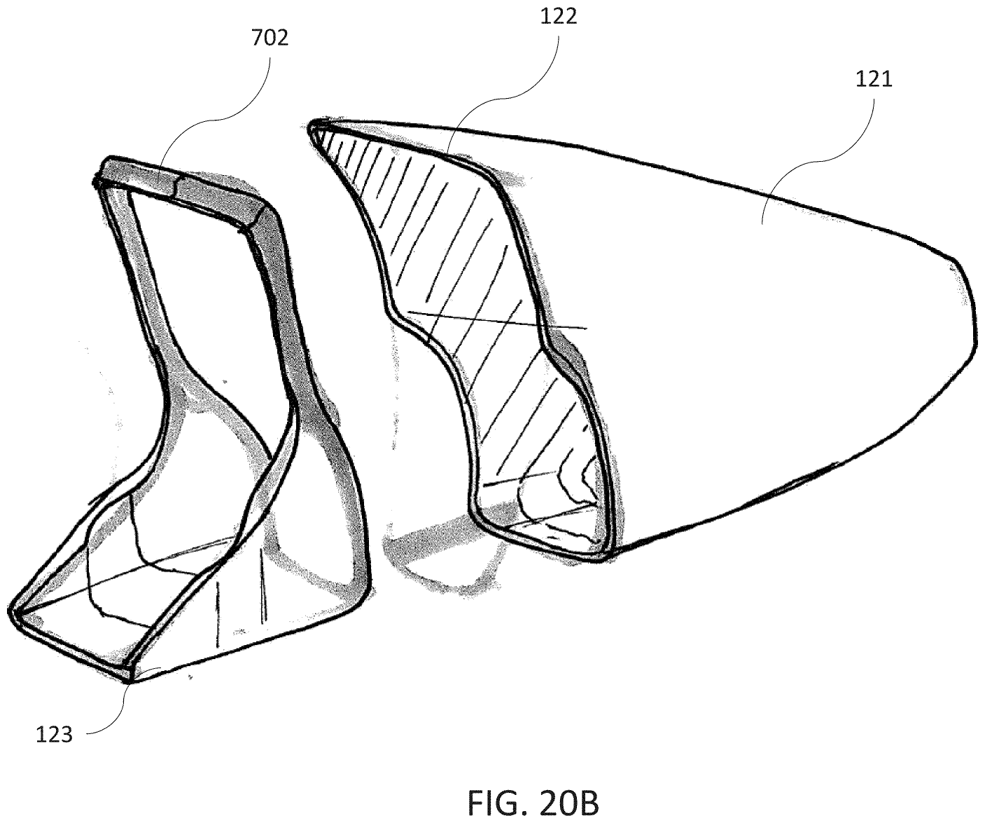

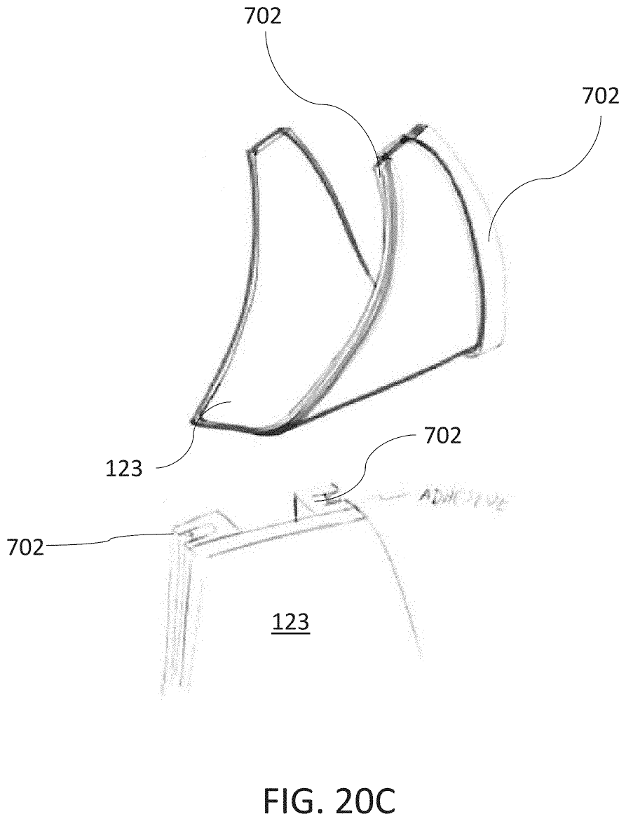

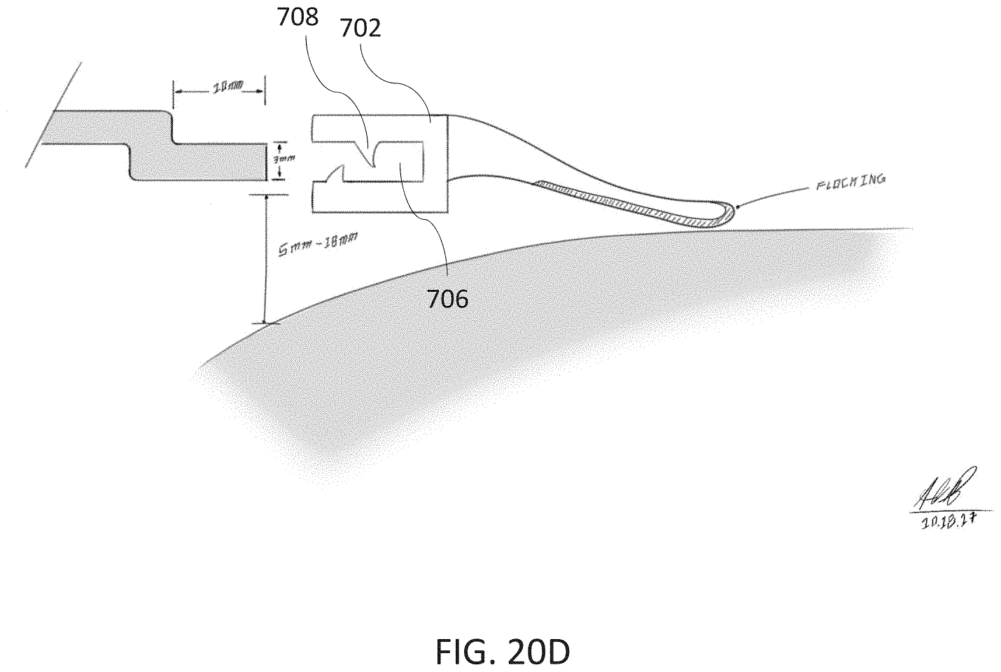

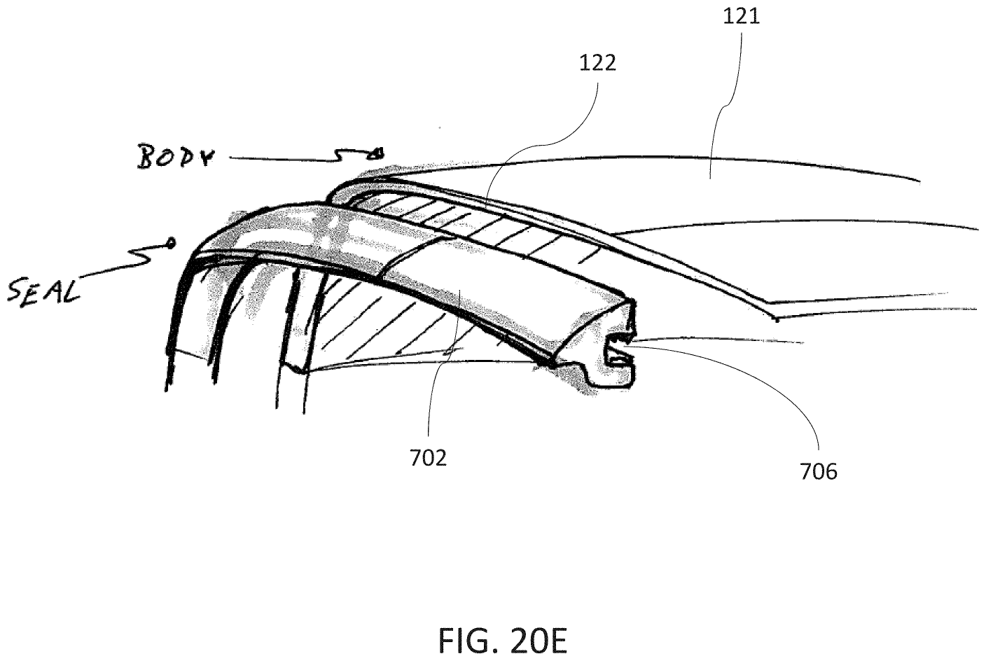

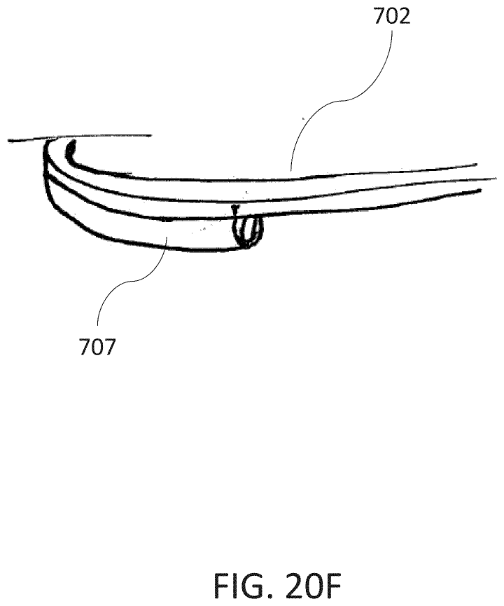

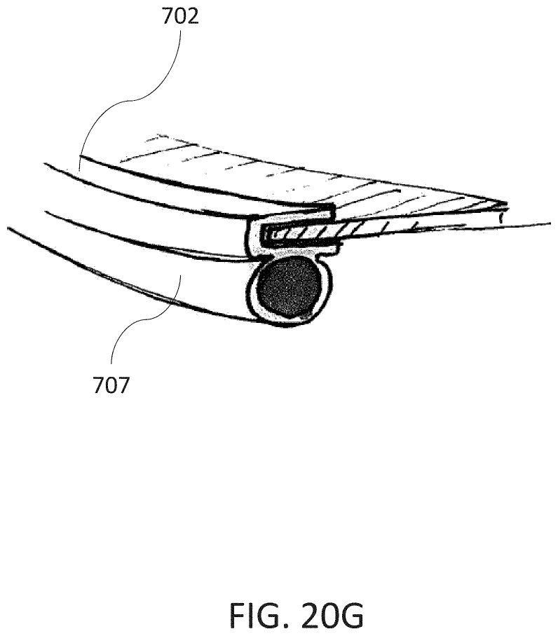

The sealing member 702 in FIGS. 15A and 15B may be used to fill small gaps located between the articulated components of the vehicle 100. The sealing member 702 may be a compliant part that is affixed to one rigid section and abuts another rigid section when the vehicle 100 is articulated. In some instances, the sealing member 702 may also be used to facilitate attachment of the morphing section 123 onto the rigid section. FIG. 20A shows an exemplary rear outer shell 121 of the tail section 104 with the sealing member 702 and the morphing section 123 coupled thereto. FIG. 20B shows one example where the morphing section 123 and the sealing member 702 are formed as a single part to couple to an interior edge 122 of the rear outer shell 121. FIG. 20C shows another example of a combined morphing section 123 and sealing member 702 that only covers the bottom portion of the rear outer shell 121. A separate sealing member 702 may be used for the top portion of the rear outer shell 121.

The sealing member 702 may be coupled to a rigid section using various coupling mechanisms including, but not limited to, an adhesive, a press fit, and a snap fit. FIG. 20D shows a cross-section of an exemplary sealing member 702 that is press-fit onto an edge of a rigid section. As shown, the sealing member 702 may include a channel 706 with a tooth-like structure 708 disposed therein to increase the clamping force exerted onto the rigid section. FIG. 20E shows another exemplary sealing member 702 with multiple teeth disposed within the channel 706. Additionally, the sealing member 702 may have a collapsible, compliant portion designed to seal a gap between adjoining sections of the vehicle 100 without exerting unwanted forces onto said sections. FIGS. 20F and 20G show two exemplary morphing sections 123 with a collapsible portion 707. The sealing member 702 may be compliant to conform to the shape of the sections. The sealing member 702 may also be formed from various materials including, but not limited to rubber, silicone, and plastic.

### 5. AN EXEMPLARY PAYLOAD POSITIONING JOINT

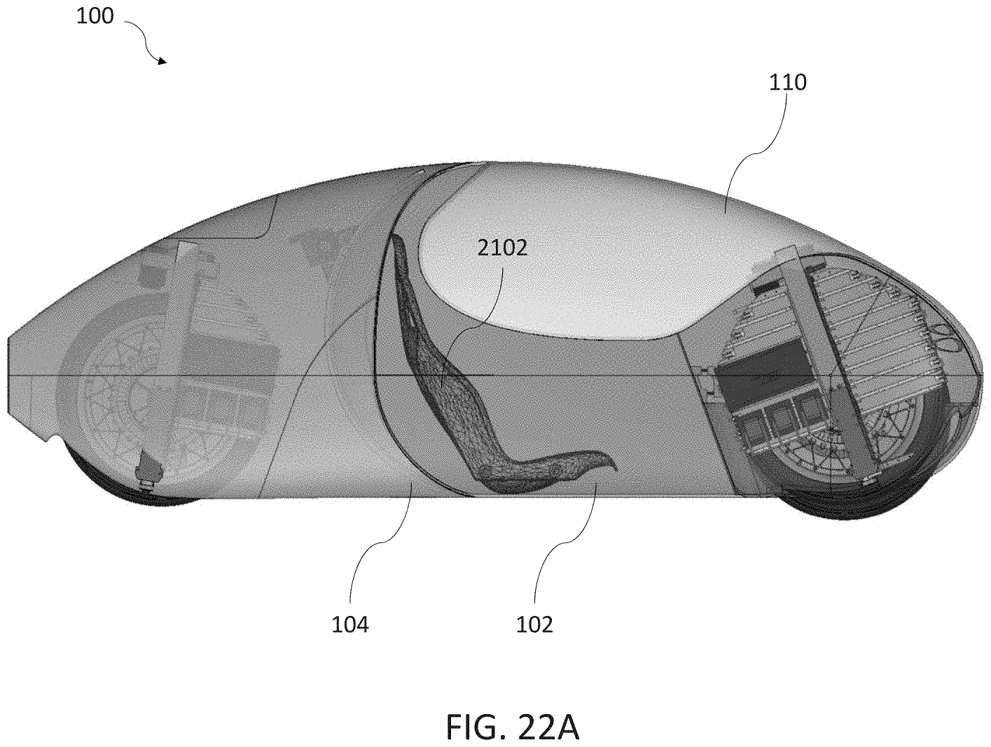

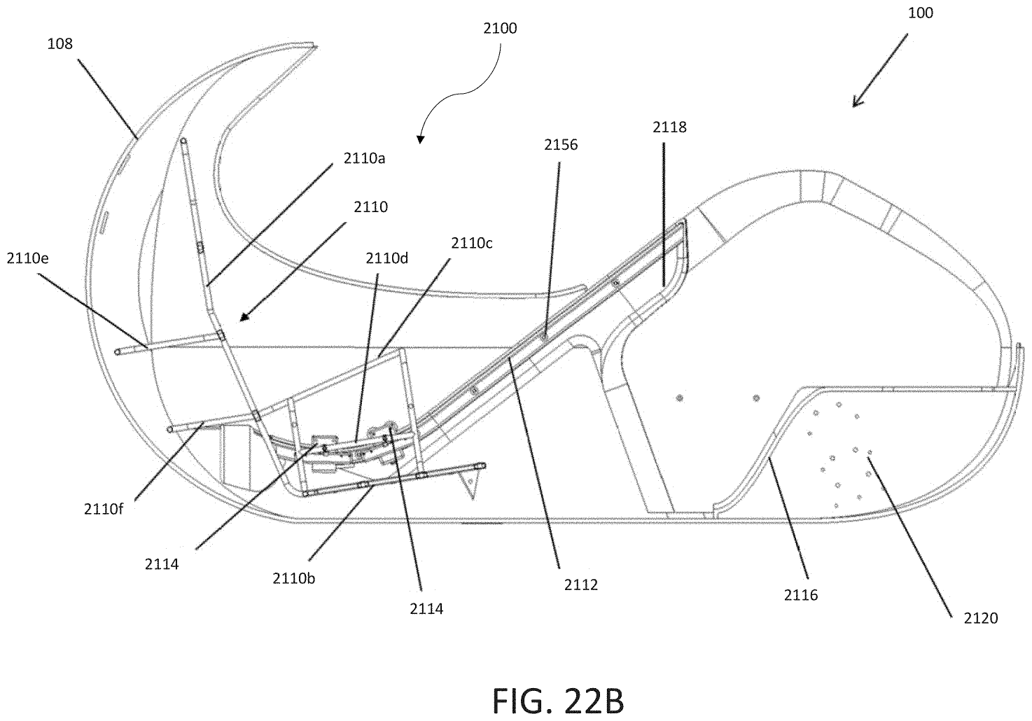

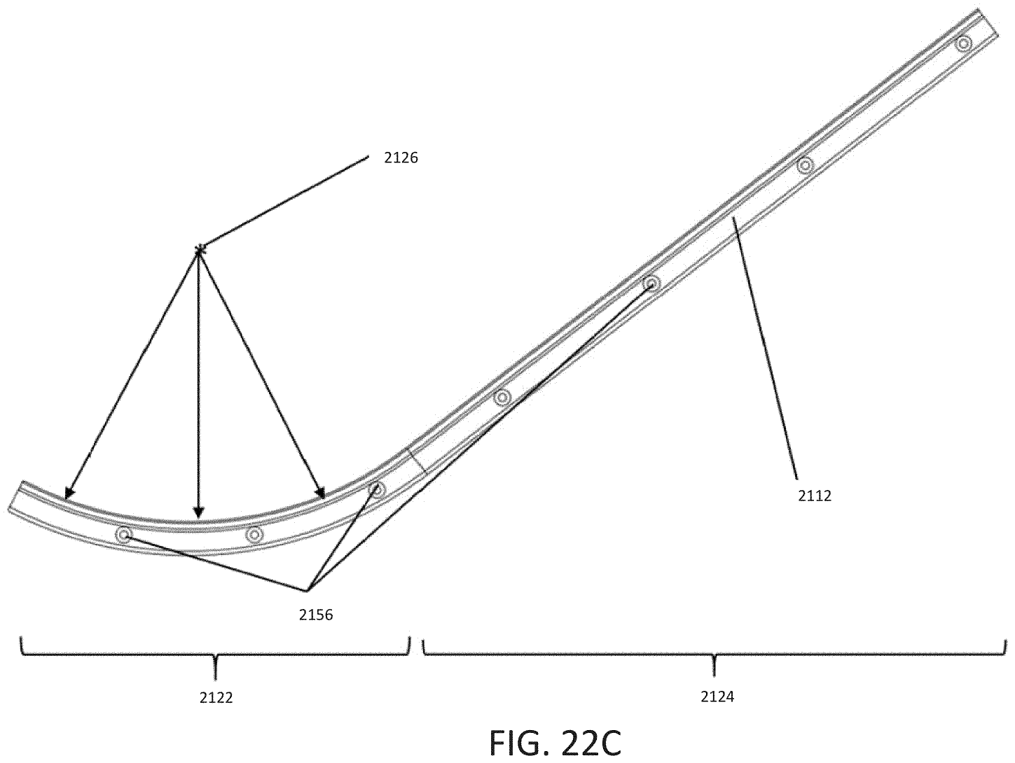

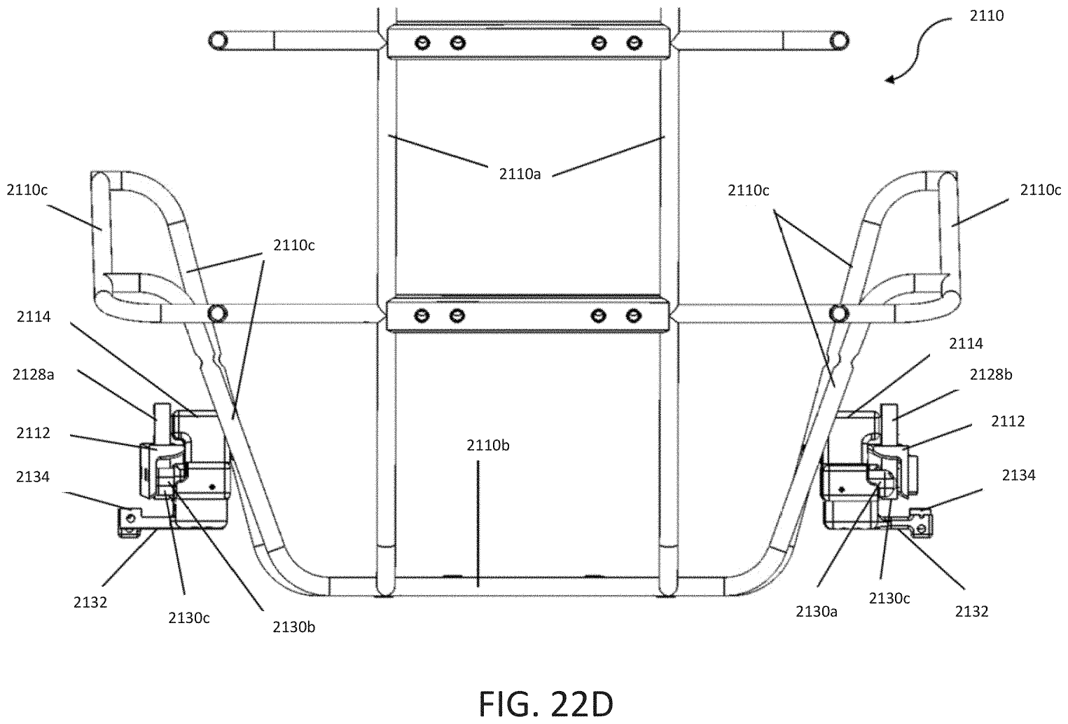

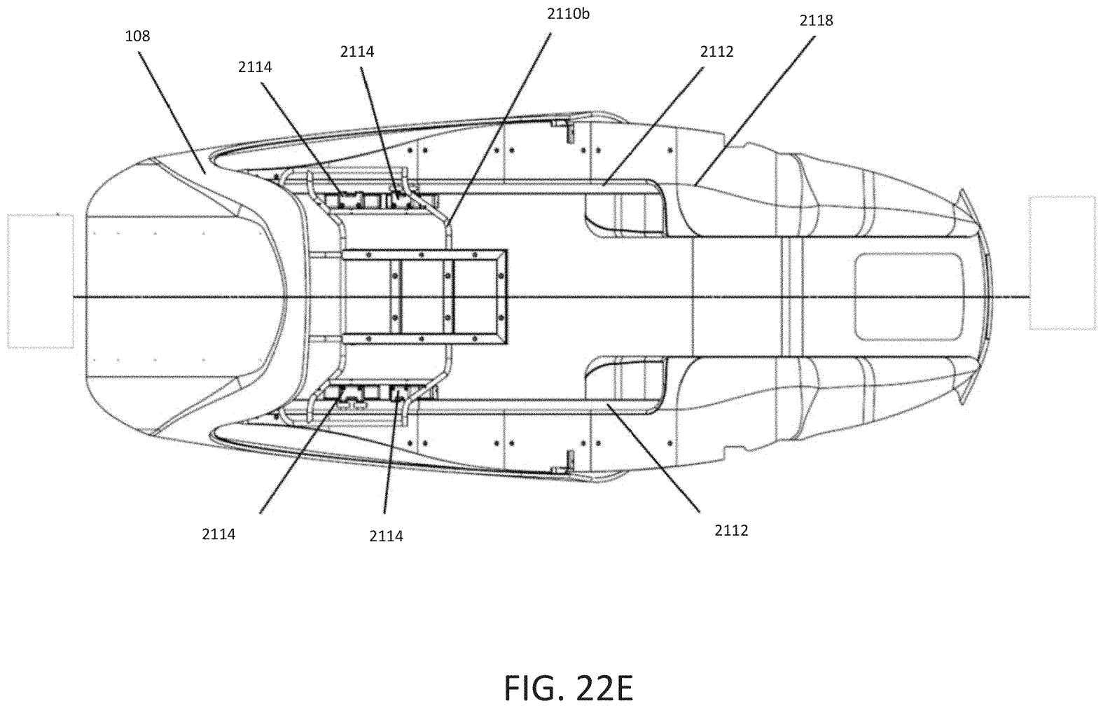

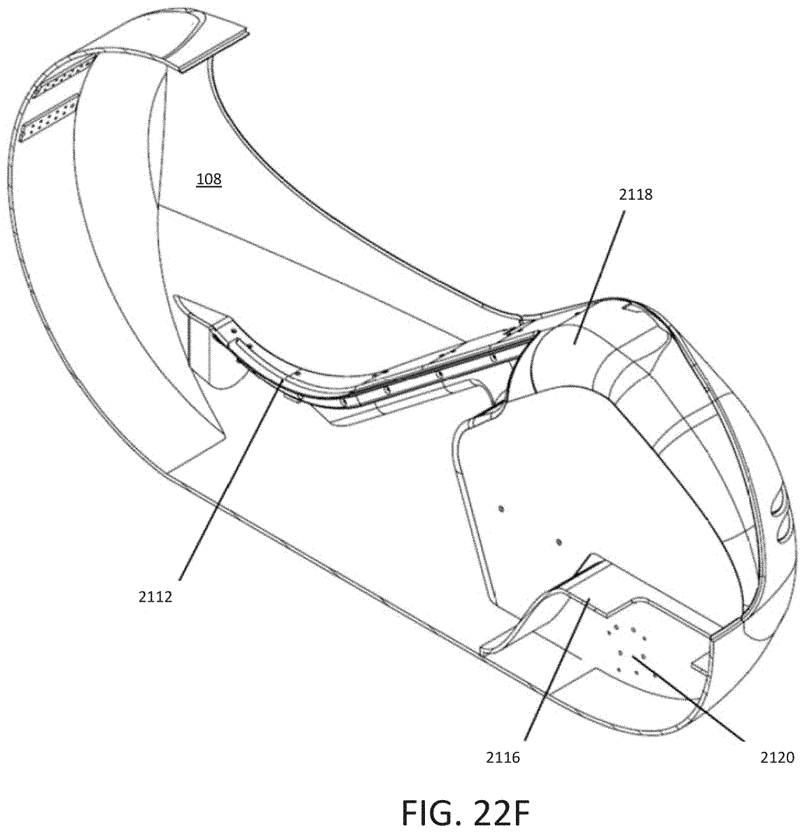

FIG. 22A shows a side view of an exemplary vehicle 100 exposing a seat 2102 for a driver or passenger. The articulated vehicle 100, also previously presented in FIGS. 1A-1E, may transition between a low profile configuration and a high profile configuration, thus changing the wheelbase and the height of the vehicle 100. By reconfiguring the vehicle 100 in this manner, the payload 2000 (e.g., a driver, a passenger, cargo) in the vehicle 100 may be reoriented in an undesirable manner. For example, the seat 2102 may be arranged to accommodate a driver's profile when the vehicle 100 is in the low profile configuration (i.e., the extended wheelbase). Once the vehicle 100 transition to the high profile configuration (i.e., the shortened wheelbase), the seat 2102 may tilt forward with the front section 102 producing a driver orientation that is not desirable.

To compensate for such undesirable modifications to the driver orientation, the articulated vehicle 100 may include the payload positioning joint 2100, also called a payload positioning mechanism. The payload positioning joint 2100 may reconfigure the orientation of the payload 2000 whilst the articulated joint 106 reconfigures the vehicle 100 such that the payload 2000 maintains a desired orientation. The payload positioning joint 2100 may utilize similar components to the articulated joint 106 as described previously. For example, the payload positioning joint 2100 may include a carriage (e.g., a seat), a guide structure (e.g., rails in the passenger cabin to guide the seat), a drive actuator (e.g., gravity, a motor), and a brake (e.g., to hold the seat in place at a particular vehicle configuration).

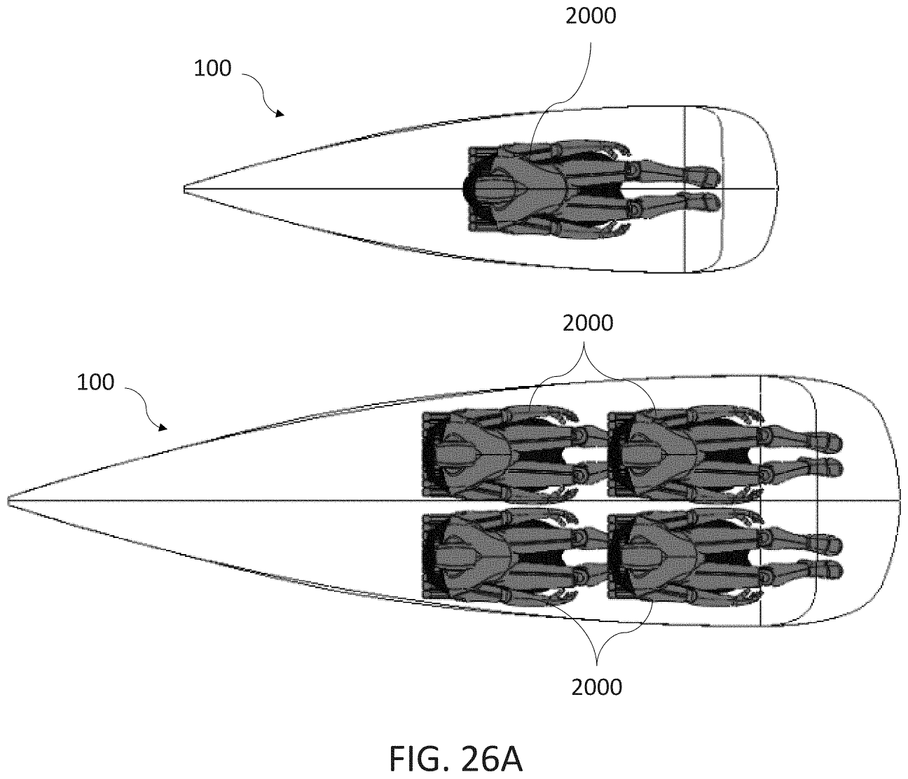

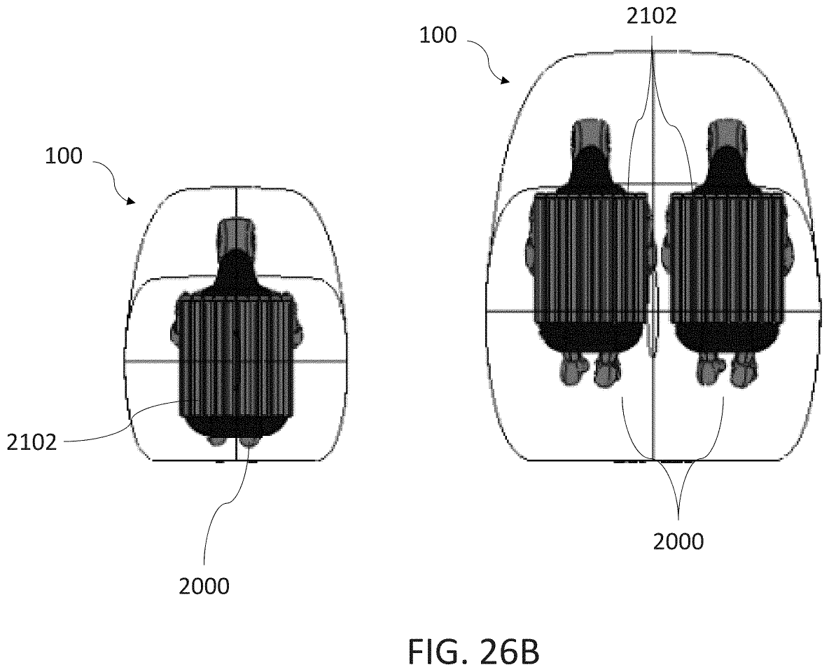

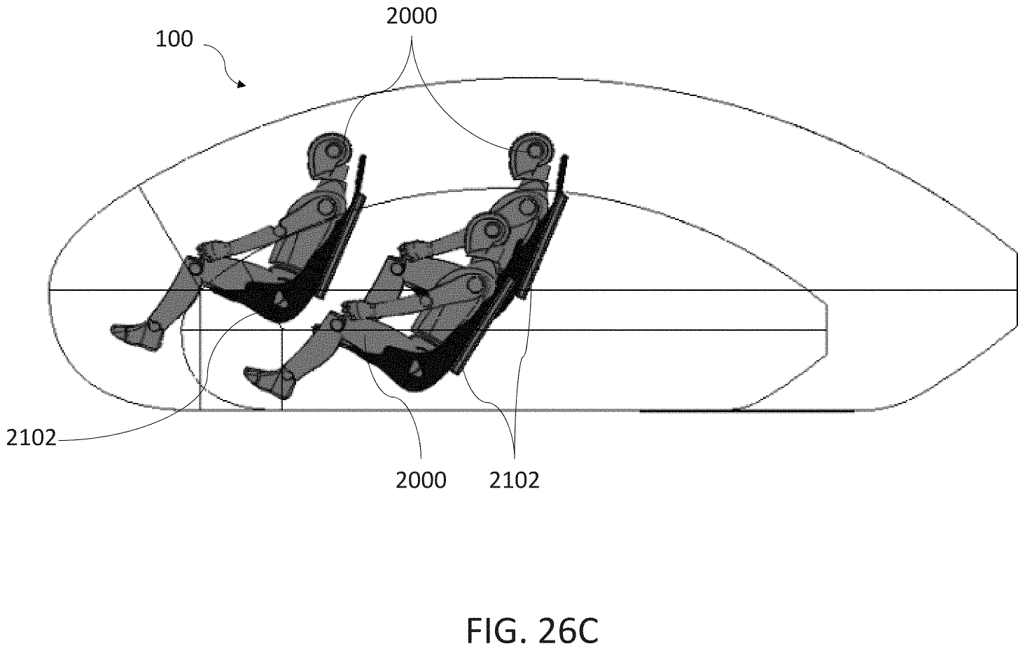

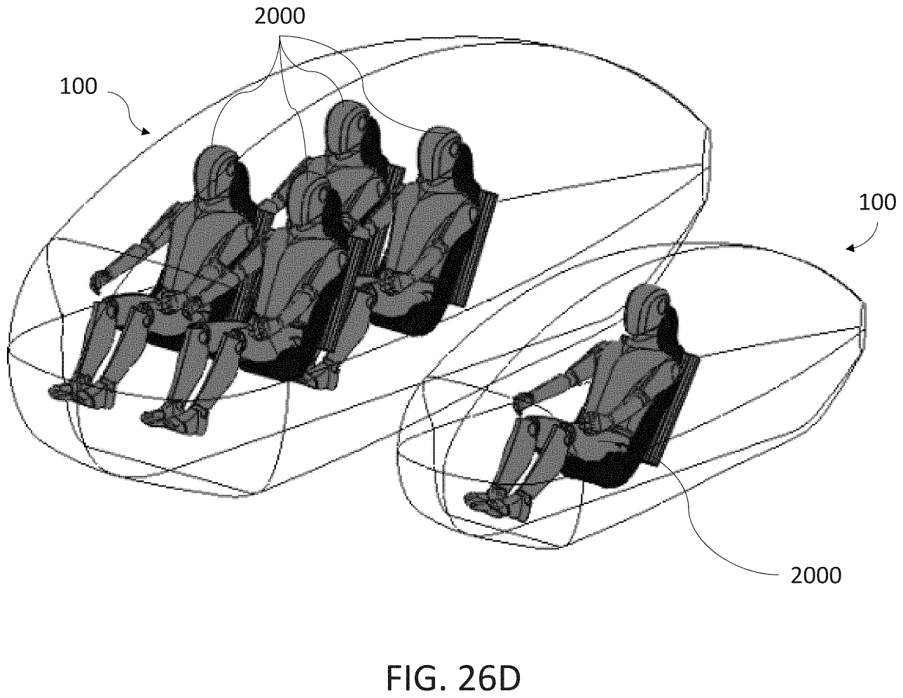

Generally, the payload 2000 may include a driver, a passenger, cargo, or any combinations of the foregoing. For example, FIGS. 26A-26D show several views of an exemplary front section 102 designed to accommodate one or four passengers. Each passenger seat 2102 may have a corresponding payload positioning joint 2100 to reorient each passenger as the vehicle 100 is reconfigured. The passengers may be arranged in several ways: side by side, front to back, staggered, facing toward center, facing outward, seated, prone, or reclined.

The payload positioning joint 2100 may be used to generate a desired motion path based on linear and/or rotary motion. In the case of a passenger, the payload positioning joint 2100 may be used to maintain a particular orientation of the passenger as the vehicle 100 articulates. For example, the payload positioning joint 2100 may be used to keep the passenger level as the vehicle 100 transitions from the low profile configuration to the high profile configuration. The payload positioning joint 2100 may be driven independently from the articulated joint 106 used to reconfigure the vehicle 100. In this manner, a desired passenger orientation may be maintained with respect to the vehicle 100 (a local reference) or the terrain (a global reference).

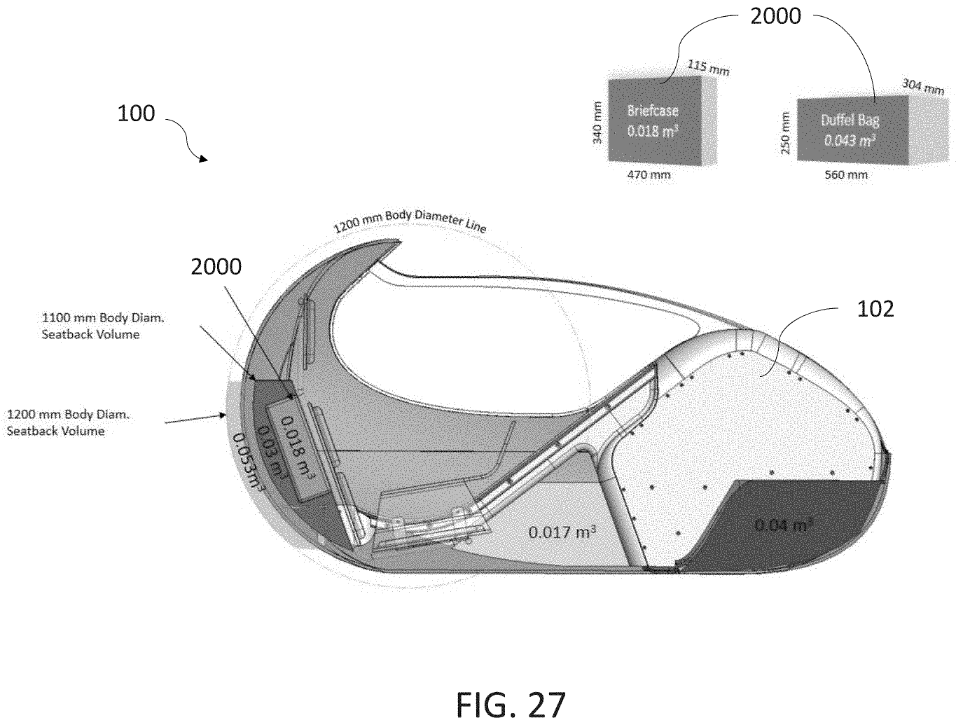

FIG. 27 shows another exemplary vehicle 100 where the payload 2000 is a package supported by a package platform 2104. This type of vehicle 100 may be designed, at least in part, as a package delivery platform. In some instances, the vehicle 100 may be an autonomous vehicle to make package deliveries. In one example, the articulated vehicle 100 may be driven by a passenger while commuting to work. Once the passenger is at work, the vehicle 100 may autonomously acquire and/or deliver packages. A robotic arm or manipulator may be implemented within the vehicle 100 to increase the dexterity for delivering packages, mail, and open doors.

The payload positioning joint 2100 may be used to maintain a horizontal or an otherwise preferred orientation of cargo in the vehicle 100. The payload positioning joint 2100 may also be used to stabilize and/or reduce the impact and shifting of cargo under dynamic loading conditions as created by accelerations, braking, and cornering.

In the following description, an exemplary payload positioning joint 2100 designed for passengers is discussed. It should be appreciated that the components and designs described may be adapted for other types of payloads (e.g., cargo), or multiple payloads.

### 5.1. An Exemplary Payload Positioning Joint for Passengers

FIG. 22B shows a cross-sectional view of a front vehicle section 102 in which the payload positioning joint 2100 is shown to accommodate a passenger. The payload positioning joint 2100 may include a support frame assembly 2110 for holding a platform to support the payload 2000 (not shown in this figure), two rails 2112 (only the left one of which can be seen in this view), and an arrangement of four bearing assemblies 2114, two on each side of the support frame assembly 2110. The support frame assembly 2110 may have a back-support frame 2110a, a bottom-support frame 2110b, an arm rest support frame 2110c on the left and right sides, and a bearing support bar 2110d attached to each of the left and right arm rest support frames 2110c. Two bearing assemblies 2114 that ride on the left rail 2112 are mounted on the left-side bearing support bar 2110d and two bearings 2114 that ride on the right rail 2112 are mounted on the right-side bearing support bar 2110d. On the back of the support frame assembly 2110 are two U-shaped frame members 2110e and 2110f that define a storage space behind the payload platform. The actual payload platform fits within and is held securely by the support frame assembly 2110.

As shown in FIGS. 22E and 22F, the front vehicle section 102 may include internal reinforcing molded, carbon fiber boxes that serve to both increase the rigidity of the vehicle 100 and provide surfaces on which instruments and other vehicle control components may be mounted. For example, two molded carbon fiber foot boxes 2116 are located at the front of and inside of the front vehicle section 102, one on each side of the vehicle 100. These boxes 2116 provide foot rests for the driver. Additionally, two molded, carbon fiber consoles 2118 may be placed inside of the front vehicle section 102, one on each side of the vehicle 100 to provide surfaces for mounting various vehicle instruments and controls. These consoles 2118 also provide surfaces onto which the rails 2112 in the payload positioning joint 2100 are mounted. FIGS. 22B and 22F also show the carbon fiber shell has a set of holes 2120 up front and under the foot box 2116. These represent locations where the motorized wheel assemblies are bolted onto the vehicle 100.

As shown in FIG. 22C, the rails 2112 are identical, contoured rails with a curved section 2122 in which the rail has a constant curvature of radius R and a straight section 2124 in which the rail is straight (or relatively straight). The center of the circle with radius R is identified by reference number 2126. With the rails 2112 mounted in the vehicle 100, the center 2126 coincides with the axis of rotation 111 shown in FIGS. 1A-1E. The two rails 2112 may lie within two parallel vertical planes that are themselves parallel to the longitudinal axis of the vehicle 100 when installed in the vehicle 100. The curved section of each rail 2112 may be concave in an upward direction. Each rail 2112 may include a series of equally spaced bolt holes 2156 along the side of the rail 2112. When mounted on the vehicle 100, bolts passing through these holes 2156 fixedly attach the rail 2112 to the respective consoles 2118 (see FIG. 22B). In the described embodiment, each rail 2112 may have an L-shaped cross-section as shown in FIG. 22D.

As will be described below, the curved section 2122 on which the support frame assembly 2110 rides functions to keep the payload platform in the same orientation as the front vehicle section 102 tilts forward or backward over a substantial range of tilt. The straight section 2124 may provide a runout region in which the support frame assembly 2110 can move forward to enable the driver to more easily exit the vehicle when the vehicle is in its fully contracted orientation (i.e., shortest wheelbase).

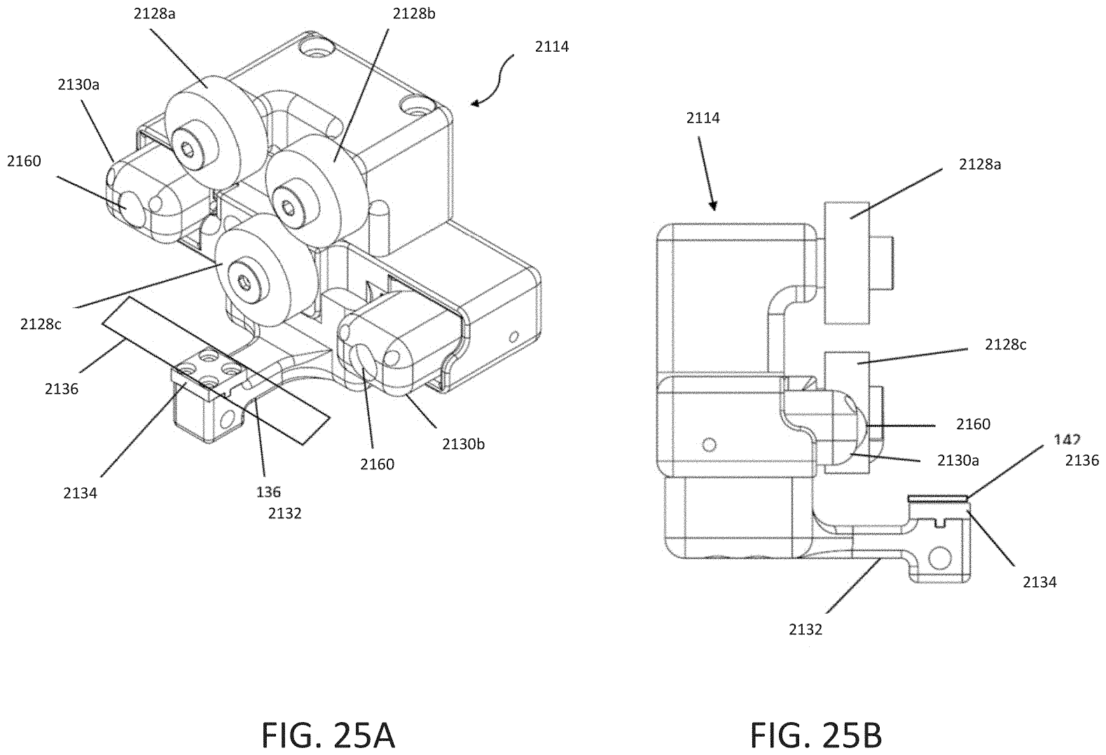

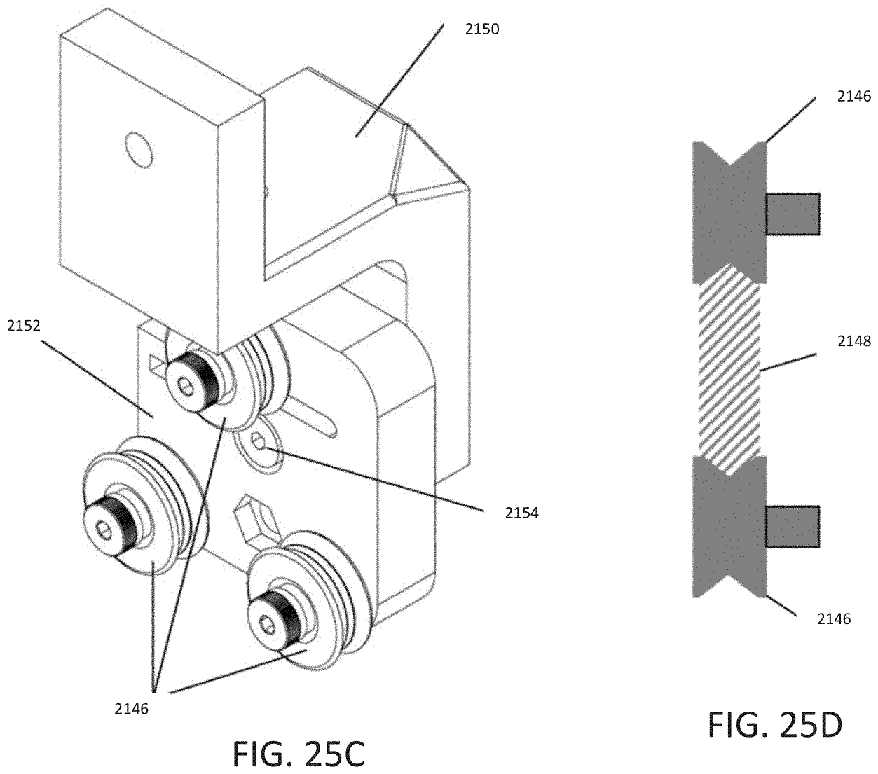

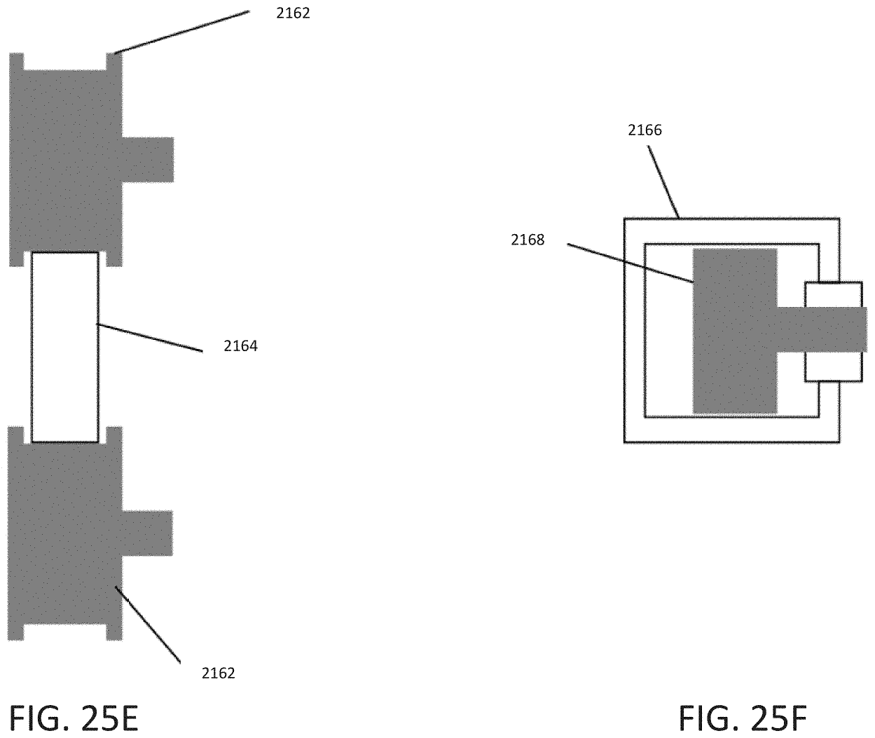

In FIGS. 25A and 25B, each bearing assembly 2114 may include a housing 2158 that supports three roller elements 2128a, 2128b, and 2128c. Two roller elements 2128a and 2128b may ride on the top surface of the horizontal leg of the L-shaped rail 2112 and the third roller element 2128c may ride under the horizontal leg of the L-shaped rail 2112 (see FIG. 22D). Each bearing assembly 2114 may also include two laterally constraining, housed bearings 2130a and 2130b, each holding their own respective ball bearing 2160. These housed bearings 2130a and 2130b ride along the inside surface of the downward extending leg of the L-shaped rail 2112 and maintain a lateral force that keeps the support frame assembly 2110 correctly aligned within the track system.

Each bearing assembly 2114 may also include a lower extended arm 2132 at the end of which there is a connection head 2134 where a belt or cable 2136 is connected for pulling the support frame assembly 2110 along the rails 2112, as described below.

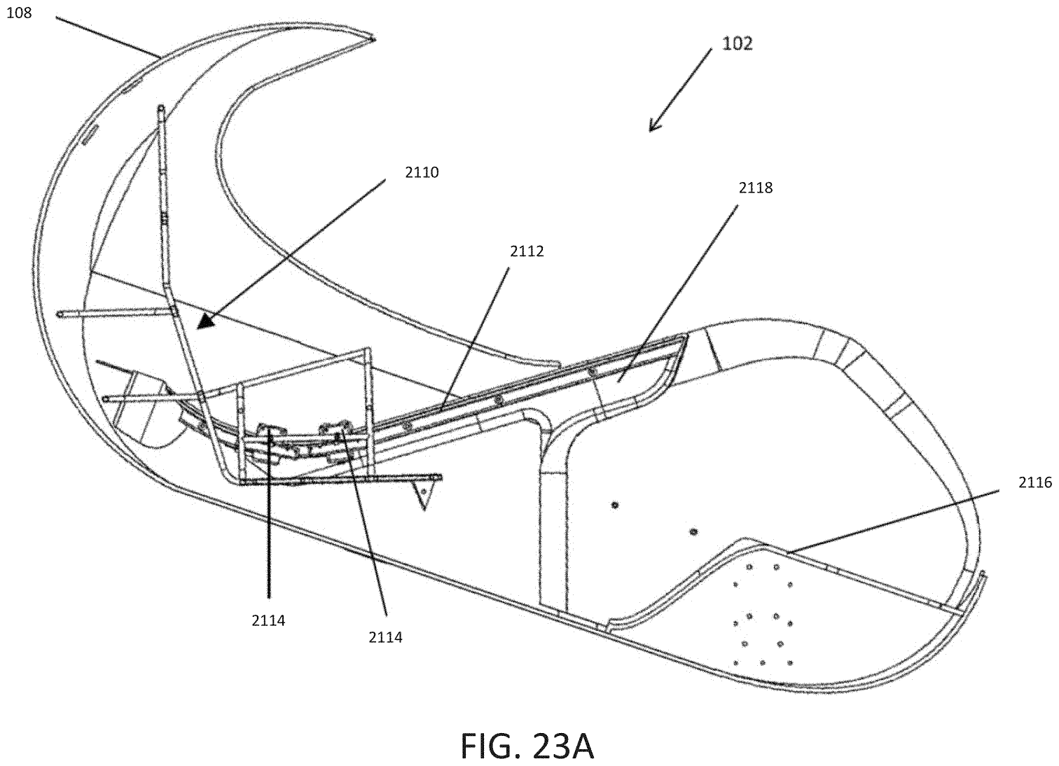

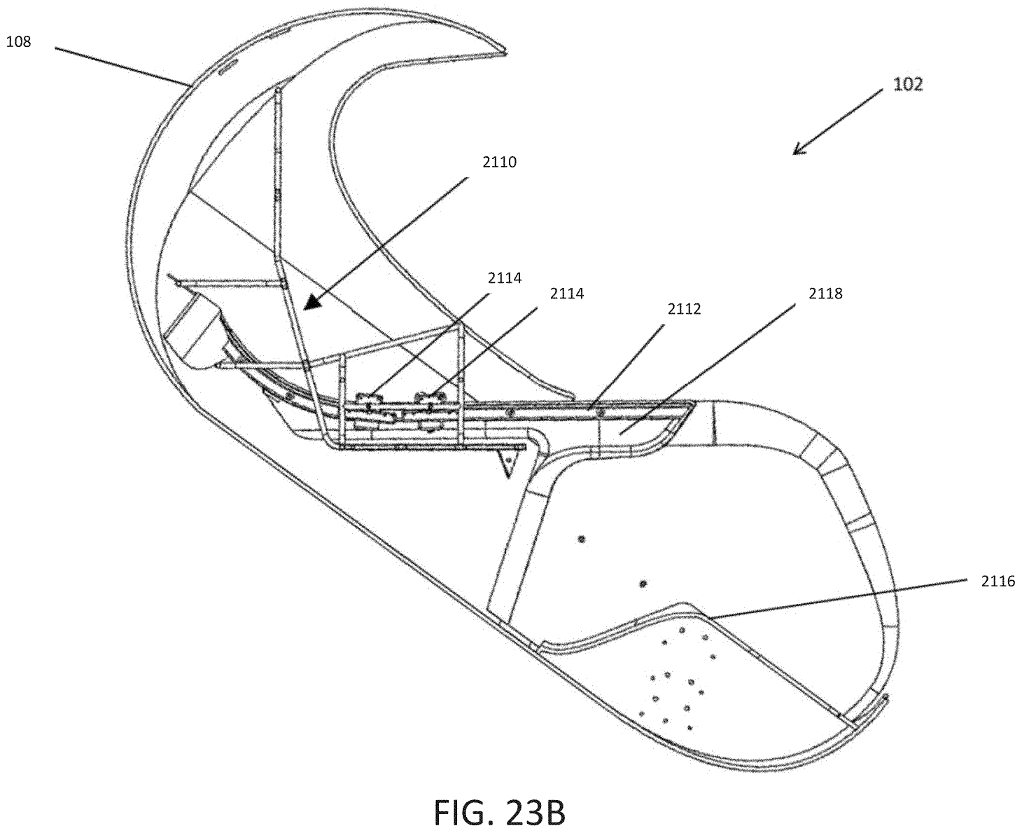

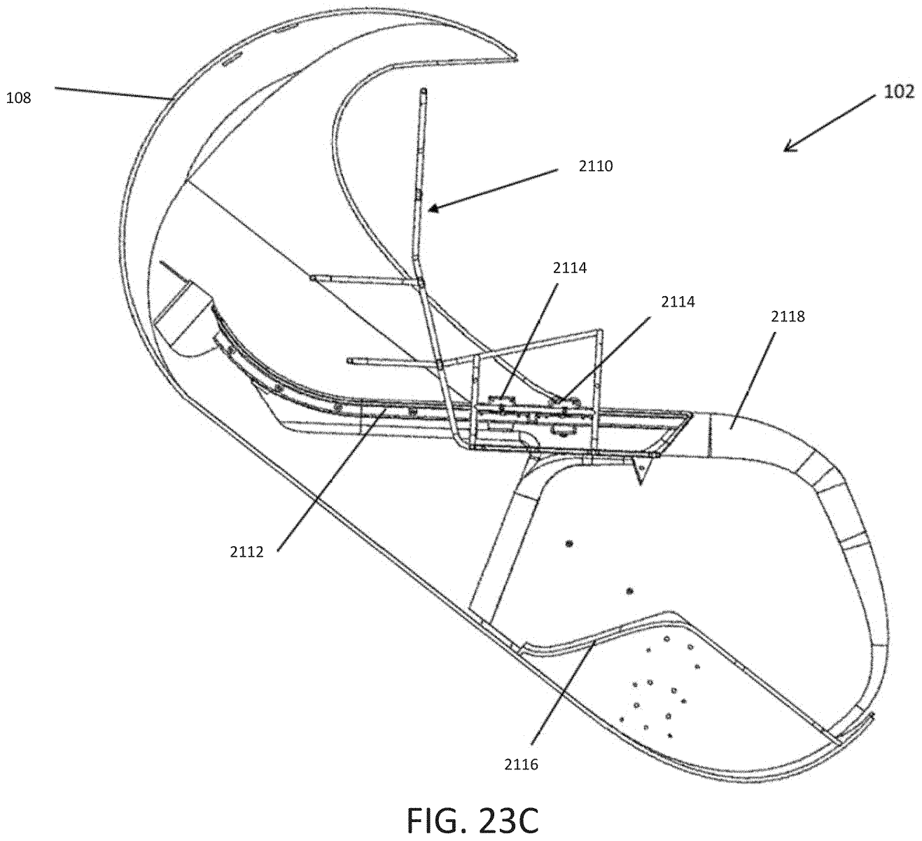

The operation of the payload positioning joint 2100 is illustrated by the sequence of cross-sectional views presented by FIGS. 22B, 23A, 23B, and 23C. When the vehicle 100 is in the low profile configuration, the front vehicle section 102 has 0° tilt as indicated in FIG. 22B. In this configuration, the straight section of the rail 2112 is at an inclination angle of about 40° with respect to the horizontal. If the frame 2110 is free to move on the rail 2112, the frame 2110 will move to its lowest position on the curved section of the rail 2112, as indicated. The bearings 2114 are attached to positions on the frame 2110 so that in the low profile configuration, the payload platform is oriented along a preferred orientation for regular operation of the vehicle 100. For example, the payload platform has the appropriate inclination to provide a comfortable driving position for the driver.

When the articulated joint 106 begins to rotate the tail section 104 downward, the front vehicle section 102 will begin to tilt upward in a forward direction. As the front vehicle section 102 tilts forward by so many degrees, the angle of inclination of the straight section of the rail 2112 will decrease by the same number of degrees, and the point along the curved section that is lowest with respect to the ground will also change, i.e., it will move forward. Assuming the support frame 2110 is free to roll along the rails 2112, the payload platform automatically moves to the new lowest position of the curved section of the rail while also automatically maintaining the same orientation when the vehicle 100 was in the low profile configuration. As the articulated joint 106 continues to rotate the tail section 104 downward, the front vehicle section 102 will eventually achieve a 20° tilt as illustrated by FIG. 23A. At this point, the angle of inclination of the straight section of the rail 2112 will also be about 20°.

If the articulated joint 106 continues to rotate the tail section 104 downward, the front vehicle section 102 will eventually achieve a forward tilt of 40°, as indicated by FIG. 23B. With front vehicle section 102 at a 40° tilt, the straight section 2124 of the rail 2112 will be horizontal with respect to the ground and the curved section 2122 of the rail 2112 will no longer define the point along the rail 2112 that is lowest with respect to the ground. At this point, the support frame 2110 will begin to roll onto the straight section 2124 of the rail 2112.

If the articulated joint 106 continues to rotate the tail section 104 downward, the front vehicle section 102 will eventually achieve a forward tilt of 45°, as indicated by FIG. 23C. This may represent the extent to which the wheelbase can be shortened by the articulated joint 106. This configuration also represents the point at which the straight section 2124 of the rail 2112 has a negative inclination of about 5° with respect to the ground and the lowest point along the rail 2112 with respect to the ground is now the end of the rail. If allowed to roll freely, the frame 2110 will roll along the rail 2112 toward the front of the vehicle 100 to achieve a position from which egress from the vehicle 100 is more easily accomplished, which is why this section of the rail 2112 was also characterized as the runout region.

Although the runout region is described as being straight, in other designs the runout region may have a slight curvature or diverge from being straight so long as the runout region serves to facilitate the forward movement of the support frame 2110 when approaching the limit in shortening the wheelbase in the low profile configuration.

Note that while the frame 2110 rolls along the curved section 2122 of the rail 2112, the frame 2110 will maintain a fixed orientation throughout its range of movement. That is, the tilting of the front vehicle section 102 does not cause the orientation of the payload platform to also tilt. The payload platform will also begin to tilt after the 40° tilt of the front vehicle section has been reached.

Also note that the particular track system design described above achieves a very efficient use of space inside of the vehicle 100. For example, the volume that the payload platform and the payload 2000 sweep through within the cabin of the vehicle and over the range of tilt from 0° to 40° is small. Of course, other curved rail configurations could be used if this is not an important consideration. For example, the curved section 2122 could be characterized by a changing radius of curvature as one moves along that section of the rail. In addition, the straight section 2124 of the rail could also be slightly curved as well to facilitate driver egress depending on the design of the vehicle 100. For example, it could be slightly curved in the opposite direction from the curve of the curved section 2122.

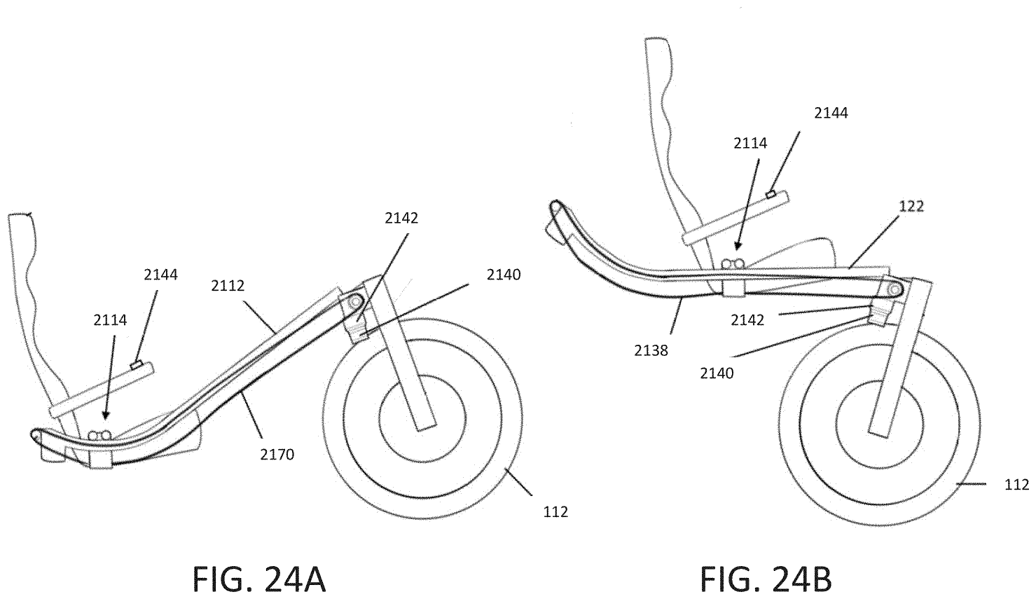

The payload positioning joint 2100 described thus far may be actuated by gravity alone. However, in some designs, the payload positioning joint 2100 may be motorized. An example of a motorized drive system is shown in FIGS. 24A and 24B. A belt or cable 2138 may be included on one side of the frame 2110. The belt or cable 2138 is in a closed loop configuration and the frame 2110 is connected to the belt or cable. For example, the frame 2110 may be connected to the belt or cable 2138 via the connection head 2134 on the bearing assembly 2114 (see FIGS. 25A and 25B) or connected directly to the belt or cable 2138. The belt or cable loops over a pulley 2170 at one end and is driven by a motor 2142 at the other end.

A controller 2140 may also be used to operate the motor 2142 and to determine where to position the support frame 2110 along the rail 2112. The controller 2140 may include sensors to detect the tilt of the front vehicle section 102 or monitor a signal from the articulated joint 106 that controls the degree of tilt of the front vehicle section 102. In either case, the controller 2140 may be programmed to know where the payload platform should be along the rail as a function of tilt and thus moves the frame 2110 to that location. There may also be a manual control 2144 which enables the driver to activate an egress mode in which the motor 2142 moves the frame 2110 forward along the straight section 2124 of rail to facilitate the egress of the driver from the vehicle 100. The egress mode may only be available when the tilt of the front vehicle section 102 reaches or exceeds a certain amount, e.g., 40° tilt.

It should be appreciated the motorized payload positioning joint 2100 depicted in FIGS. 24A and 24B is merely illustrative of one of many alternatives for moving the frame 2110 along the rail 2112. Other implementations might, for example, use a rack and pinion arrangement or a multi-bar linkage arrangement. Other exemplary mechanisms described above for the articulated joint 106 may also be applied to the payload positioning joint 2100.

Also, the bearing assembly and rail design described above is merely illustrative of one of many possible designs. FIGS. 25C and 25D show another design which employs vertical force Vee rollers 2146 riding on a Vee rail 2148. The bearing assembly may include a bracket 2150 to connect the assembly to the support frame 2110. The bearing assembly may also include a rocker block 2152 on which three Vee rollers are mounted (e.g., one roller runs on top of the rail 180 and the other two rollers ride along the bottom of the rail). The rocker block 2152 is mounted on the bracket 2150 by a position adjustment bearing 2154 that enables the rocker block 2152 to pivot with respect to the bracket 2150. This pivot may be useful since multiple rockers on the same rail will not be parallel when in the curved section of the rail, but the bottom of the payload platform should remain parallel to ground.

Other examples of possible roller and rail designs are shown in FIGS. 25E and 25F. In FIG. 25E, the rollers 2162 are flat channel rollers that ride on a rail 2164 that has a rectangular cross-section. In FIG. 25F, the roller 2168 rides within an extruded U-channel rail 2166.

It should also be appreciated that the payload positioning joint 2100 described above may be retrofit in a conventional vehicle as a payload (e.g. seat) inclination controller. The rail may have a curved section as described above without the straight, runout section. A motorized drive system would enable an operator (e.g. a driver) to change the payload platform's location along the curved section of the rail which, in turn, would control the inclination of the payload platform with respect to the ground.

Additionally, the number of bearing assemblies used may vary in other designs. Instead of using four bearing assemblies, fewer bearing assemblies (e.g., two or three) or more than four bearing assemblies may be used. Additionally, roller bearings may be substituted with plain bearings, ball bearings, or sliding elements. The surfaces of the bearings and the rails that contact may be further coated with a low friction coating (e.g., lubricant, Teflon, graphite) to reduce the coefficient of friction (i.e., making the components more slippery), thus making movement of the frame 2110 along the rails 2112 easier. Furthermore, the number of rails 2112 may also vary. A single contoured rail 2112 may be used or more than two contoured rails 2112 may be used. The payload positioning joint 2100 described above may also be used in other vehicle types, e.g., other land vehicles, water vehicles, two and four-wheel vehicles, and even airborne vehicles.

### 6. EXEMPLARY APPLICATIONS FOR THE ARTICULATED VEHICLE

The reconfigurability of the articulated vehicle 100 may enable additional capabilities that are not possible in conventional vehicles. In the following description, several exemplary applications are described that leverage the reconfigurability of the vehicle 100. It should be appreciated that these exemplary uses of the articulated vehicle 100 are not limiting and that other applications may be conceived using similar articulated vehicles 100, articulated joints 106, morphing sections 123, and/or payload positioning joints 2100.

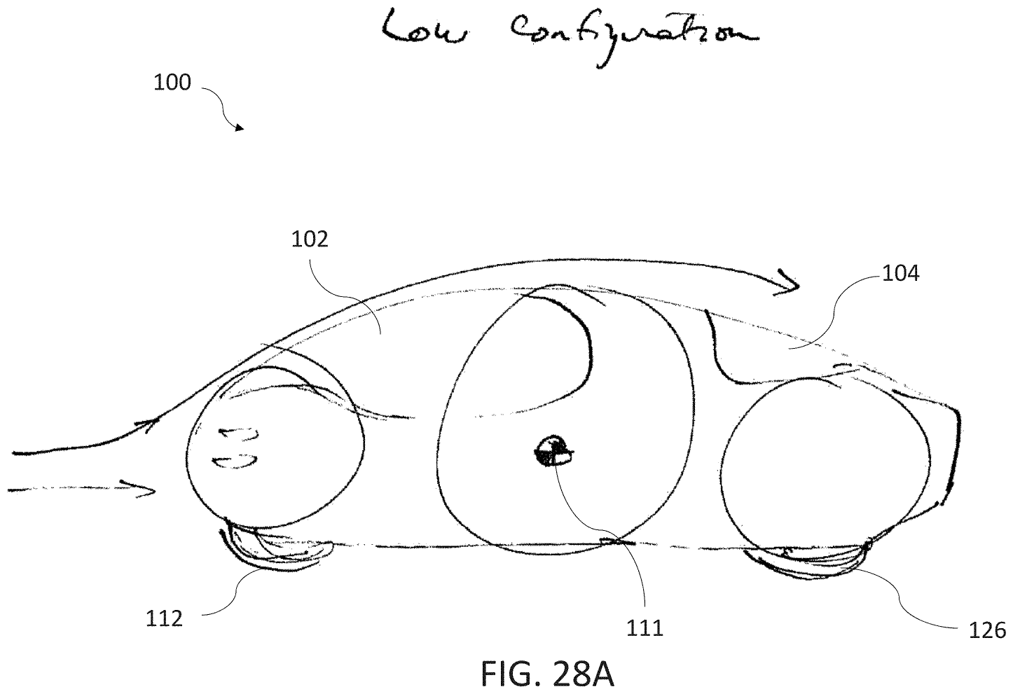

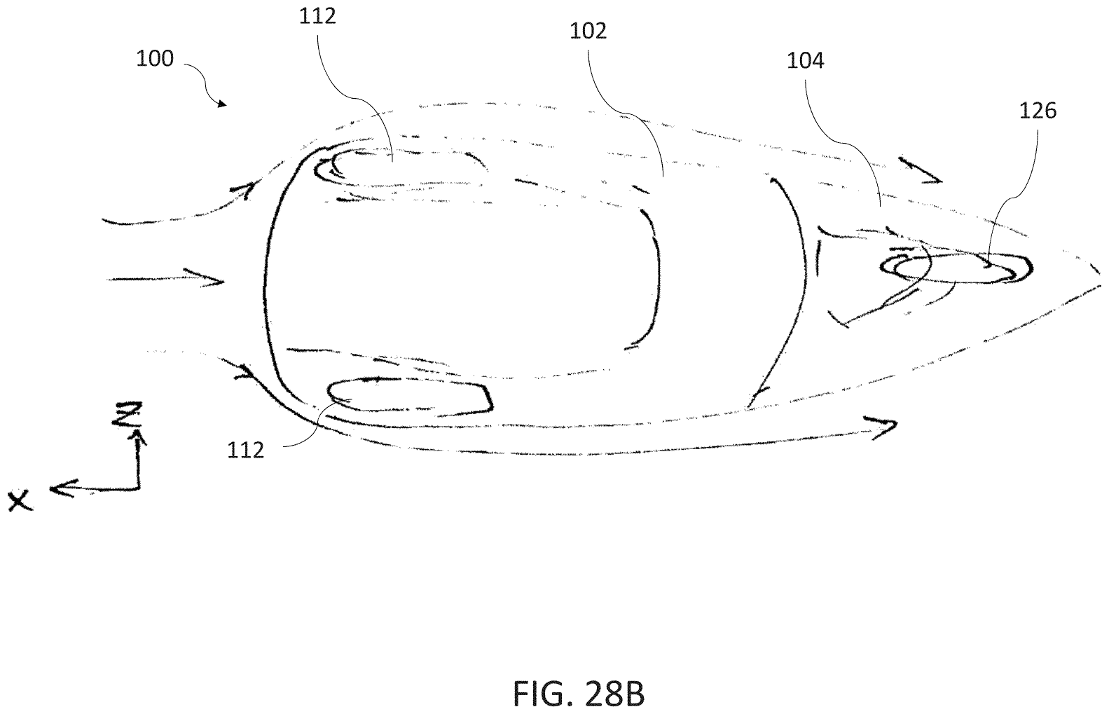

FIGS. 28A and 28B show a side view and a top view, respectively, of the articulated vehicle 100 in the low profile configuration and exemplary streamlines around the vehicle 100. In the low profile configuration, the wheelbase of the vehicle 100 is extended and the driver is positioned closer to the road. As previously described, the low profile configuration may reduce the drag coefficient and the frontal cross-sectional area of the vehicle 100, thus reducing the drag force imparted on the vehicle 100. This configuration may thus be beneficial when the vehicle 100 is traveling at high speeds, such as on a highway, by reducing the amount of energy consumed to maintain the vehicle 100 at such speeds. Additionally, the center of mass of the vehicle 100 may be lowered, thus increasing the stability of the vehicle 100 especially at high speeds and cornering rates.

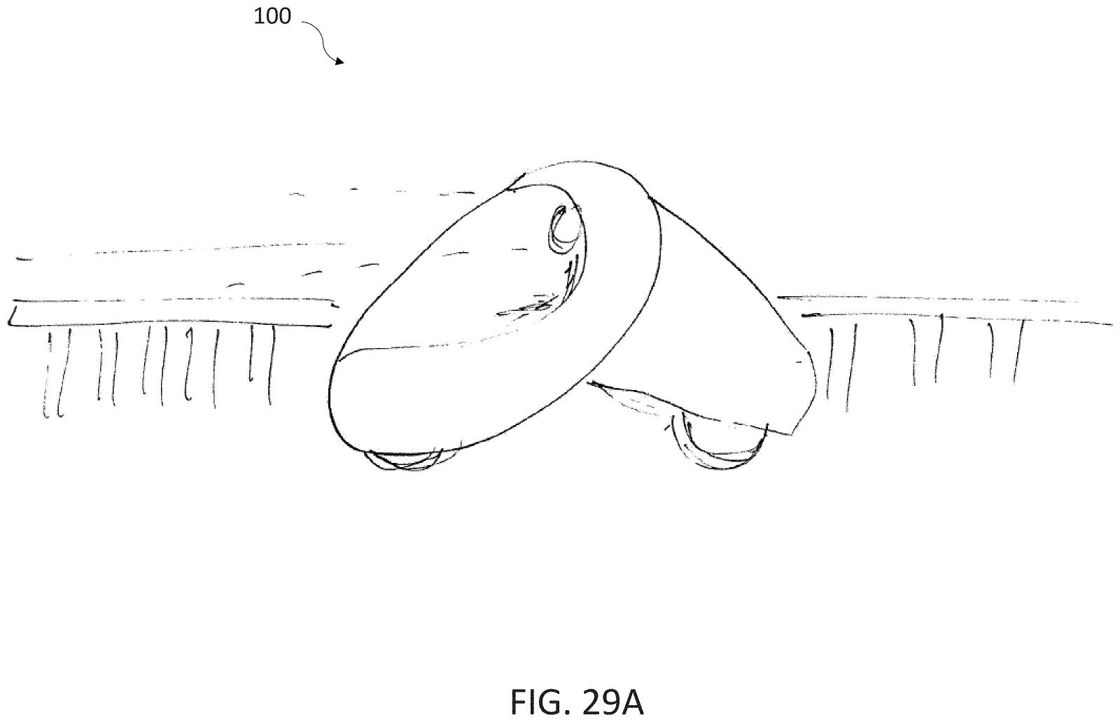

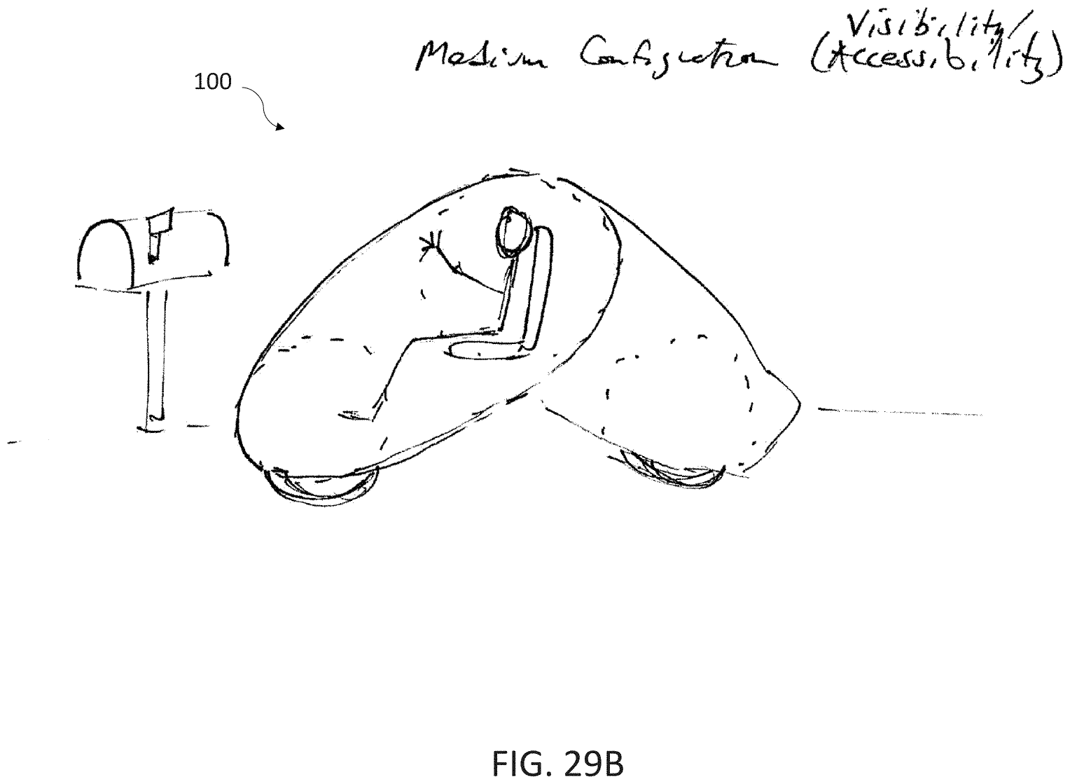

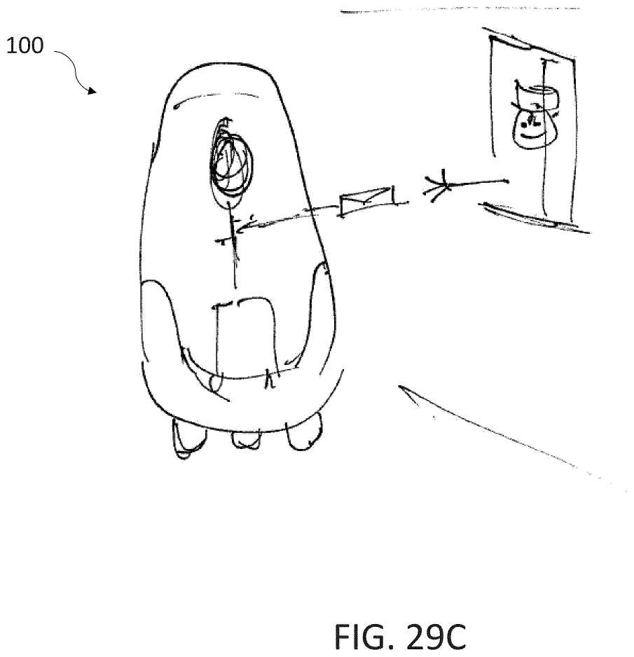

FIGS. 29A-29C show the articulated vehicle 100 in an intermediate profile configuration (i.e., a configuration between the low profile configuration and the high profile configuration). As shown, this configuration may be used to raise the height of the vehicle 100, which can have several benefits. For example, the vehicle 100 may have greater visibility of the road as shown in FIG. 29A while still maintaining low center of gravity for vehicle handling and stability. The ability to raise the articulated vehicle 100 to varying heights may also improve accessibility to other vehicles and/or other interactions with the environment. For example, FIG. 29B shows the vehicle 100 may be configured to allow the driver to access a mailbox on the side of a road. FIG. 29C shows the vehicle 100 may be configured to allow the driver to interact with a drive-through window (e.g., to receive fast food, to deliver a letter, receive cash from a bank, medicine from a pharmacy). Other examples may include interaction with a bank ATM, a pharmacy prescription counter, or another human standing on the side of the road (i.e., a neighbor or cyclist). In applications where the articulated vehicle 100 is used to transport cargo, the ability to dynamically change the height of the vehicle 100 may improve the ease of delivery of cargo and/or receipt of cargo at a loading dock, to/from other robots or humans, and so on.

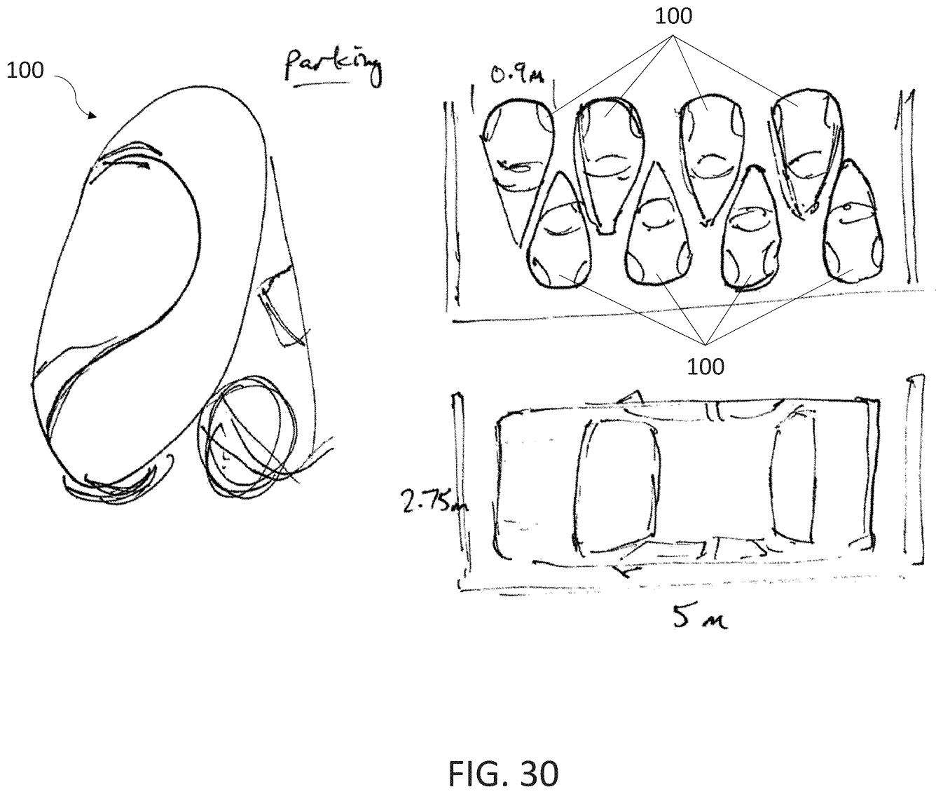

FIG. 30 shows the articulated vehicle 100 in a high profile configuration where the wheelbase is contracted and the height of the vehicle 100 is at its highest. The high profile configuration may represent the height limit available for the payload 2000 to interact with the surrounding environment. The shortened wheelbase also reduces the footprint of the vehicle 100, which may be beneficial when parking the vehicle 100. For example, FIG. 30 shows a plurality of vehicles 100 (at least 8) may be parked in a space typically occupied by a single conventional passenger vehicle using a nested arrangement. The relative orientation of the vehicles 100 may reduce the overall footprint while maintaining access for ingress/egress.

The high profile configuration may also improve the ease of ingress/egress of the payload 2000. For example, the payload positioning joint 2100 described above in the high profile configuration may allow: (1) a passenger to step into or out of the vehicle 100 or (2) a package to be presented at the height of a worker or a robot. To this end, the vehicle 100 may also be parked facing towards a curb for safer ingress/egress.

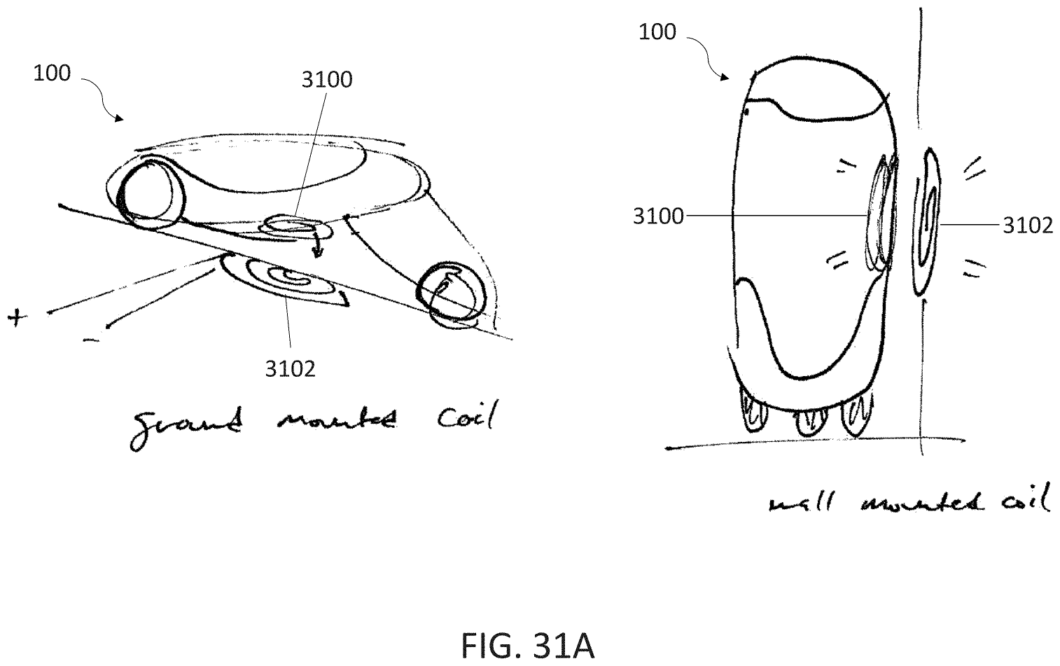

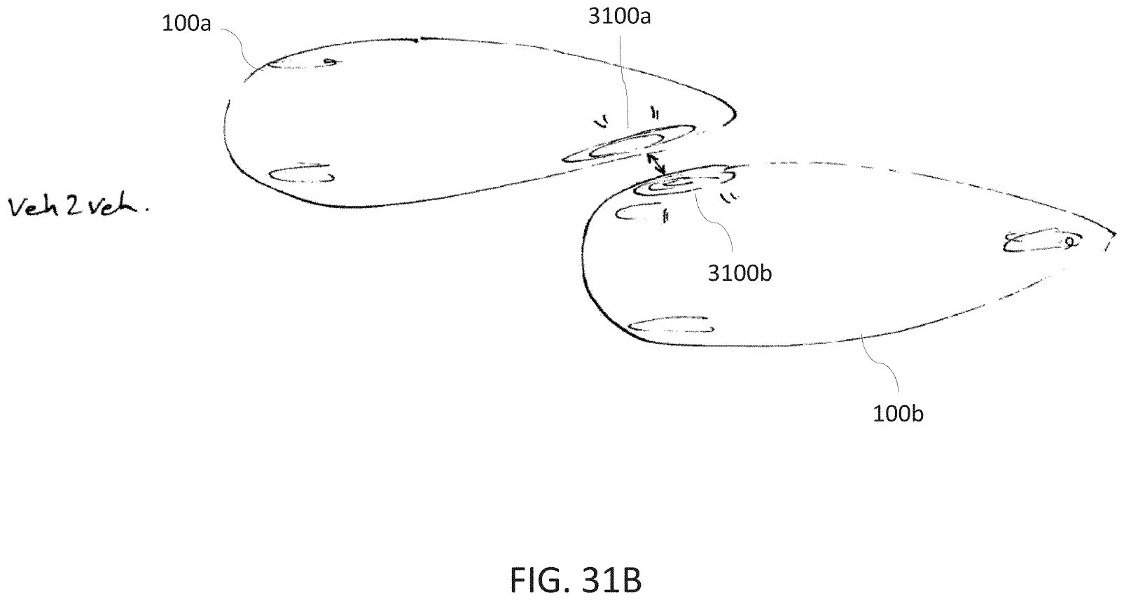

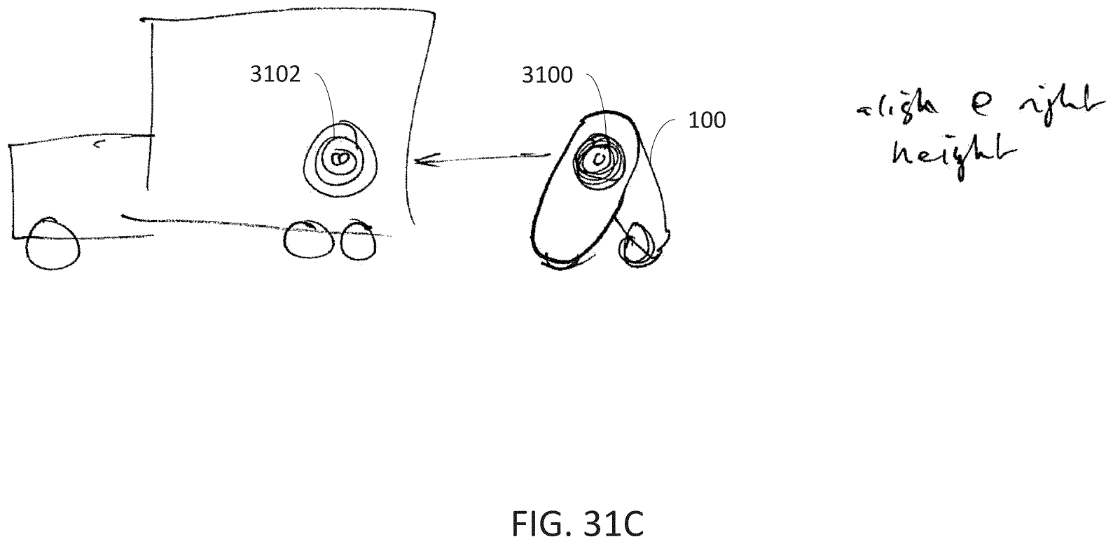

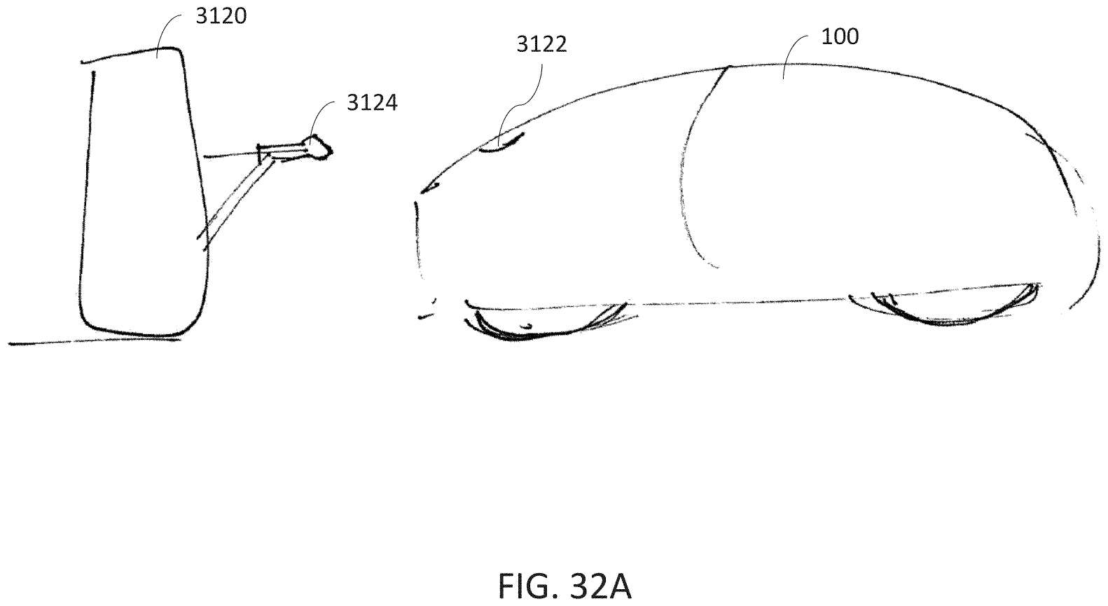

The reconfigurability of the articulated vehicle 100 may also assist with power transfer to or from the vehicle 100. For example, the articulated vehicle 100 may include a wireless power transfer system (WPTS) with one or more receivers 3100 to receive wireless power from an external transmitter 3102. In some cases, the receiver 3100 on the vehicle 100 may be configured to function as a transmitter where power from the vehicle 100 is transferred to an external receiver (e.g., using energy stored in an onboard battery in the vehicle 100). FIG. 31A shows on application where the articulated vehicle 100 may be configured in order to precisely align the receiver 3100 to a transmitter disposed on a stationary dock in order to increase the power transfer rate and/or the power transfer efficiency. As shown, the articulated vehicle 100 may be in a low profile configuration in the case where the WPTS receiver 3100 is disposed on the bottom of the vehicle 100 and the external transmitter 3102 is mounted onto the ground. Additionally, the vehicle 100 may be in a high profile configuration in the case where the WPTS receiver 3100 is disposed on a side of the vehicle 100 and the external transmitter 3102 is mounted onto a wall.

FIG. 31B shows another example where the WPTS receiver 3100a on one vehicle 100a may align to another receiver 3100b (configured to function as a transmitter) on another vehicle 100b, thus enabling wireless power transfer between vehicles 100a and 100b. The two vehicles 100a and 100b may be stationary or moving. Furthermore, wireless power transfer may occur between two identical vehicles 100 in which case the configurations of both vehicles 100 should be preferably the same. Wireless power transfer may also occur between two dissimilar vehicles, as depicted in FIG. 31C. As shown, the vehicle 100 may be configured to be in a high profile configuration to align the WPTS receiver 3100a to a transmitter disposed on the side of a truck (which may be loaded with batteries).

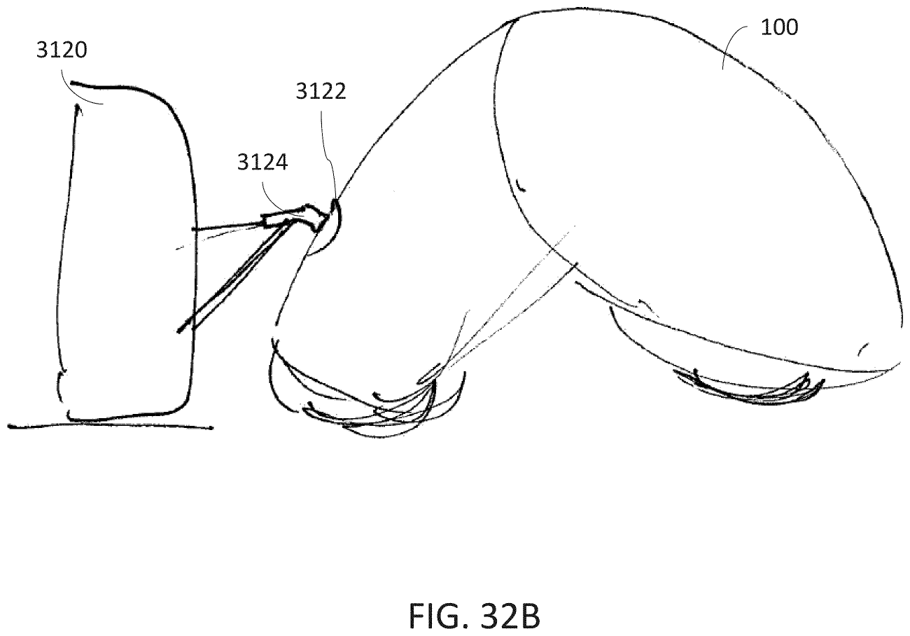

The vehicle 100 may also be configured to align with and dock to a wired charging station. FIGS. 32A and 32B show that the vehicle 100 may have a charging port 3122 and the charging station 3120 has a charging receptacle 3124. As the vehicle 100 approaches the charging station 3120, the height of the vehicle 100 may be adjusted to align the charging port 3122 to the charging receptacle 3124 as shown.

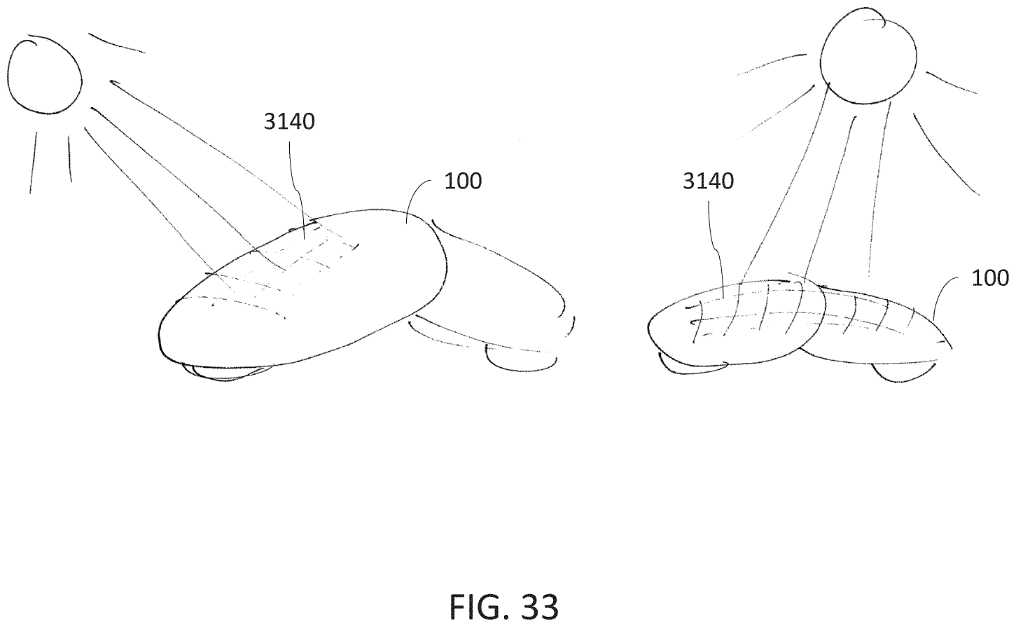

The vehicle 100 may also include a photovoltaic (PV) cell 3140 to convert solar energy into electrical energy stored in an onboard battery. Typically, the amount of solar energy converted by the PV cell into electricity varies during the day as the Sun moves across the sky. For this reason, PV cells may include a tracking mechanism to orient the PV cell towards the Sun as the Sun moves across the sky in order to increase the power output of the PV cell. In conventional vehicles, a PV cell disposed on the roof of the vehicle is stationary, hence, the performance is limited by the lack of tracking. The articulated vehicle 100, however, may reconfigure its form and/or orientation and, hence, may function as a solar tracking device. As shown in FIG. 33, the vehicle 100 may be articulated such that a PV cell 3140 mounted onto the vehicle 100 is oriented towards the Sun. In some cases, the PV cell 3140 may be permanently coupled to the vehicle 100 and used to charge an onboard battery in the vehicle 100. In other cases, the PV cell 3140 may be temporarily coupled to the vehicle 100 to partially charge the vehicle 100 and partially charge a portable battery that can then power other devices. The PV cells 3140 may be mounted onto the external surface of the vehicle 100 including the canopy 110.

The reconfigurability of the articulated vehicle 100 may also provide additional dynamic capabilities. The primary articulation axis under consideration below is a centered Y-axis pivot as shown in related drawings. Additionally, some behaviors listed below require an additional actuated degree of freedom (DOF) per wheel. Unless otherwise stated, this degree of freedom will allow the wheel to extend linearly along or nearly parallel to its dynamic suspension axis. This may be referred to as the long-travel suspension. This suspension may be a non-back-drivable element and therefore non-continuous power consuming. The active or dynamic suspension is often referred to as the short travel suspension and may be addressed by a passive and/or active suspension system (i.e. the Traction T1 motor).

The articulated vehicle 100 may be actuated to provide a walking motion rather than (or in addition to) rolling. The walking motion may be achieved, in part, using additional independent actuation of each wheel to adjust the ride height of the vehicle 100. For instance, the caster angle adjuster previously described may be paired with a long travel linear motion axis that is parallel or near parallel to the caster angle to generate the walking motion. The caster angle adjuster may sweep the caster angle across an arc and the long travel articulation may lift or lower the wheels, thus producing a motion akin to footsteps across a surface. This type of walking motion may be preferable in some terrains where rolling is less feasible or effective (e.g., along a road with downed trees or rocks). The articulation of the vehicle 100 about the primary articulation axis may provide an additional DOF to extend and/or complement the walking capability of the vehicle 100 by effectively shifting the center of mass or adjusting the relative orientation of the payload 2000. The walking motion may take place with or without combined rolling of any or all of the wheels.

The long travel suspension elements described above may also allow the vehicle 100 to lean (e.g., potentially up to about ±45°, see FIG. 21F). A vehicle 100 with a narrow track width is preferable for reducing aerodynamic drag and/or reducing the urban footprint/maneuverability. However, the narrow form factor may lead to poor dynamic stability especially when the vehicle 100 is cornering in a turn. At high cornering rates, the vehicle 100 with a narrow track width may tend to lean outwards, thus affecting stability. It is preferable for the vehicle 100 to instead towards the center of rotation of the turn such as when operating a motorcycle.

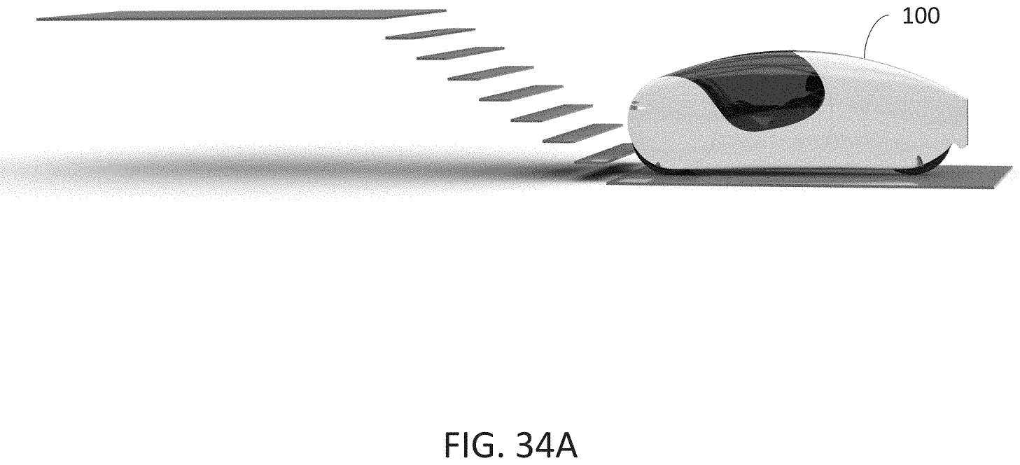

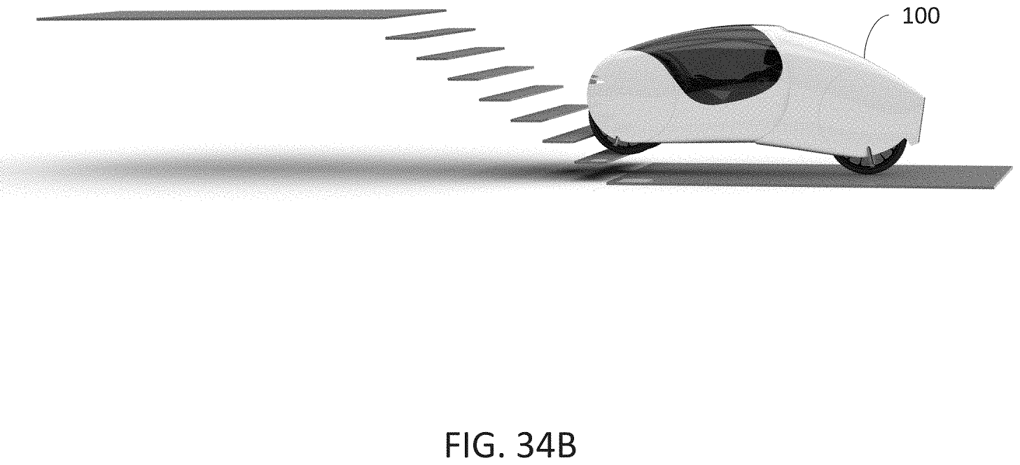

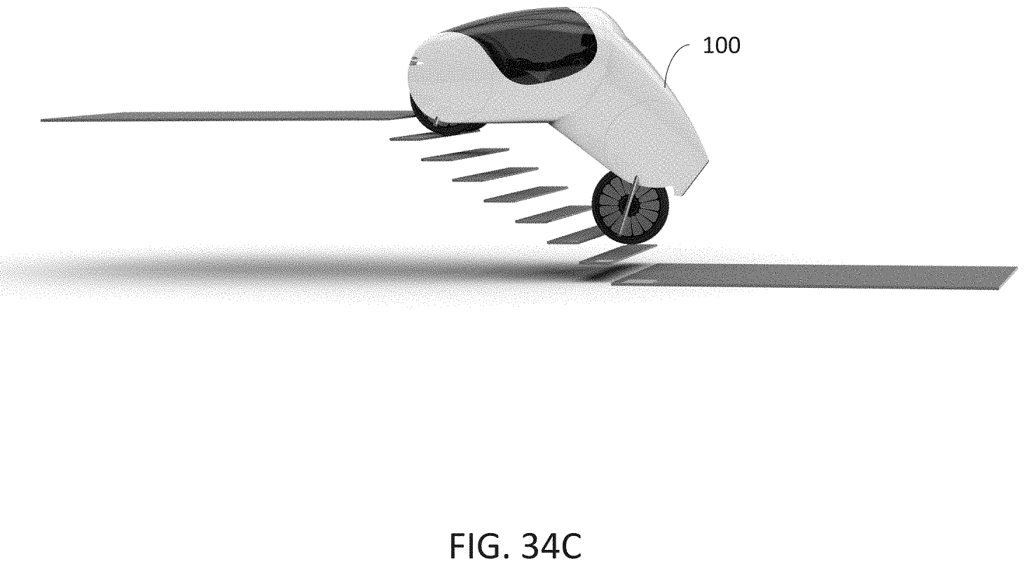

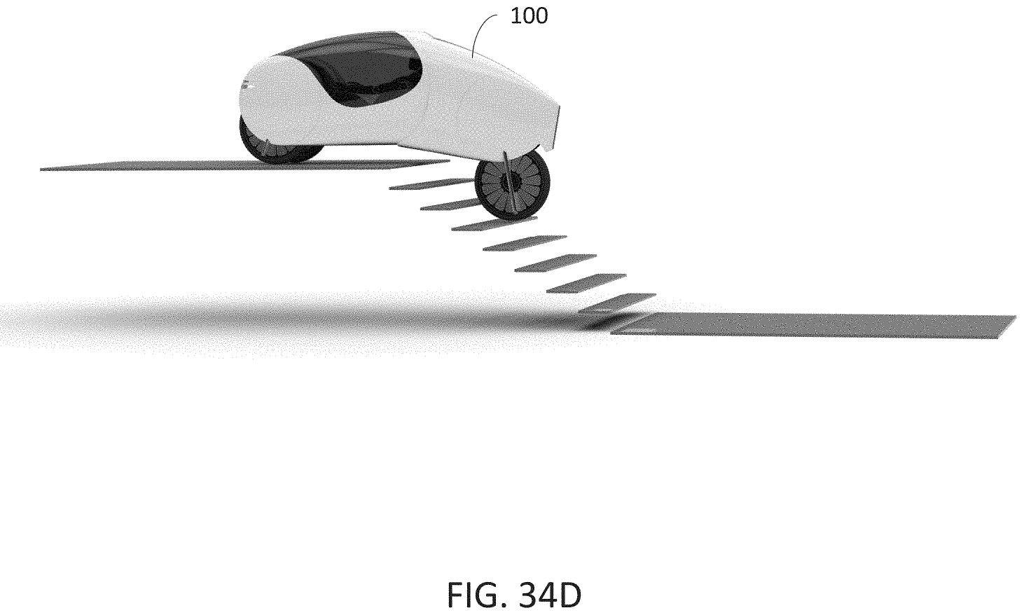

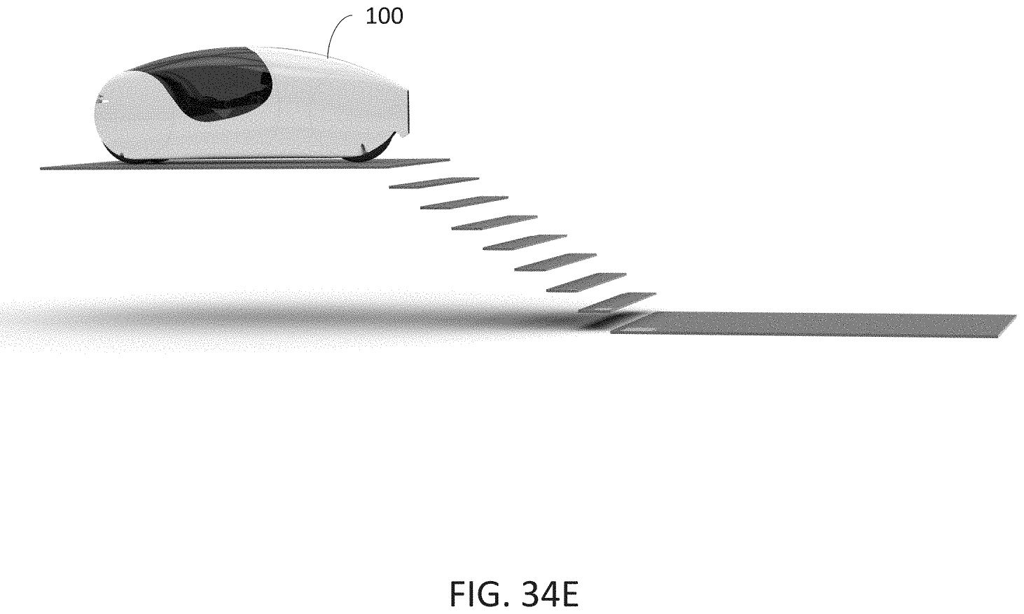

In addition to walking and leaning, the vehicle 100 may also be capable of climbing stairs. FIGS. 34A-34E show an exemplary vehicle 100 traversing a set of stairs by using a combination of the long travel suspension articulation and the articulation of the vehicle 100 about the primary articulation axis. As shown, these articulation DOF's may be used to “walk” the wheels up the stairs using a combination of maneuvers that include, but are not limited to: (1) braking the front wheel 112 and rotating the rear wheel 126 while the vehicle 100 articulates to the high profile configuration, (2) braking the rear wheel 126 and rotating the front wheel 112 while the vehicle 100 articulates to the low profile configuration, (3) extending/contracting the long travel suspension articulation of each wheel to ensure the front section 102 and the tail section 104 have sufficient clearance from the stairs. In some cases, the vehicle 100 may be configured such that the torque imparted onto each wheel is sufficient to lift the front section 102 and the tail section 104 off the ground (e.g., similar to the front end of a rear-wheel drive vehicle lifting off the ground during a drag race). This may be used to provide more of a “stepping” motion as the vehicle 100 traverses the stairs. As the vehicle 100 climbs the stairs, the payload positioning joint 2100 in the vehicle 100 may be used to maintain a fixed payload orientation with respect to the environment so that the payload 2000 does not experience any undesirable jostling or jolting.

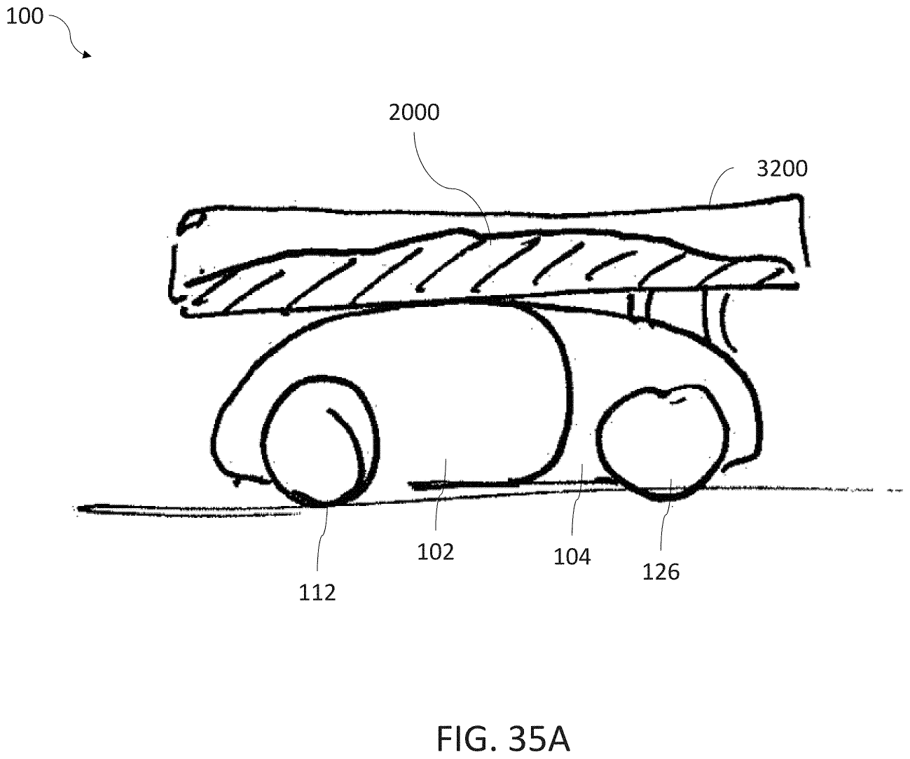

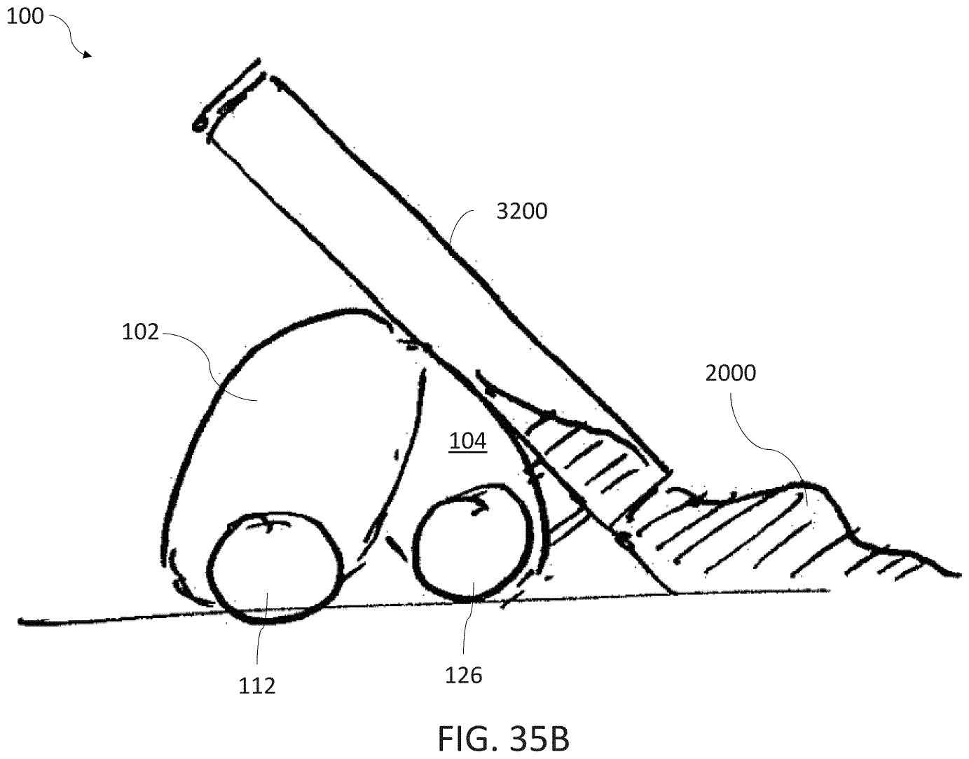

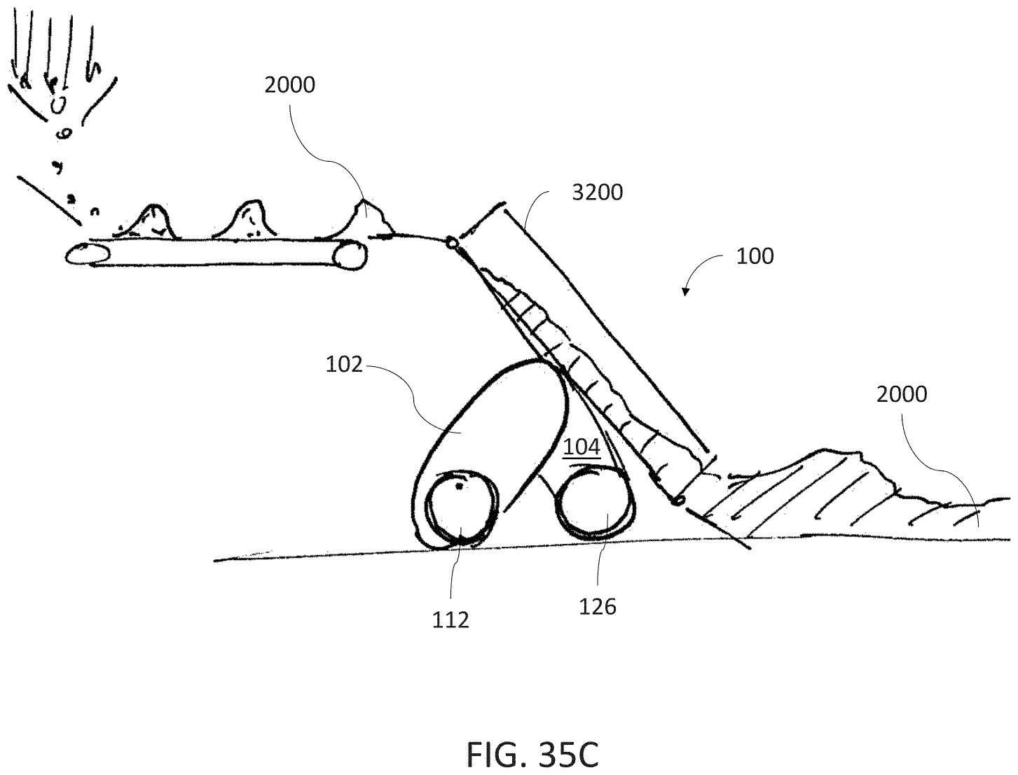

In yet another example, the articulated vehicle 100 may include a flatbed 3200 designed to carry the payload 2000 (e.g., packages, construction materials, farming materials). FIGS. 35A-35C show an exemplary vehicle 100 with a flatbed 3200 in various configurations. As shown in FIG. 35A, the flatbed 3200 may be a platform or container disposed above the vehicle 100 and coupled to the tail section 104. The flatbed 3200 may be horizontal when the vehicle 100 is in a low profile configuration to store and/or transport the payload 2000. As the vehicle 100 is articulated to the high profile configuration, the flatbed 3200 may be tilted such that the payload 2000 is offloaded from the rear of the vehicle 100 as shown in FIG. 35B. The flatbed 3200 may include at least one hatch disposed at the front end and/or the rear end, which can be opened (manually or automatically via a motor or a linkage coupled to the articulated joint 106) to facilitate loading and offloading of the payload 2000. It should also be appreciated that in other designs, the flatbed 3200 may be coupled to the front section 102 in order to load/offload the payload 2000 from the front of the vehicle 100 instead of the rear.

The manner in which the vehicle 100 offloads the payload 2000 may depend on various factors including, but not limited to, the weight of the payload 2000, the terrain (e.g., pavement, dirt, mud, loose gravel, snow) onto which the vehicle 100 is offloading the payload 2000, and the desired distribution of the offloaded payload 2000 (e.g., a single large pile, multiple smaller piles, an evenly distributed, linear pile). In some cases, the drive actuator 540 shown in FIGS. 7A-7G may provide a sufficient actuating force to articulate the vehicle 100 and offload the payload 2000 from the flatbed 3200. The actuating force may be supplemented (or substituted) by driving the front wheel 112 and/or the rear wheel 126 in a manner depicted in FIGS. 8A-8C. In cases where the vehicle 100 does not have sufficient traction (e.g., the wheels slip in muddy conditions), an additional anchor may be deployed to prevent the vehicle 100 from sliding in an undesirable manner.

FIG. 35C shows another exemplary use case of the vehicle 100 where the flatbed 3200 is oriented to receive the payload 2000 from an elevated position (e.g., distribution of grain from another vehicle or facility). The reconfigurability of the vehicle 100 may be used to accommodate different systems that load the payload 2000 at different heights. Once a sufficient amount of the payload 2000 is loaded onto the vehicle 100, the vehicle 100 may change to the low profile configuration for subsequent transport to another location. Alternatively, the vehicle 100 may function as a reconfigurable conveyor belt to move the payload 2000 from an elevated position to the ground as shown in FIG. 35C.

For this application, the vehicle 100 may be controlled by a driver or autonomous. Although the flatbed 3200 depicted in FIGS. 35A-35C is used with the articulated vehicle 100 described herein, it should be appreciated the various articulated joints 106 described herein may also be retrofit onto vehicles that may or may not articulate. For instance, the articulated joint 106 may be integrated into a pickup truck to actuate a flatbed of the pickup truck.

### 7. Conclusion

All parameters, dimensions, materials, and configurations described herein are meant to be exemplary and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the implementations without departing from the scope of the present disclosure. The use of a numerical range does not preclude equivalents that fall outside the range that fulfill the same function, in the same way, to produce the same result.

Also, various inventive concepts may be embodied as one or more methods, of which at least one example has been provided. The acts performed as part of the method may in some instances be ordered in different ways. Accordingly, in some inventive implementations, respective acts of a given method may be performed in an order different than specifically illustrated, which may include performing some acts simultaneously (even if such acts are shown as sequential acts in illustrative embodiments).

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A vehicle comprising:
a front section having a front body;
a tail section having a rear body; and
an articulated joint having a first end coupled to the front section and a second end coupled to the tail section, the articulated joint comprising:
a guide structure, coupled to the first end and the second end, defining a curved path, the second end being movable with respect to the first end along the curved path;
a drive actuator, coupled to the guide structure, to move the second end along the curved path; and
a brake, coupled to the guide structure, to hold the second end to a fixed position along the curved path in response to being activated.

2. The vehicle of claim 1, wherein the curved path lies on a plane that bisects the vehicle, the plane containing a vertical axis of the vehicle and a longitudinal axis of the vehicle.

3. The vehicle of claim 1, wherein movement of the second end relative to the first end along the curved path changes a height of the vehicle.

4. The vehicle of claim 1, further comprising:
a front wheel, coupled to the front body, rotatable about a first axis; and
a rear wheel, coupled to the rear body, rotatable about a second axis.

5. The vehicle of claim 4, wherein movement of the second end relative to the first end along the curved path changes a distance between the first axis and the second axis.

6. The vehicle of claim 1, wherein the guide structure comprises:
a carriage coupled to the tail section and supporting the drive actuator and the brake; and
a track system, coupled to the front section, that defines the curved path, the carriage being slidably adjustable along the curved path.

7. The vehicle of claim 6, wherein the track system comprises a first rail and a second rail and the carriage comprises bearings that interface and ride on the first and second rails.

8. (canceled)

9. The vehicle of claim 7, wherein the bearings are configured to hold the carriage on the first and second rails.

10. The vehicle of claim 6, wherein the drive actuator comprises a motorized belt drive.

11. (canceled)

12. (canceled)

13. (canceled)

14. (canceled)

15. (canceled)

16. (canceled)

17. (canceled)

18. (canceled)

19. (canceled)

20. The vehicle of claim 1, wherein the curved path has a center of curvature that varies as a function of position along the curved path.

21. The vehicle of claim 1, wherein the curved path is a circular arc having a remote center of location (RCM).

22. (canceled)

23. (canceled)

24. The vehicle of claim 1, further comprising:
a morphing section, coupled to the rear body of the tail section, having a surface that changes shape as the second end moves relative to the first end.

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The vehicle of claim 1, further comprising:
a second articulated joint having a third end and a fourth end, the third end being coupled to the tail section; and
a trailer section, coupled to the fourth end of the second articulated joint, to hold a payload.

44. The vehicle of claim 1, further comprising:
a flatbed, coupled to the tail section and disposed above the vehicle, to carry a payload.

45. The vehicle of claim 44, wherein the flatbed includes a hatch to facilitate at least one of loading or unloading of the payload.

46. The vehicle of claim 45, wherein movement of the second end relative to the first end along the curved path changes a height of the vehicle, thereby tilting the flatbed and allowing the payload to be loaded into or offloaded out of the flatbed through the hatch.

47. The vehicle of claim 44, wherein the guide structure comprises:
a carriage coupled to the tail section and supporting the drive actuator and the brake; and
a track system, coupled to the front section, that defines the curved path, the carriage being slidably adjustable along the curved path.

48. The vehicle of claim 47, wherein the drive actuator comprises a belt, a toothed gear engaged with the belt, and a motor to drive the toothed gear.

49. The vehicle of claim 44, further comprising:
a front wheel, coupled to the front body, rotatable about a first axis; and
a rear wheel, coupled to the rear body, rotatable about a second axis.

50. The vehicle of claim 49, wherein the drive actuator comprises a front motor to drive the front wheel and a rear motor to the drive the rear wheel.

51. A vehicle comprising:
a front section comprising:
a front body; and
a front wheel coupled to the front body;
a tail section comprising:
a rear body; and
a rear wheel coupled to the rear body; and
an articulated joint having a first end coupled to the front section and a second end coupled to the tail section, the articulated joint comprising:
a carriage coupled to the tail section;
a track system, coupled to the front section, that defines a curv ed path lying in a plane that bisects the vehicle, the carriage being slidably adjustable along the curved path;
a drive actuator, coupled to the carriage, to move the carriage along the curved path; and
a brake, coupled to the carriage, to hold the carriage at a fixed position along the curved path in response to being activated.

52. An articulated joint comprising:
a guide structure defining a curved path and having a second end that is movable with respect to a first end along the curved path;
a drive actuator, coupled to the guide structure, to move the second end along the curved path; and
a brake, coupled to the guide structure, to hold the second to a fixed position along the curved path in response to being activated.

53. The articulated joint of claim 52, wherein the guide structure comprises:
a carriage supporting the drive actuator and the brake; and
a track system that defines the curved path, the carriage being slidably adjustable along the curved path.

54. A vehicle comprising:
a front section; and
a tail section,
wherein the front section comprises:
a front vehicle body;
a front wheel assembly attached to the front vehicle body; and
a track system at the rear of the front vehicle body, said track system defining a curved path; and
wherein the tail section comprises:
a rear vehicle body;
a rear wheel assembly;
a carriage system that rides on the track system and to which the rear vehicle body and the rear wheel assembly is attached; and
a motorized drive system for moving the carriage system back and forth over the curved path defined by the track system,
wherein the curved path is vertically oriented and is convex as viewed from the tail section towards the front section.

55. The vehicle of claim 54, wherein the tail section further comprises a steering assembly connected to the carriage and to which the rear wheel is connected, said steering assembly for steering the vehicle.

56. The vehicle of claim 54, wherein the curved path defines an arc of a circle with a center located within the front section of the vehicle.

57. The vehicle of claim 56, wherein the arc of the curved path extends over an angle between 90° and 120°of the circle.

58. The vehicle of claim 54, wherein the track system is mounted on a back side of the front vehicle body.

59. The vehicle of claim 54, wherein the curved path is along the back side of front vehicle body.

60. The vehicle of claim 54, wherein the track system comprises a first rail and a second rail and the carriage system comprises bearings that interface and ride on the first and second rails.

61. The vehicle of claim 60, wherein the bearings are plain bearings.

62. The vehicle of claim 60, wherein the bearings are configured to hold the carriage system on the first and second rails.

63. The vehicle of claim 54, wherein the motorized drive system comprises a motorized belt drive.

64. The vehicle of claim 54, wherein the motorized drive system comprises a belt, a toothed gear that is engaged with the belt, and a motor driving the toothed gear

65. The vehicle of claim 64, wherein the belt is attached to the front vehicle section and the motor and gear are mounted on the carriage system.

66. The vehicle of claim 65, wherein the motorized drive system further comprises a rail attached to the front section, and wherein the rail has a recessed center region that holds the belt.

67. The vehicle of claim 66, further comprising a braking assembly for maintaining holding the carriage system at a selectable location along the track system.

68. The vehicle of claim 67, wherein the brake comprises a brake shoe and an actuator for pushing the brake shoe against an object that is attached to the front section.

69. The vehicle of claim 68, wherein the object attached to the front section is the rail.

70. The vehicle of claim 54, further comprising a braking assembly for maintaining holding the carriage system at a selectable location along the track system.

71. The vehicle of claim 70, wherein the brake comprises a brake shoe and an actuator for pushing the brake shoe against an object that is attached to the front section.

72. The vehicle of claim 70, wherein the object attached to the front section is a rail.

73. The vehicle of claim 54, wherein movement of the carriage system over the curved path defined by the track system changes the w heelbase of the vehicle.

74. The vehicle of claim 54, wherein movement of the carriage system over the curved path defined by the track system changes the height of the vehicle.

75. A vehicle comprising:
a front section and a tail section,
wherein the front section comprises:
a front wheel assembly; and
a track system defining a curved path;
wherein the tail section comprises:
a rear wheel assembly;
a carriage system that rides on the track system and to which the rear wheel assembly is attached; and
a motorized drive system for moving the carriage system back and forth over the curved path defined by the track system,
wherein the curved path is vertically oriented and is convex as viewed from the tail section towards the front section.

76. A seat positioning system for a vehicle, said seat positioning system comprising:
a track system including a contoured rail with a rear curved section and a forward runout section in front of the rear curved section, wherein the forward runout section is much straighter than the rear curved section;
a seat assembly; and
a set of one or more bearing assemblies supporting the seat assembly on the contoured rail so that the seat assembly can move back-and-forth along the contoured rail, wherein the seat assembly is supported on the contoured rail in a forward-facing direction.

77. The seat positioning system of claim 76, wherein the curved section of the contoured rail has a constant radius of curvature.

78. The seat positioning system of claim 76, wherein the runout section of the contoured rail is straight.

79. The seat positioning system of claim 76, wherein the contoured rail lies in a vertical plane with the curved section of the contoured rail being concave in an upward direction.

80. The seat positioning system of claim 76, wherein the track system includes a second contoured rail with a rear curved section and a forward runout section in front of the rear curved section, wherein the forward runout section of the second contoured rail is much straighter than the rear curved section of the second contoured rail.

81. The seat positioning system of claim 80, further comprising a second set of one or more bearing assemblies supporting the seat assembly on the second contoured rail so that the seat assembly can move back-and-forth along the second contoured rail, wherein the seat assembly is supported on the second contoured rail in a forward-facing direction.

82. The seat positioning system of claim 76, further comprising a drive system that is connected to the seat assembly and is configured to move the seat assembly back and forth along the contoured rail.

83. The seat positioning system of claim 76, further comprising a drive system that is connected to the seat assembly and is configured to move the seat assembly along the contoured rail to a location determined by an amount of tilt that is applied to the contoured rail in the vertical plane.

84. A vehicle comprising:
a front vehicle section that has a forward tilt that is variable; and
a seat positioning system within the front vehicle section, said seat positioning system comprising:
a track system including a contoured rail with a rear curved section and a forward runout section in front of the rear curved section, wherein the forward runout section is much straightcr than the rear curved section;
a seat assembly; and
a set of one or more bearing assemblies supporting the seat assembly on the contoured rail so that the seat assembly can move back-and-forth along the contoured rail, wherein the seat assembly is supported on the contoured rail in a forward-facing direction.

85. The vehicle of claim 84, wherein the curved section of the contoured rail has a constant radius of curvature.

86. The vehicle of claim 84, wherein the runout section of the contoured rail is straight.

87. The vehicle of claim 84, wherein the contoured rail lies in a vertical plane with the curved section of the contoured rail being concave in an upward direction.

88. The vehicle of claim 84, wherein the track system further comprises a drive system that is connected to the seat assembly and is configured to move the seat assembly along the contoured rail to a location determined by an amount of tilt that is applied to the front vehicle section.
